(19) United States
(12) Patent Application Publication
(10) Pub. No.: US 2009/0218935 A1
(43) Pub. Date: Sep. 3, 2009

(54) Organic electroluminescence element

(75) Inventors: Wataru Sotoyama, Kanagawa (JP); Kazuyuki Shibata, Tokyo (JP); Manabu Tobise, Kanagawa (JP); Akira Takeda, Kanagawa (JP)

Correspondence Address: Moss & Burke, PLLC, 401 Holland Lane, Suite 407, Alexandria, VA, 22314, US

(73) Assignee: FUJIFILM CORPORATION, Tokyo (JP)

(21) Appl. No.: 12/379,489

(22) Filed: Feb. 24, 2009

(30) Foreign Application Priority Data
Feb. 28, 2008 (JP) 2008-048628
Dec. 10, 2008 (JP) 2008-315024

(51) Int. Cl. H01J 1/63

(52) U.S. Cl. 313/504

(57) ABSTRACT

An organic electroluminescence element having at least one organic compound layer including a light-emitting layer, which is disposed between a pair of electrodes, wherein the light-emitting layer includes a light emitting material, a compound represented by the following formula (1) and a charge transporting material. An organic EL element that exhibits high light-emission efficiency and low driving voltage, and is excellent in drive durability is provided.

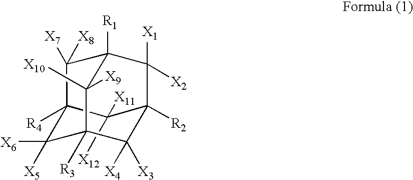

### CROSS-REFERENCE TO RELATED APPLICATION

This application claims priority under 35 USC 119 from Japanese Patent Application Nos. 2008-48628 and 2008-315024, the disclosures of which are incorporated by reference herein.

### BACKGROUND OF THE INVENTION

1. Field of the Invention

The present invention relates to an organic electroluminescence element (hereinafter, referred to as an “organic EL element” in some cases, and also referred to as an organic light emitting diode (OLED)) which can be effectively applied to a surface light source for full color displays, backlights, illumination light sources and the like; or a light source array for printers and the like.

2. Description of the Related Art

An organic EL element is composed of a light-emitting layer or a plurality of organic layers containing a light-emitting layer, and a pair of electrodes sandwiching the organic layers. The organic EL element is an element for obtaining luminescence by utilizing at least either one of luminescence from excitons each of which is obtained by recombining an electron injected from a cathode with a hole injected from an anode to produce an exciton in the organic layer, or luminescence from excitons of other molecules produced by energy transmission from the above-described excitons.

Heretofore, an organic EL element has been developed by using a laminate structure from integrated layers in which each layer is functionally differentiated, whereby brightness and element efficiency have been remarkably improved. For example, a two-layer laminated type element obtained by laminating a hole transport layer and a light-emitting layer also functioning as an electron transport layer; a three-layer laminated type element obtained by laminating a hole transport layer, a light-emitting layer, and an electron transport layer; and a four-layer laminated type element obtained by laminating a hole transport layer, a light-emitting layer, a hole-blocking layer, and an electron transport layer have been frequently used.

For the practical application of an organic EL element, however, there are still many problems such as improvements in light-emission efficiency and drive durability. Particularly, increase in light-emission efficiency results in a decrease in power consumption, and further, it is advantageous in view of drive durability. Accordingly, many means of improvement have been heretofore disclosed.

For instance, Japanese Patent Application Laid-Open (JP-A) No. 2005-123164 discloses an organic EL element improved in light-emission efficiency which includes an electron transporting material, a hole transporting material and a dopant as a light emitting material in a light-emitting layer. However, as an electron transportability and hole transportability by the electron transporting material and hole transporting material which act as a host are insufficient, improvement in light-emission efficiency and lowering of driving voltage are not obtained as expected.

On the other hand, a search for a light emitting material that is high in light-emission efficiency has been forwarded. For instance, JP-A No. 2006-120811 discloses that an organic EL element which includes an unsubstituted adamantane compound or a substituted adamantane compound having a straight chain or branched alkyl group as a substituent as a host compound together with a guest compound in a light-emitting layer is expected to improve the light-emission efficiency and drive durability. However, since the adamantane compound does not have charge transportability, charges flow only on the guest compound. Accordingly, the driving voltage is increased by incorporating the adamantane compound, and as a result, a large improvement in the light-emission efficiency is not expected. Furthermore, JP-A No. 2005-220080 discloses that when an adamantane compound having an o-terphenyl group is used as a host material in a light-emitting layer, heat resistance in particular is improved, and an organic EL element which is high in light-emission efficiency is provided. However, in order to put an organic EL element to practical use, in addition to high light-emission efficiency and high drive durability, comprehensively, many characteristics such as low driving voltage operability and capability of light emission in a broad light-emission wavelength region have to be provided. The structure of the light-emitting layer disclosed in JP-A No. 2006-120811 cannot be considered to respond sufficiently to these demands.

### SUMMARY OF THE INVENTION

The present invention has been made in view of the above circumstances and provides an organic electroluminescence element with the following aspect.

An aspect of the invention provides an organic electroluminescence element comprising at least one organic compound layer including a light-emitting layer, which is disposed between a pair of electrodes, wherein the light-emitting layer includes a light emitting material, a compound represented by the following formula (1) and a charge transporting material:

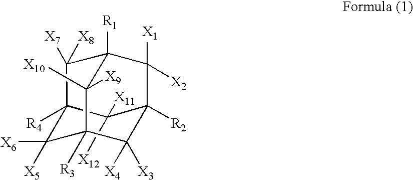

wherein in the formula (1), R₁ through R₄ each independently represent a hydrogen atom, an alkyl group having 1 to 6 carbon atoms, an alkenyl group having 2 to 6 carbon atoms, an alkynyl group having 2 to 6 carbon atoms, an aryl group, a heteroaryl group, an alkoxy group having 1 to 6 carbon atoms, an acyl group, an acyloxy group, an amino group, a nitro group, a cyano group, an ester group, an amido group, a halogen atom, a perfluoroalkyl group having 1 to 6 carbon atoms or a silyl group; at least one of R₁ through R₄ is a group having a double bond or a triple bond; and X₁ through X₁₂ each independently represent a hydrogen atom, an alkyl group having 1 to 6 carbon atoms, an alkenyl group having 2 to 6 carbon atoms, an alkynyl group having 2 to 6 carbon atoms, an aryl group, a heteroaryl group, an alkoxy group having 1 to 6 carbon atoms, an acyl group, an acyloxy group, an amino group, a nitro group, a cyano group, an ester group, an amido group, a halogen atom, a perfluoroalkyl group having 1 to 6 carbon atoms or a silyl group.

### DETAILED DESCRIPTION OF THE INVENTION

An object of the present invention is to provide an organic EL element that exhibits high light-emission efficiency and low driving voltage, and is excellent in drive durability.

The purpose of the present invention is attained by an organic electroluminescence element comprising at least one organic compound layer including a light-emitting layer, which is disposed between a pair of electrodes, wherein the light-emitting layer includes a light emitting material, a compound represented by the following formula (1) and a charge transporting material.

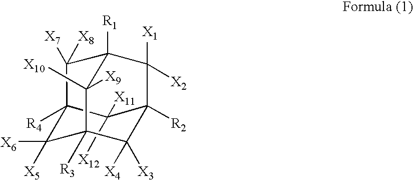

In formula (1), R₁ through R₄ each independently represent a hydrogen atom, an alkyl group having 1 to 6 carbon atoms, an alkenyl group having 2 to 6 carbon atoms, an alkynyl group having 2 to 6 carbon atoms, an aryl group, a heteroaryl group, an alkoxy group having 1 to 6 carbon atoms, an acyl group, an acyloxy group, an amino group, a nitro group, a cyano group, an ester group, an amido group, a halogen atom, a perfluoroalkyl group having 1 to 6 carbon atoms or a silyl group, wherein at least one of R₁ through R₄ is a group having a double bond or triple bond. X₁ through X₁₂ each independently represent a hydrogen atom, an alkyl group having 1 to 6 carbon atoms, an alkenyl group having 2 to 6 carbon atoms, an alkynyl group having 2 to 6 carbon atoms, an aryl group, a heteroaryl group, an alkoxy group having 1 to 6 carbon atoms, an acyl group, an acyloxy group, an amino group, a nitro group, a cyano group, an ester group, an amido group, a halogen atom, a perfluoroalkyl group having 1 to 6 carbon atoms or a silyl group.

Preferably, at least one of R1 through R4 is a group having a group a double bond, and the group having a double bond is a phenyl group, a biphenylyl group or a terphenylyl group.

Preferably, in formula (1), at least one of R₁ through R₄ is a phenyl group.

Preferably, an energy difference (Eg) between the highest occupied molecular orbital and the lowest unoccupied molecular orbital of the compound represented by formula (1) is 4.0 eV or more.

Preferably, the lowest excited triplet level (T₁) of the compound represented by formula (1) is 2.7 eV or more.

Preferably, an ionization potential (Ip) of the compound represented by formula (1) is 6.1 eV or more.

Preferably, an electron affinity (Ea) of the compound represented by formula (1) is 2.3 eV or less.

Preferably, the compound represented by formula (1) and the charge transporting material are contained in a range of from 1:99 to 50:50 by weight ratio.

Preferably, the compound represented by formula (1) and the charge transporting material are contained in a range of from 5:95 to 35:65 by weight ratio.

Preferably, plural compounds represented by formula (1) are contained in a mixture.

Preferably, the plural compounds represented by formula (1) have different numbers of phenyl groups from each other.

Preferably, the charge transporting material comprises a hole transporting material.

Preferably, the light emitting material comprises a metal complex represented by the following formula (A).

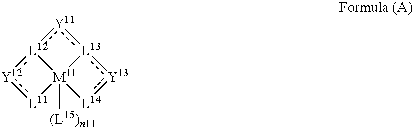

In formula (A), M¹¹ represents a metal ion, and L¹¹ through L¹⁵ each independently represent a ligand which coordinates to M¹¹. An atomic group may further exist between L¹¹ and L¹⁴ to form a cyclic ligand. L¹⁵ may bond to both of L¹ and L¹⁴ to form a cyclic ligand. Y¹¹, Y¹² and Y¹³ each independently represent a linking group, a single bond or a double bond. When Y¹¹, Y¹² or Y¹³ is a linking group, bonds between L¹¹ and Y¹², Y¹² and L¹², L¹² and Y¹¹, Y¹¹ and L¹³, L¹³ and Y¹³, and Y¹³ and L¹⁴ each independently represent a single bond or a double bond. n11 represents an integer of from 0 to 4. Bonds between M¹¹ and L¹¹ to L¹⁵ are each independently a coordination bond, an ionic bond or a covalent bond.

Preferably, in formula (A), M¹¹ is a platinum ion.

According to the present invention, an organic EL element that exhibits high light-emission efficiency and low driving voltage, and is excellent in drive durability is provided.

In the following, the organic electroluminescence element of the present invention will be described in detail.

The organic electroluminescence element of the present invention includes an anode and a cathode on a substrate, and at least one organic compound layer including an organic light-emitting layer (hereinafter, referred simply to as a “light-emitting layer” in some cases) between the electrodes. Due to the nature of a light-emitting element, it is preferred that at least one electrode of the anode or the cathode is transparent.

The organic compound layer in the present invention may be composed of either one layer or plural laminated layers. As a lamination embodiment of the organic compound layers, it is preferable to be laminated in the order of a hole transport layer, a light-emitting layer, and an electron transport layer from the anode side. Moreover, a charge-blocking layer and the like may be provided between the hole transport layer and the light-emitting layer, or between the light-emitting layer and the electron transport layer. Further, a hole injection layer may be provided between the anode and the hole transport layer, and similarly an electron injection layer may be provided between the cathode and the electron transport layer. Each of the layers mentioned above may be composed of a plurality of secondary layers.

### 1. Compound Represented by Formula (1)

The compound represented by formula (1) used for the organic electroluminescence element in the present invention is to be described in detail hereinafter.

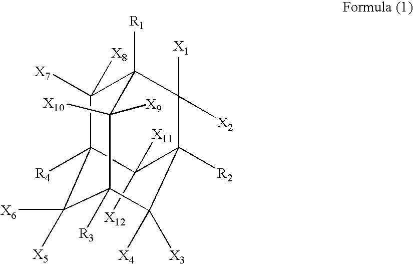

In formula (1), R₁ to R₄ each independently represent a hydrogen atom, an alkyl group having 1 to 6 carbon atoms, an alkenyl group having 2 to 6 carbon atoms, an alkynyl group having 2 to 6 carbon atoms, an aryl group, a heteroaryl group, an alkoxy group having 1 to 6 carbon atoms, an acyl group, an acyloxy group, an amino group, a nitro group, a cyano group, an ester group, an amido group, a halogen atom, a perfluoroalkyl group having 1 to 6 carbon atoms or a silyl group, wherein at least one from among R₁ to R₄ is a group having a double bond or a triple bond. X₁ to X₁₂ each independently represent a hydrogen atom, an alkyl group having 1 to 6 carbon atoms, an alkenyl group having 2 to 6 carbon atoms, an alkynyl group having 2 to 6 carbon atoms, an aryl group, a heteroaryl group, an alkoxy group having 1 to 6 carbon atoms, an acyl group, an acyloxy group, an amino group, a nitro group, a cyano group, an ester group, an amido group, a halogen atom, a perfluoroalkyl group having 1 to 6 carbon atoms or a silyl group.

Examples of the alkyl group having 1 to 6 carbon atoms represented by R₁ to R₄ and X₁ to X₁₂ include methyl, ethyl, n-propyl, isopropyl, n-butyl, sec-butyl (i.e., 2-butyl), isobutyl, tert-butyl, n-pentyl, isopentyl, n-hexyl, cyclopropyl, cyclobutyl, cyclopentyl, cyclohexyl and the like.

Examples of the alkenyl group having 2 to 6 carbon atoms represented by R₁ to R₄ and X₁ to X₁₂ include vinyl, allyl (i.e., 1-(2-propenyl)), 1-(1-propenyl), 2-propenyl, 1-(1-butenyl), 1-(2-butenyl), 1-(3-butenyl), 1-(1,3-butadienyl), 2-(2-butenyl), 1-(1-pentenyl), 5-(cyclopentadienyl), 1-(1-cyclohexenyl) and the like.

Examples of the alkynyl group having 2 to 6 carbon atoms represented by R₁ to R₄ and X₁ to X₁₂ include ethynyl, propargyl (i.e., 1-(2-propynyl)), 1-(1-propynyl), 1-butadiynyl, 1-(1,3-pentadiynyl) and the like.

Examples of the aryl group represented by R₁ to R₄ and X₁ to X₁₂ include phenyl, o-tolyl (i.e., 1-(2-methylphenyl)), m-tolyl, p-tolyl, 1-(2,3-dimethylphenyl), 1-(3,4-dimethylphenyl), 2-(1,3-dimethylphenyl), 1-(3,5-dimethylphenyl), 1-(2,5-dimethylphenyl), p-cumenyl, mesityl, 1-naphtyl, 2-naphtyl, 1-anthranyl, 2-anthranyl, 9-anthranyl, biphenylyls such as 4-biphenylyl (i.e., 1-(4-phenyl)phenyl), 3-biphenylyl and 2-biphenylyl, terphenylyls such as 4-p-terphenylyl (i.e., 1-4-(4-biphenylyl)phenyl) and 4-m-terphenylyl (i.e., 1-4-(3-biphenylyl)phenyl), and the like.

The heteroaryl group represented by R₁ to R₄ and X₁ to X₁₂ includes a heteroatom such as a nitrogen atom, an oxygen atom, a sulfur atom or the like. Specific examples of the heteroaryl group represented by R₁ to R₄ and X₁ to X₁₂ include imidazolyl, pyrazolyl, pyridyl, pyrazyl, pyrimidyl, triazinyl, quinolyl, isoquinolinyl, pyrrolyl, indolyl, furyl, thienyl, benzoxazolyl, benzimidazolyl, benzthiazolyl, carbazolyl, azepinyl and the like.

Examples of the alkoxy group having 1 to 6 carbon atoms represented by R₁ to R₄ and X₁ to X₁₂ include methoxy, ethoxy, isopropoxy, cyclopropoxy, n-butoxy, tert-butoxy, cyclohexyloxy, phenoxy and the like.

Examples of the acyl group represented by R₁ to R₄ and X₁ to X₁₂ include acetyl, benzoyl, formyl, pivaloyl and the like.

Examples of the acyloxy group represented by R₁ to R₄ and X₁ to X₁₂ include acetoxy, benzoyloxy and the like.

Examples of the amino group represented by R₁ to R₄ and X₁ to X₁₂ include amino, methylamino, dimethylamino, diethylamino, dibenzylamino, diphenylamino, ditolylamino, pyrrolidino, piperidino, morpholino and the like.

Examples of the ester group represented by R₁ to R₄ and X₁ to X₁₂ include methylester (i.e., methoxycarbonyl), ethylester, isopropylester, phenylester, benzylester and the like.

Examples of the amido group represented by R₁ to R₄ and X₁ to X₁₂ include those to be linked through the carbon atom of amido group such as N,N-dimethylamido (i.e., dimethylaminocarbonyl), N-phenylamido and N,N-diphenylamido, and those to be linked through the nitrogen atom of amido group such as N-methylacetoamido (i.e., acetylmethylamino), N-phenylacetoamido, N-phenylbenzamido and the like.

Examples of the halogen atom represented by R₁ to R₄ and X₁ to X₁₂ include a fluorine atom, a chlorine atom, a bromine atom, an iodine atom and the like.

Examples of the perfluoroalkyl group having 1 to 6 carbon atoms represented by R₁ to R₄ and X₁ to X₁₂ include trifluoromethyl, pentafluoroethyl, 1-perfluoropropyl, 2-perfluoropropyl, perfluoropentyl and the like.

Examples of the silyl group having 1 to 18 carbon atoms represented by R₁ to R₄ and X₁ to X₁₂ include trimethylsilyl, triethylsilyl, triisopropylsilyl, triphenylsilyl, methyldiphenylsilyl, dimethylphenylsilyl, tert-butyldimethylsilyl, tert-butyldiphenylsilyl and the like.

R₁ to R₄ and X₁ to X₁₂ described above may be further substituted by other substituents. Examples of an aryl-substituted alkyl group include benzyl, 9-fluorenyl, 1-(2-phenylethyl), 1-(4-phenyl)cyclohexyl and the like. Examples of a heteroaryl-substituted aryl group include 1-(4-N-carbazolyl)phenyl, 1-(3,5-di(N-carbazolyl))phenyl, 1-(4-(2-pyridyl)phenyl) and the like.

R₁ to R₄ described above are each preferably a hydrogen atom, an alkyl group, an alkenyl group, an alkynyl group, an aryl group, a heteroaryl group, an alkoxy group, an amino group, an ester group or a silyl group, more preferably a hydrogen atom, an alkyl group, an aryl group, a heteroaryl group, an alkoxy group, an amino group or a silyl group, and particularly preferably a hydrogen atom, an alkyl group or an aryl group.

X₁ to X₁₂ described above are each preferably a hydrogen atom, an alkyl group, an alkenyl group, an alkynyl group, an aryl group, a heteroaryl group, an alkoxy group, an amino group, an ester group or a silyl group, more preferably a hydrogen atom, an alkyl group or an aryl group, and particularly preferably a hydrogen atom.

The alkyl group having 1 to 6 carbon atoms represented by R₁ to R₄ and X₁ to X₁₂ is preferably methyl, ethyl, n-propyl, isopropyl, n-butyl, isobutyl, tert-butyl, n-pentyl, n-hexyl, cyclopentyl or cyclohexyl, more preferably methyl, ethyl, tert-butyl, n-hexyl or cyclohexyl, and particularly preferably methyl or ethyl.

The aryl group represented by R₁ to R₄ and X₁ to X₁₂ is preferably phenyl, o-tolyl, 1-(3,4-dimethylphenyl), 1-(3,5-dimethylphenyl), 1-naphtyl, 2-naphtyl, 9-anthranyl, biphenylyls or terphenylyls, more preferably phenyl, biphenylyls or terphenylyls, and particularly preferably phenyl.

The hydrogen atom represented by R₁ to R₄ and X₁ to X₁₂ may be a deuterium atom, and is preferably a deuterium atom.

The hydrogen atoms included in the compounds represented by formula (1) may be replaced partly or entirely with deuterium atoms.

At least one from among R₁ to R₄ represents a group having a double bond or a triple bond. Specific examples of the double bond include C═C, C═O, C═S, C═N, N═N, S═O, P═O and the like. The double bond is preferably C═C, C═O, C═N, S═O or P═O, more preferably C═C, C═O or C═N, and particularly preferably C═C. Specific examples of the triple bond include C≡C and C≡N. The triple bond is preferably C≡C.

The group having a double bond or triple bond represented by R₁ to R₄ is preferably an aryl group, more preferably a phenyl group, a biphenylyl group or a terphenylyl group shown below, and particularly preferably a phenyl group.

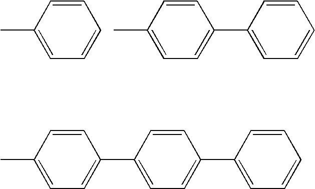

At least one from among R₁ to R₄ represents a group having a double bond or a triple bond, wherein a number of the groups having a double bond or a triple bond among R₁ to R₄ is preferably from 2 to 4, more preferably 3 or 4, and particularly preferably 4.

Among the groups represented by R₁ to R₄, when the number of the groups having a double bond or a triple bond is from 1 to 3, specific examples of the remaining group having only a single bond are preferably a hydrogen atom, an alkyl group, an alkoxy group or a silyl group, more preferably a hydrogen atom, an alkyl group or a silyl group, and particularly preferably a hydrogen atom or an alkyl group.

R₁ to R₄ and X₁ to X₁₂ may form a ring structure by combining with one other. For example, as shown below, X₂, X₃ and X₉ may link together to form a diamantane structure. Furthermore, X₄, X₅ and X₁₂ may link together to form a triamantane structure. These diamantane and triamantane structures may be further substituted by a substituent.

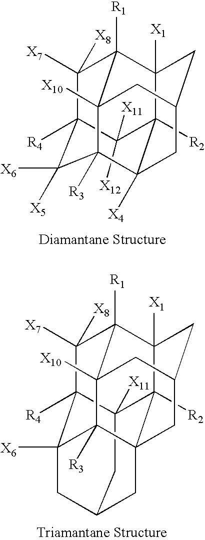

In the present invention, a plurality of the compounds represented by formula (1) is preferably used being mixed together. Preferably, compounds whose groups having a double bond are different from each other, or compounds whose number of substituents is different from each other, are mixed together. Specific examples of the group having a double bond include a phenyl group, a biphenylyl group and a terphenylyl group described above, and specific examples are compounds whose number of substituents is from 1 to 4. For example, a mixture of a mono-substituted compound, in which the number of substituents of the group having a double bond is one, and a tetra-substituted compound, in which the number of substituents of the group having a double bond is four can be used.

Specific examples of the compound represented by formula (1) are shown below, but the present invention is not limited to these compounds.

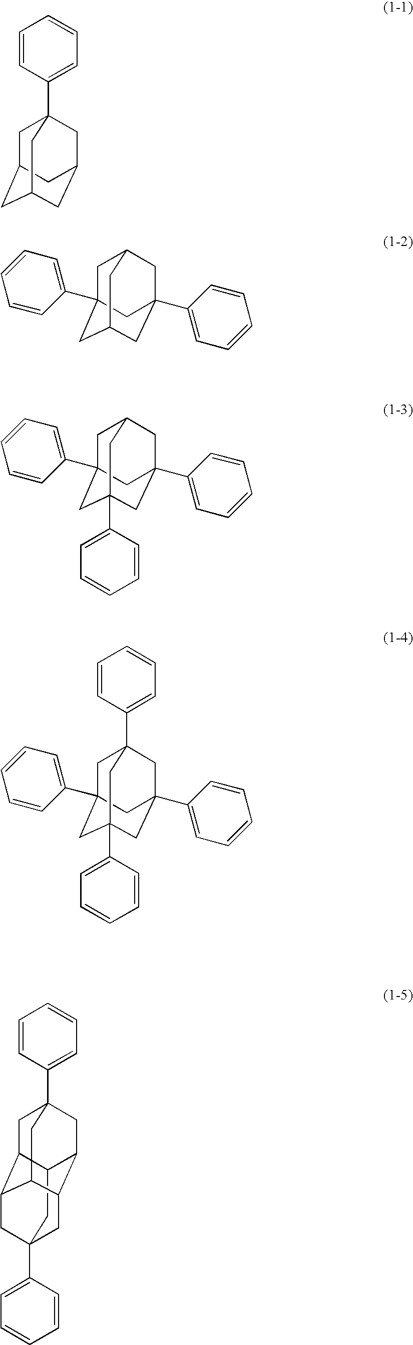

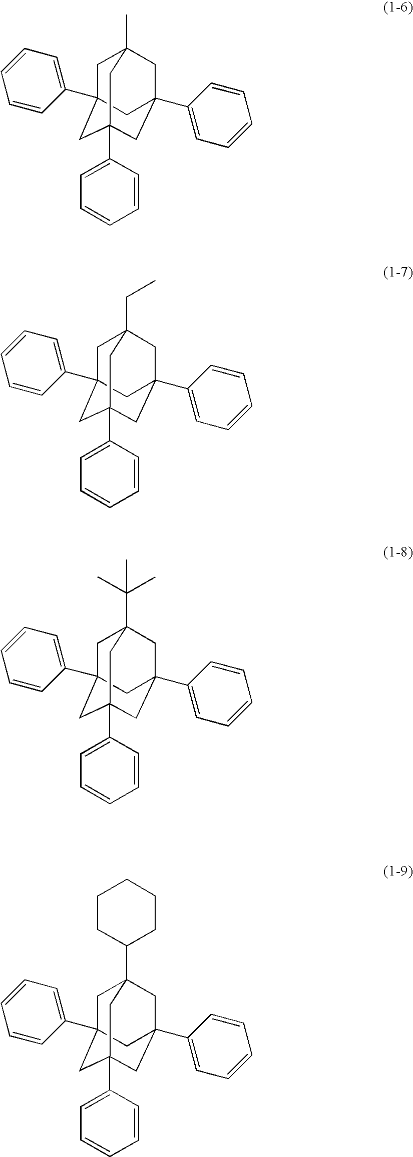

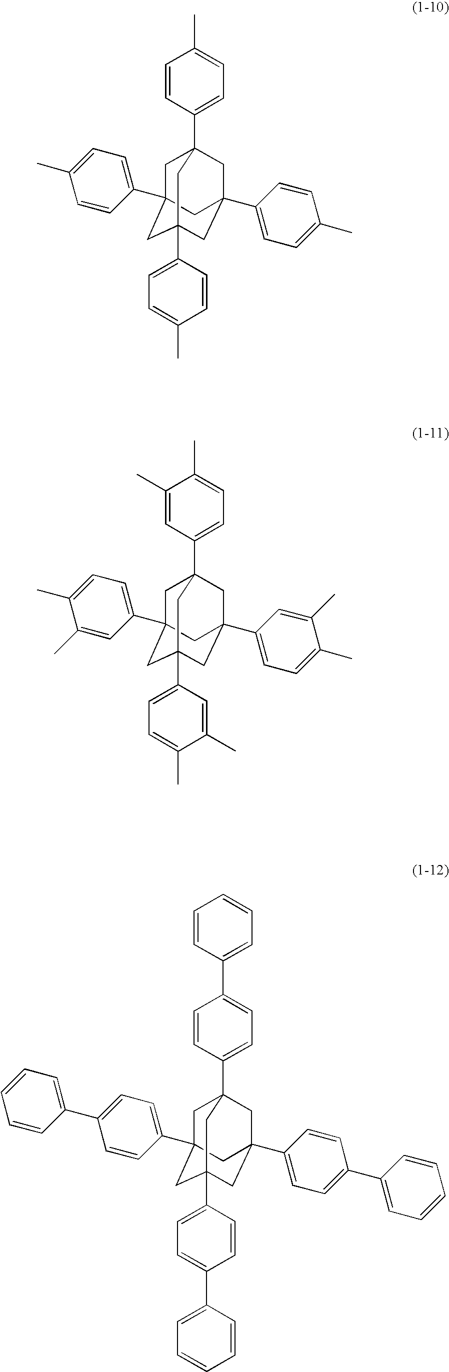

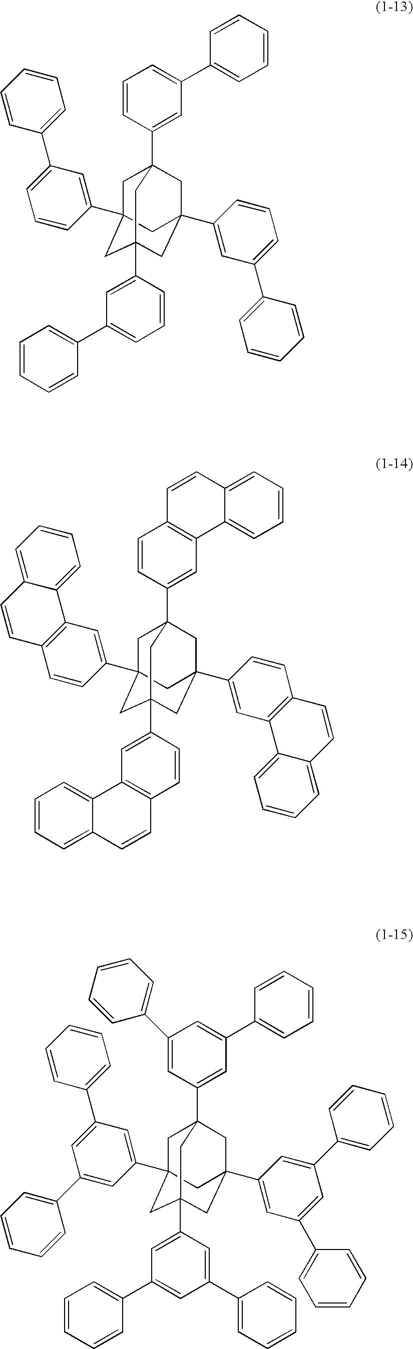

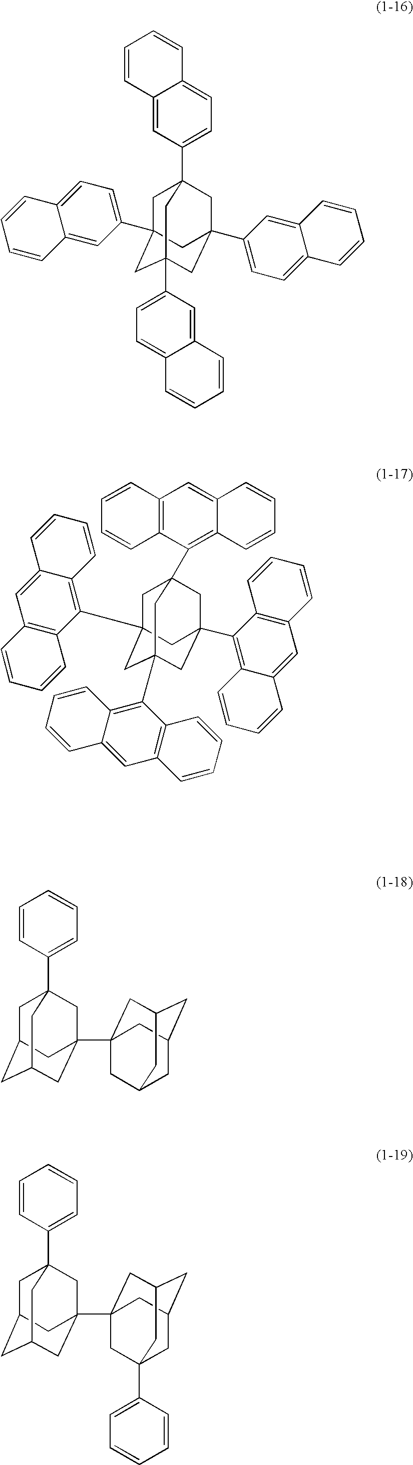

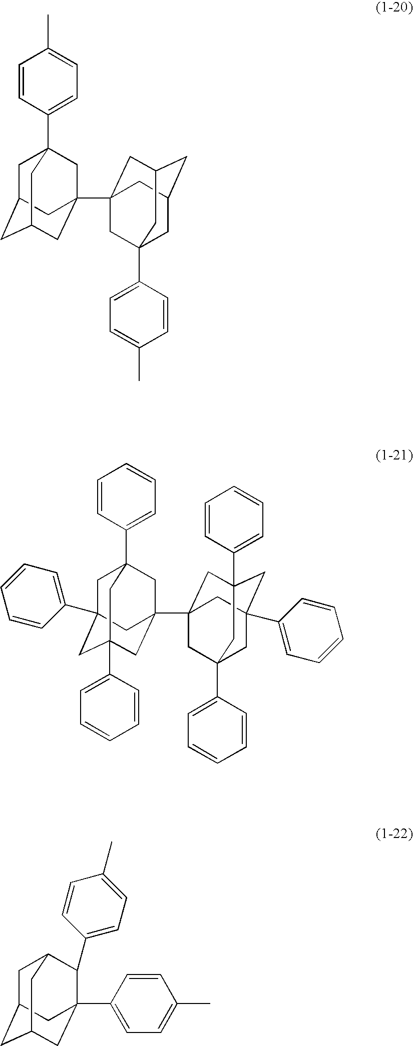

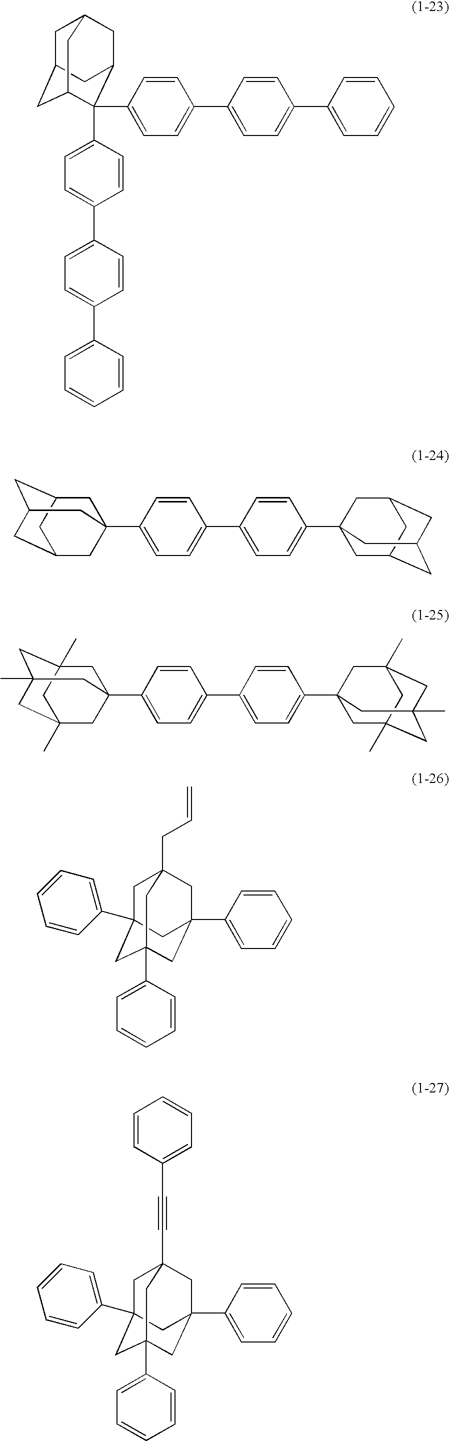

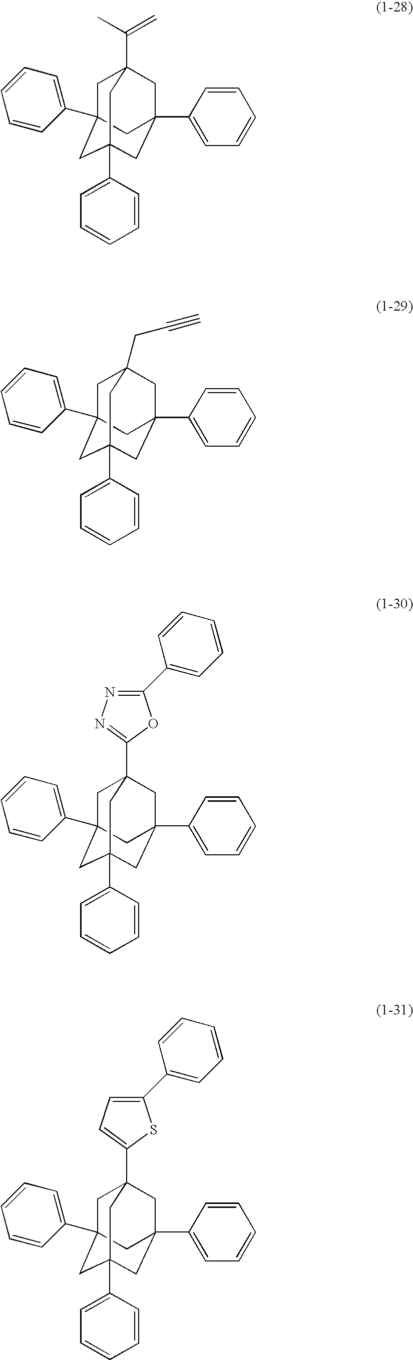

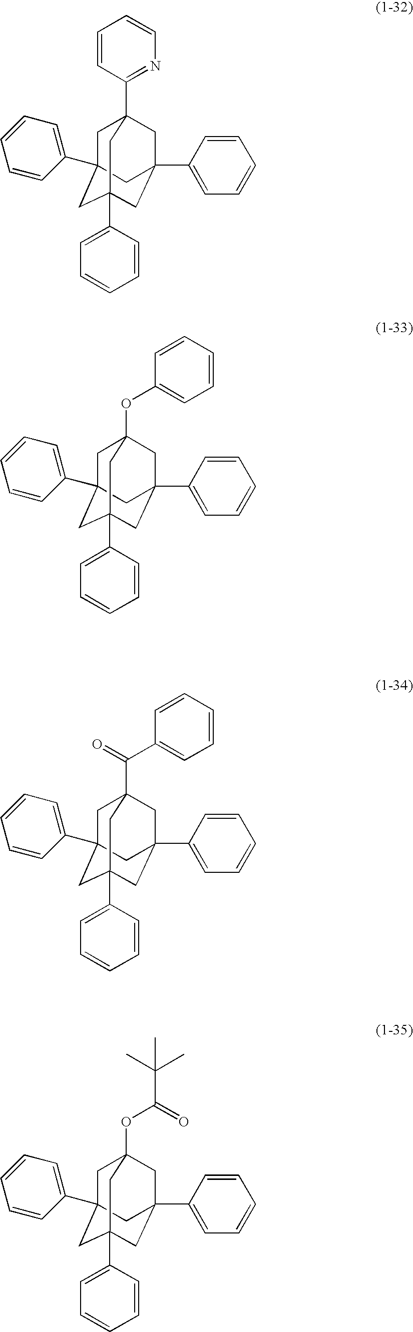

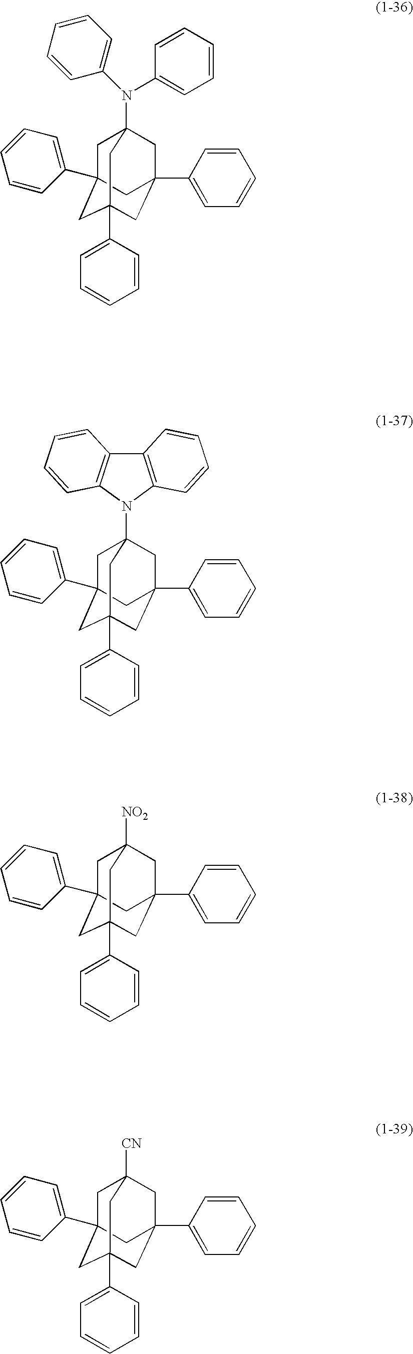

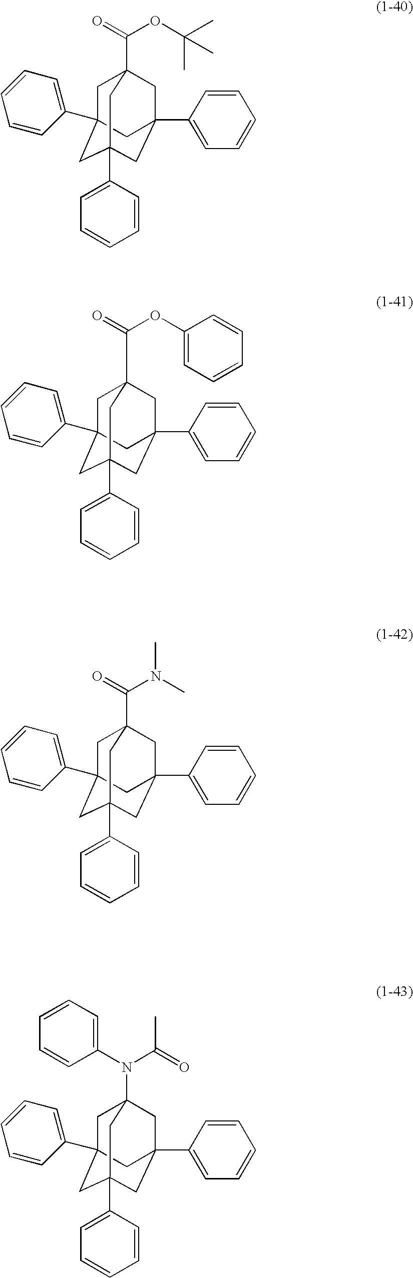

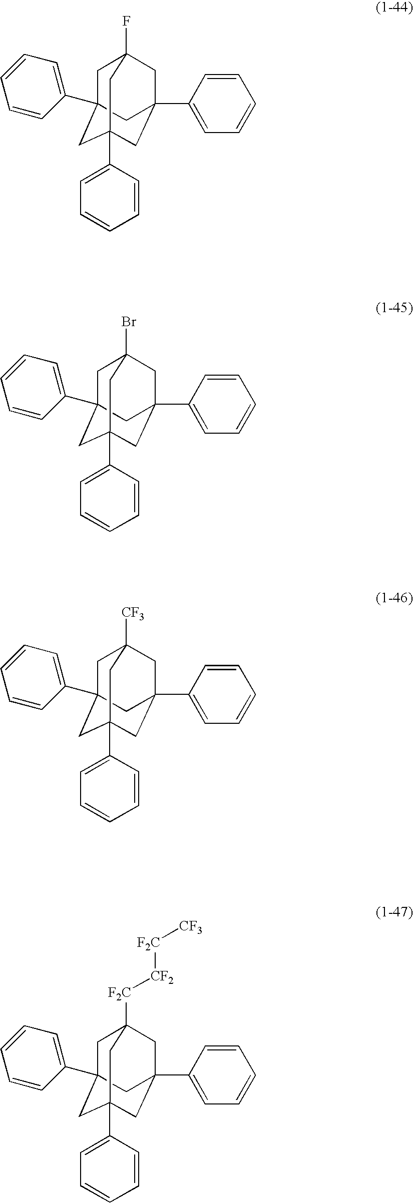

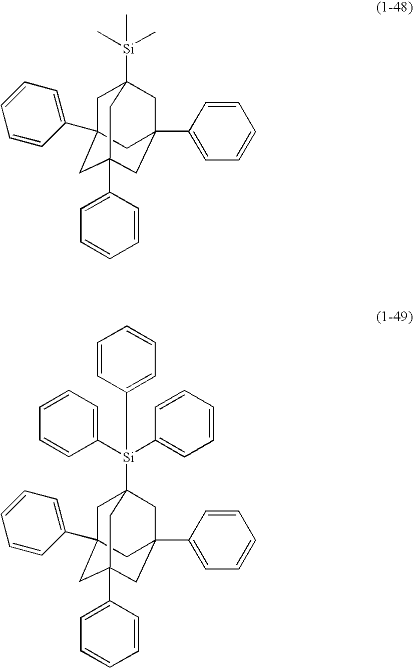

It is considered that, in the invention, the compound represented by formula (1) blocks holes and/or electrons (prevents leak-out), and inhibits excitons from diffusing in the light-emitting layer, and thereby the effects of improvement in light-emission efficiency and improvement in drive durability are obtained.

In the invention, it is preferable that an energy difference (abbreviated as Eg) between the highest occupied molecular orbital and the lowest unoccupied molecular orbital of the compound represented by formula (1) is 4.0 eV or more. Generally, an organic compound which has an energy difference Eg between the highest occupied molecular orbital and the lowest unoccupied molecular orbital of 4.0 eV or more is electrically inactive, and can exert the above effect of blocking holes and/or electrons. The Eg of the compound represented by formula (1) is more preferably 4.1 eV or more, and particularly preferably 4.2 eV or more.

Furthermore, the lowest excited triplet level T₁ of the compound represented by formula (1) is preferably 2.7 eV or more. When the lowest excited triplet level is thus set, excitons generated from a light emitting material of a light-emitting layer are inhibited from diffusing, and thereby the light-emission efficiency is more improved, which is preferable. When the light emitting material is a blue phosphorescent light-emitting material, the T₁ thereof is substantially 2.6 eV; accordingly, the T₁ of the compound represented by formula (1) is preferably more than that, that is, 2.7 eV or more to inhibit diffusing of the triplet excitons from the blue phosphorescent light-emitting material. When the T₁ is thus set, even in a blue phosphorescent light-emitting element, the light-emission efficiency is further improved.

In the invention, the ionization potential (Ip) of the compound represented by formula (1) is preferably 6.1 eV or more. When the Ip is thus set, holes are inhibited from transferring from a light emitting material in a light-emitting layer to the compound represented by formula (1), and thereby the light-emission efficiency is more improved, which is preferable. Furthermore, the Ip is more preferably 6.2 eV or more, and the Ip is particularly preferably 6.3 eV or more. In particular, when the light emitting material is a blue phosphorescent light-emitting material, the ionization potential thereof is from 5.8 eV to 5.9 eV; accordingly, the ionization potential of the compound represented by formula (1) is preferably more than that, that is, 6.0 eV or more to inhibit transferring of holes from the blue phosphorescent light-emitting material to the compound represented by formula (1). When the Ip is thus set, even in a blue phosphorescent light-emitting element, the light-emission efficiency is further improved. In particular, when a phosphorescent light-emitting material is used, the ionization potential of N,N′-dicarbazolyl-1,3-benzene (abbreviated as “mCP”) that is widely used as a host material in the light-emitting layer is 5.9 eV; accordingly, the ionization potential of the compound represented by formula (1) is preferably larger than that value to inhibit leak-outing of holes from the mCP to an adjacent layer on an anode side of the light-emitting layer. When the ionization potential thereof is set larger than 6.1 eV, the leak-out of holes is inhibited and thereby the light-emission efficiency is further improved.

Furthermore, the electron affinity of the compound represented by formula (1) is preferably 2.3 eV or less. When the electron affinity is thus set, the leak-out of electrons (mainly leak-out of electrons from a host material in the light-emitting layer) from the light-emitting layer is inhibited, and the light-emission efficiency is further improved, that is preferable. Since the electron affinity of N,N′-dicarbazolyl-1,3-benzene (abbreviated as “mCP”) that is widely used as a host material in the light-emitting layer is 2.4 eV, the electron affinity of the compound represented by formula (1) is preferably larger than that value to inhibit leaking-out of electrons from the mCP to an adjacent layer on an anode side of the light-emitting layer. When the electron affinity thereof is set to 2.3 eV or less, the leak-out of electrons is inhibited, and thereby the light-emission efficiency is further improved.

In the present invention, when a mixture of a plurality of the compounds represented by formula (1) is used, a mixing ratio thereof is preferably in a range of from 1:99 to 50:50 by weight ratio, and more preferably from 20:80 to 50:50.

By using a plurality of the compounds represented by formula (1), further improvements in light-emission efficiency and drive durability are attained.

### 2. Light-Emitting Layer

The light-emitting layer is a layer having functions of receiving holes from the anode, the hole injection layer, or the hole transport layer, and receiving electrons from the cathode, the electron injection layer, or the electron transport layer, and providing a field for recombination of the holes with the electrons to emit light, when an electric field is applied to the layer.

The light-emitting layer according to the present invention contains at least a light emitting material, a compound represented by formula (1) described above and a charge transporting material.

### 2-1. Light Emitting Material

The light emitting material used in the light-emitting layer according to the present invention may be a fluorescent light-emitting material or a phosphorescent light-emitting material.

Preferably, the light emitting material is a phosphorescent light-emitting material, in view of light-emission efficiency.

### (a) Phosphorescent Light-Emitting Material

Examples of the phosphorescent light-emitting material generally include complexes containing a transition metal atom or a lanthanoid atom.

Specific examples of the transition metal atom preferably include ruthenium, rhodium, palladium, tungsten, rhenium, osmium, iridium, platinum and gold, more preferably rhenium, iridium, and platinum, and even more preferably iridium and platinum.

Specific examples of the lanthanoid atom include lanthanum, cerium, praseodymium, neodymium, samarium, europium, gadolinium, terbium, dysprosium, holmium, erbium, thulium, ytterbium, and lutetium. Among these lanthanoid atoms, neodymium, europium, and gadolinium are preferred.

Examples of ligands in the complex include the ligands described, for example, in “Comprehensive Coordination Chemistry” authored by G. Wilkinson et al., published by Pergamon Press Company in 1987; “Photochemistry and Photophysics of Coordination Compounds” authored by H. Yersin, published by Springer-Verlag Company in 1987; and “YUHKI KINZOKU KAGAKU—KISO TO OUYOU—(Organometallic Chemistry—Fundamental and Application—)” authored by Akio Yamamoto, published by Shokabo Publishing Co., Ltd. in 1982.

Specific examples of the ligands preferably include halogen ligands (preferably chlorine ligands), aromatic carbon ring ligands (e.g., cyclopentadienyl anions, benzene anions, naphthyl anions and the like), nitrogen-containing heterocyclic ligands (e.g., phenylpyridine, benzoquinoline, quinolinol, bipyridyl, phenanthroline and the like), diketone ligands (e.g., acetylacetone and the like), carboxylic acid ligands (e.g., acetic acid ligands and the like), alkoholato ligands (e.g., phnolato ligands and the like), carbon monoxide ligands, isonitryl ligands, and cyano ligand, and more preferably nitrogen-containing heterocyclic ligands.

The above-described complexes may be either a complex containing one transition metal atom in the compound, or a so-called polynuclear complex containing two or more transition metal atoms wherein different metal atoms may be contained at the same time.

Among these, specific examples of the light emitting material include phosphorescent light-emitting compounds described in patent documents such as U.S. Pat. No. 6,303,238B1, U.S. Pat. No. 6,097,147, International Patent Publication (WO) No. 00/57676, WO No. 00/70655, WO No. 01/08230, WO No. 01/39234A2, WO No. 01/41512A1, WO No. 02/02714A2, WO No. 02/15645A1, WO No. 02/44189A1, JP-A Nos. 2001-247859, 2002-302671, 2002-117978, 2002-225352, 2002-235076, 2003-123982, 2002-170684, European Patent (EP) No. 1211257, JP-A Nos. 2002-226495, 2002-234894, 2001-247859, 2001-298470, 2002-173674, 2002-203678, 2002-203679, 2004-357791, and 2006-256999, etc.

Specific examples of the light emitting material are shown below, but it should be noted that the present invention is not limited to the compounds.

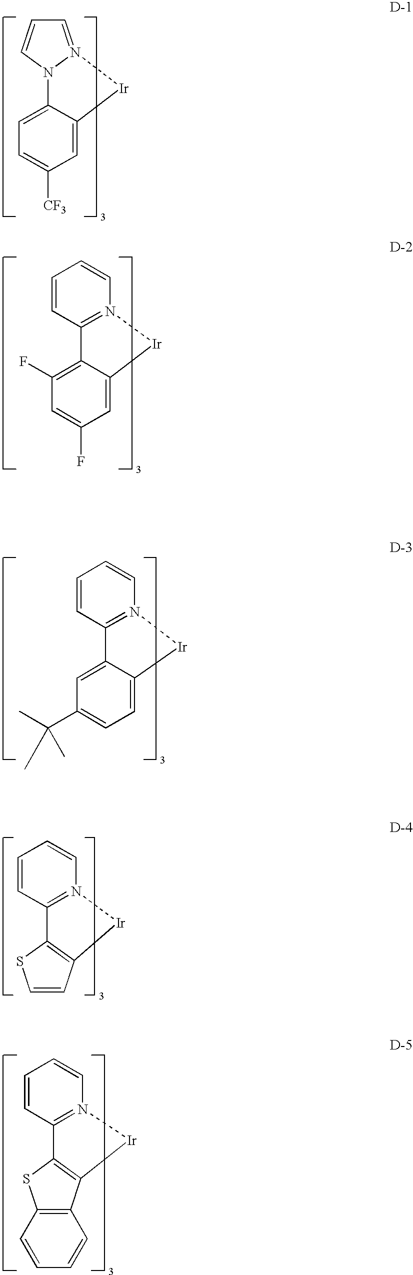

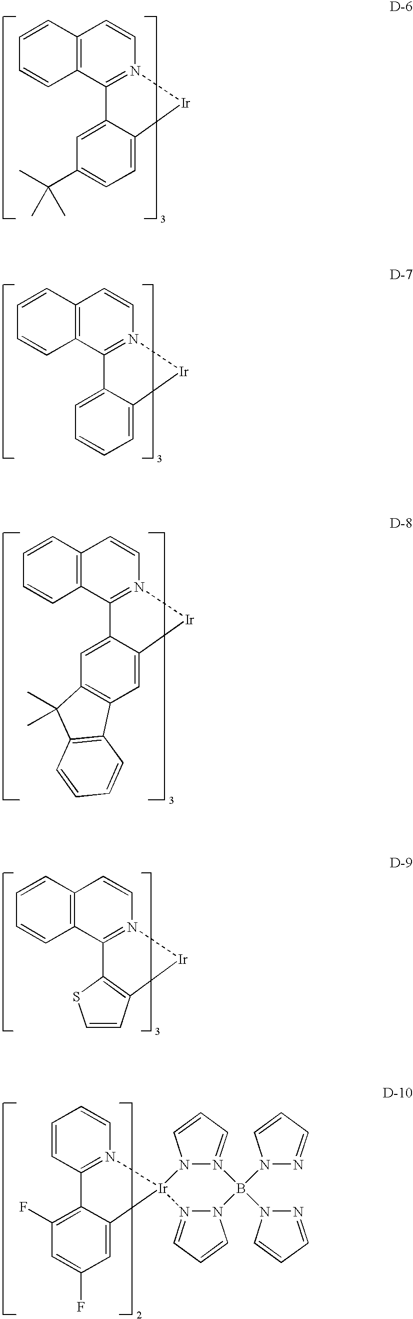

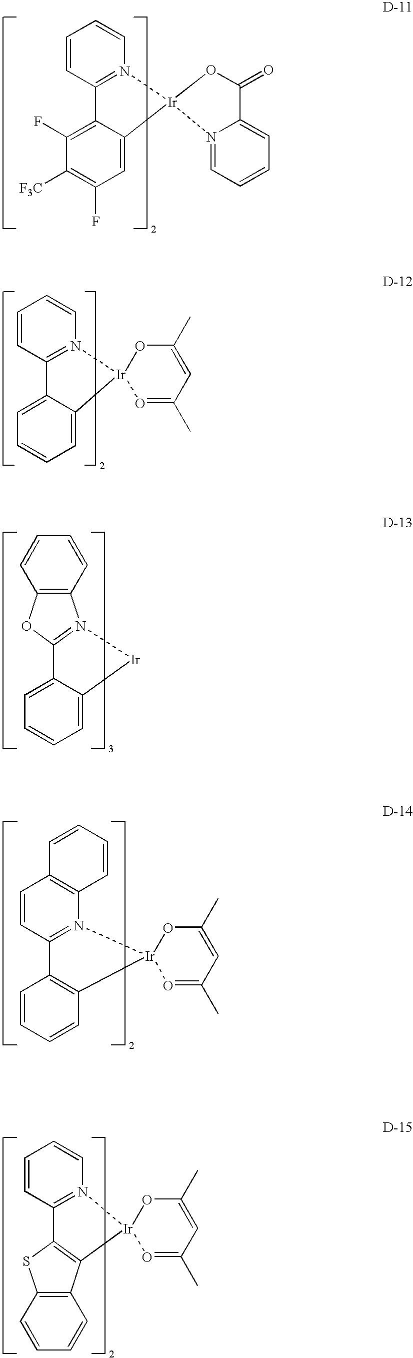

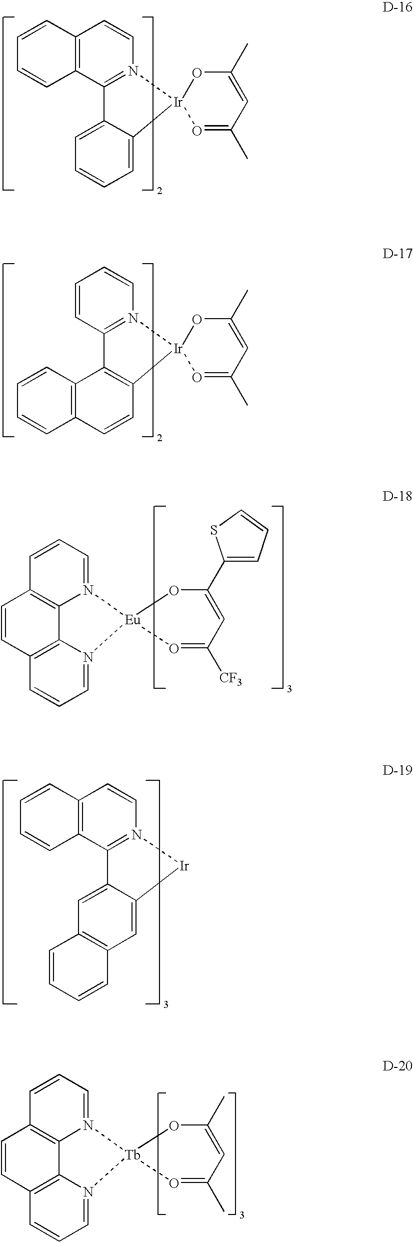

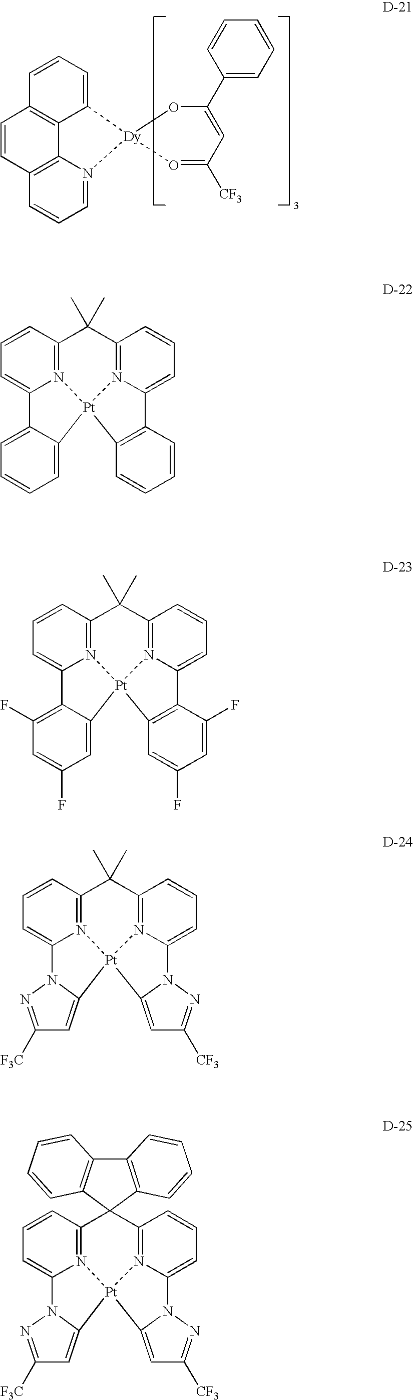

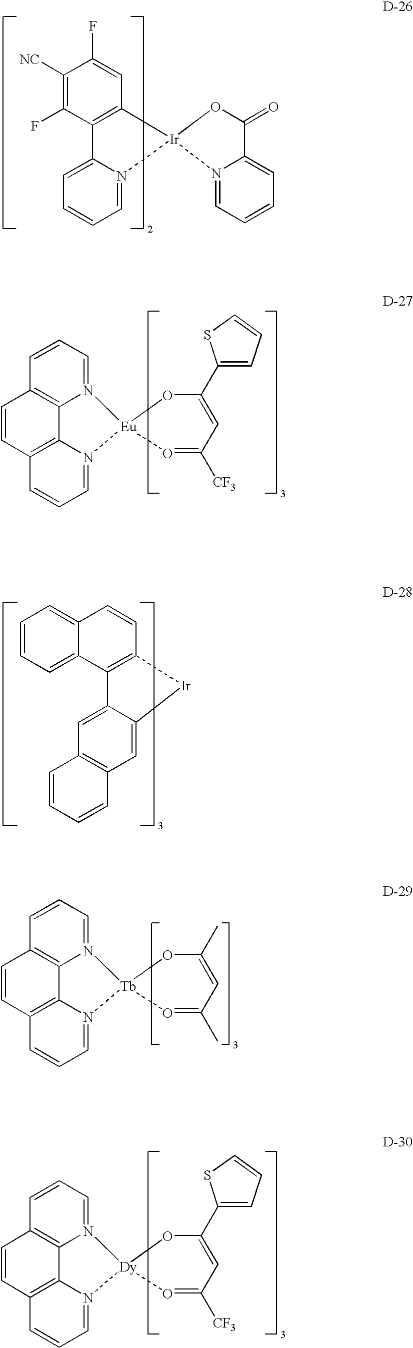

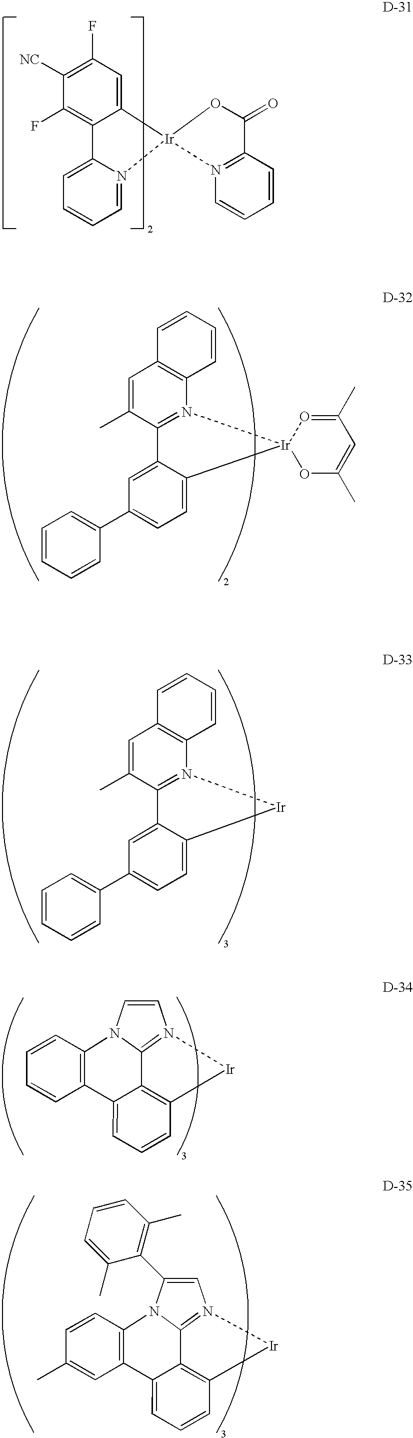

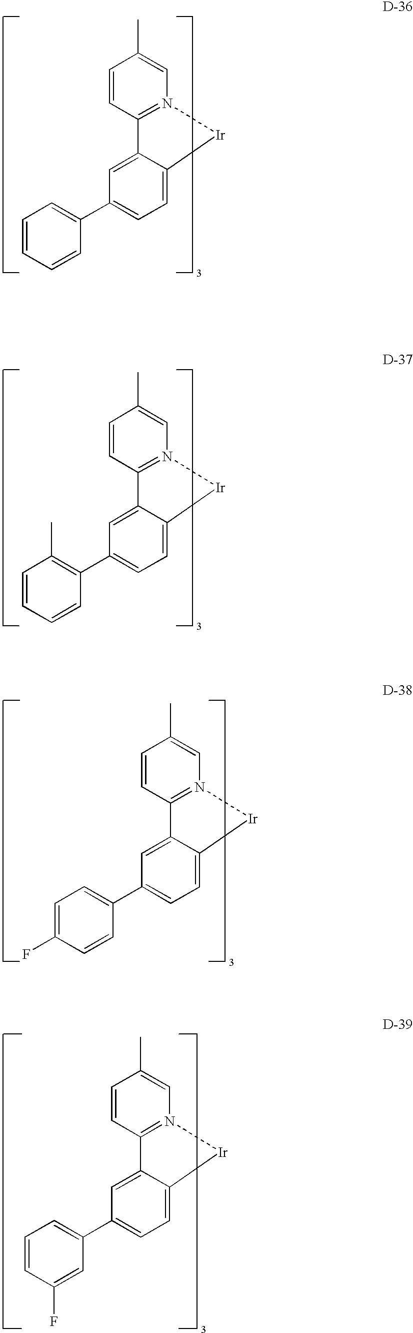

### (b) Fluorescent Light-Emitting Material

Examples of the fluorescent light-emitting materials generally include benzoxazole, benzoimidazole, benzothiazole, styrylbenzene, polyphenyl, diphenylbutadiene, tetraphenylbutadiene, naphthalimide, coumarin, pyran, perinone, oxadiazole, aldazine, pyralidine, cyclopentadiene, bis-styrylanthracene, quinacridone, pyrrolopyridine, thiadiazolopyridine, cyclopentadiene, styrylamine, aromatic dimethylidine compounds, condensed polycyclic aromatic compounds (naphthalene, anthracene, phenanthrene, phenanthroline, pyrene, perylene, rubrene, pentacene and the like), a variety of metal complexes represented by metal complexes of 8-quinolinol, pyromethene complexes or rare-earth metal complexes, polymer compounds such as polythiophene, polyphenylene or polyphenylenevinylene, organosilane, and derivatives thereof.

Preferably, the light emitting material used in the present invention is a phosphorescent light-emitting material, which is an electron-transporting phosphorescent light-emitting material having an electron affinity (Ea) of from 2.5 eV to 3.5 eV, and an ionization potential (Ip) of from 5.7 eV to 7.0 eV.

Specific examples include metal complexes of ruthenium, rhodium, palladium, tungsten, rhenium, osmium, iridium, platinum, gold, lanthanum, cerium, praseodymium, neodymium, samarium, europium, gadolinium, terbium, dysprosium, holmium, erbium, thulium, ytterbium, or lutetium. Metal complexes of ruthenium, rhodium, palladium, rhenium, iridium, or platinum are preferred, and an iridium complex and a platinum complex are most preferred.

The phosphorescent light-emitting material used in the present invention is particularly preferably a metal complex having a tri- or higher-dentate ligand.

(Metal Complex Having Poly-Dentate Ligand)

The metal complex having a tri- or higher-dentate ligand used in the present invention is to be described.

### 1) Metal Ion

An atom which coordinates to a metal ion in the metal complex is not particularly limited, but examples thereof preferably include an oxygen atom, a nitrogen atom, a carbon atom, a sulfur atom and a phosphorus atom, more preferably an oxygen atom, a nitrogen atom and a carbon atom, and even more preferably a nitrogen atom and a carbon atom.

The metal ion in the metal complex is not particularly limited, but a transition metal ion or a rare earth metal ion is preferable from the viewpoints of improving light-emission efficiency, improving durability and lowering driving voltage. Specific examples thereof include an iridium ion, a platinum ion, a gold ion, a rhenium ion, a tungsten ion, a rhodium ion, a ruthenium ion, an osmium ion, a palladium ion, a silver ion, a copper ion, a cobalt ion, a zinc ion, a nickel ion, a lead ion, an aluminum ion, a gallium ion and a rare earth metal ion (for example, a europium ion, a gadolinium ion, a terbium ion or the like). Preferred is an iridium ion, a platinum ion, a gold ion, a rhenium ion, a tungsten ion, a palladium ion, a zinc ion, an aluminum ion, a gallium ion, a europium ion, a gadolinium ion or a terbium ion, more preferred is an iridium ion, a platinum ion, a rhenium ion, a tungsten ion, a europium ion, a gadolinium ion or a terbium ion even more preferred is an iridium ion, a platinum ion, a palladium ion, a zinc ion, an aluminum ion or a gallium ion, and most preferred is a platinum ion.

### 2) Coordination Number

The metal complex having a tri- or higher-dentate ligand in the present invention is preferably a metal complex having a tridentate to hexadentate ligand from the viewpoints of improving light-emission efficiency and improving durability. In the case where a metal ion is easy to form a hexacoordinate complex exemplified by an iridium ion, a metal complex having a tridentate ligand, a tetradentate ligand or a hexadentate ligand is preferable. In the case where a metal ion is easy to form a tetracoordinate complex exemplified by a platinum ion, a metal complex having a tridentate ligand or a tetradentate ligand is preferable, and a metal complex having a tetradentate ligand is more preferable.

### 3) Ligand

The ligand of the metal complex in the present invention is preferably a chain ligand or cyclic ligand from the viewpoints of improving light-emission efficiency and improving durability. More preferred is a ligand having at least one nitrogen-containing heterocycle which coordinates to a central metal (for example, M¹¹ in the compound represented by formula (A) described below) through a nitrogen atom. Examples of the nitrogen-containing heterocycle include a pyridine ring, a quinoline ring, a pyrimidine ring, a pyrazine ring, a pyrrole ring, an imidazole ring, a pyrazole ring, an oxazole ring, a thiazole ring, an oxadiazole ring, a thiadiazole ring, a triazole ring and the like. Among them, a 6-membered or 5-membered nitrogen-containing heterocycle is more preferred. The heterocycle may form a condensed ring with another ring.

The chain ligand in the metal complex is defined as a ligand having no cyclic structure in the metal complex (for example, a ter-pyridyl ligand or the like). The cyclic ligand of the metal complex is defined to indicate that plural ligands in the metal complex combine with each other to form a closed structure (for example, a phthalocyanine ligand, a crown ether ligand or the like).

### 4) Preferable Structure of Metal Complex

The metal complex in the present invention is preferably an organic compound represented by formula (A), which is described below in detail.

### <Metal Complex Represented by Formula (A)>

In the first place, the organic compound represented by formula (A) is to be described.

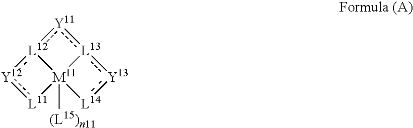

In formula (A), M¹¹ represents a metal ion. L¹¹ to L¹⁵ each represent a ligand which coordinates to M¹¹. An atomic group may further exist between L¹¹ to L¹⁴ to form a cyclic ligand. L¹⁵ may bonds to both L¹¹ and L¹⁴ to form a cyclic ligand. Y¹¹, Y¹² and Y¹³ each represent a linking group, a single bond or a double bond. In the case where Y¹¹, Y¹² or Y¹³ represents a linking group, bonds between L¹¹ and Y¹², Y¹² and L¹², L¹² and Y¹¹, Y¹¹ and L¹³, L¹³ and Y¹³, and Y¹³ and L¹⁴ each independently represent a single bond or a double bond. n11 represents an integer of from 0 to 4. Bonds between M¹¹ and L¹¹ to L¹⁵ are each independently a coordination bond, an ionic bond or a covalent bond.

The organic compound represented by formula (A) is to be described in detail.

In formula (A), M¹¹ represents a metal ion. The metal ion is not particularly limited, but a divalent or trivalent metal ion is preferred. Examples of the divalent or trivalent metal ion preferably include a gold ion, a platinum ion, an iridium ion, a rhenium ion, a palladium ion, a rhodium ion, a ruthenium ion, a copper ion, a europium ion, a gadolinium ion and a terbium ion, more preferably a platinum ion, an iridium ion and a europium ion, and even more preferably a platinum ion and an iridium ion. Among them, a platinum ion is particularly preferred.

In formula (A), L¹¹, L¹², L¹³ and L¹⁴ each independently represent a ligand which coordinates to M¹¹. Examples of the atom which is contained in L¹¹, L¹², L¹³ or L¹⁴ and coordinates to M¹¹ preferably include a nitrogen atom, an oxygen atom, a sulfur atom, a carbon atom and a phosphorus atom, more preferably a nitrogen atom, an oxygen atom, a sulfur atom and a carbon atom, and even more preferably a nitrogen atom, an oxygen atom and a carbon atom.

The bonds formed by M¹¹ and L¹¹, L¹², L¹³ or L¹⁴ are each independently a covalent bond, an ionic bond or a coordination bond. The term ligand in the present invention may include, for the sake of explanation, those formed by an ionic bond or a covalent bond besides a coordination bond.

The ligand formed by L¹¹, Y¹², L¹², Y¹¹, L¹³, Y¹³ and L¹⁴ is preferably an anionic ligand, wherein at least one anion is bonded to the metal. A number of the anion in the anionic ligand is preferably 1 to 3, more preferably 1 or 2, and even more preferably 2.

L¹¹, L¹², L¹³ or L¹⁴ which coordinates to M¹¹ through a carbon atom is not particularly limited, but examples thereof include independently an imino ligand, an aromatic carbon ring ligand (for example, a benzene ligand, a naphthalene ligand, an anthracene ligand, a phenanthrene ligand or the like), and a heterocyclic ligand (for example, a thiophene ligand, a pyridine ligand, a pyrazine ligand, a pyrimidine ligand, a thiazole ligand, an oxazole ligand, a pyrrole ligand, an imidazole ligand, a pyrazole ligand, a condensed ring body thereof (for example, a quinoline ligand, a benzothiazole ligand or the like) or a tautomer thereof).

L¹¹, L¹², L¹³ or L¹⁴ which coordinates to M¹¹ through a nitrogen atom is not particularly limited, but examples thereof include independently a nitrogen-containing heterocyclic ligand (for example, a pyridine ligand, a pyrazine ligand, a pyrimidine ligand, a pyridazine ligand, a triazine ligand, a thiazole ligand, an oxazole ligand, a pyrrole ligand, an imidazole ligand, a pyrazole ligand, a triazole ligand, an oxadiazole ligand, a thiadiazole ligand, a condensed ring body thereof (for example, a quinoline ligand, a benzoxazole ligand, a benzimidazole ligand or the like) and a tautomer thereof (the tautomer in the present invention is defined that the following examples are also regarded as the tautomer. For example, a 5-membered heterocyclic ligand of Compound (24) and a terminal 5-membered heterocyclic ligand of Compound (64), which are described on pages 57 and 61 respectively, are defined to be included in a pyrrole tautomer.), and an amino ligand (an alkylamino ligand (having preferably 2 to 30 carbon atoms, more preferably 2 to 20 carbon atoms, and even more preferably 2 to 10 carbon atoms; for example, methylamino or the like), an arylamino ligand (for example, phenylamino or the like), an acylamino ligand (having preferably 2 to 30 carbon atoms, more preferably 2 to 20 carbon atoms, and even more preferably from 2 to 10 carbon atoms; for example, acetylamino, benzoylamino or the like), an alkoxycarbonylamino ligand (having preferably 2 to 30 carbon atoms, more preferably 2 to 20 carbon atoms, and even more preferably 2 to 12 carbon atoms; for example, methoxycarbonylamino or the like), an aryloxycarbonylamino ligand (having preferably 7 to 30 carbon atoms, more preferably 7 to 20 carbon atoms, and even more preferably 7 to 12 carbon atoms; for example, phenyloxycarbonylamino or the like), a sulfonylamino ligand (having preferably 1 to 30 carbon atoms, more preferably 1 to 20 carbon atoms, and even more preferably 1 to 12 carbon atoms; for example, methanesulfonylamino, benzenesulfonylamino or the like), an imino ligand or the like). These ligands may be further substituted.

L¹¹, L¹², L¹³ or L¹⁴ which coordinates to M¹¹ through an oxygen atom is not particularly limited, but examples thereof include independently an alkoxy ligand (having preferably 1 to 30 carbon atoms, more preferably 1 to 20 carbon atoms, and even more preferably 1 to 10 carbon atoms; for example, methoxy, ethoxy, butoxy, 2-ethylhexyloxy or the like), an aryloxy ligand (having preferably 6 to 30 carbon atoms, more preferably 6 to 20 carbon atoms, and even more preferably 6 to 12 carbon atoms; for example, phenyloxy, 1-naphthyloxy, 2-naphthyloxy or the like), a heterocyclic oxy ligand (having preferably 1 to 30 carbon atoms, more preferably 1 to 20 carbon atoms, and even more preferably 1 to 12 carbon atoms; for example, pyridyloxy, pyrazinyloxy, pyrimidyloxy, quinolyloxy or the like), an acyloxy ligand (having preferably 2 to 30 carbon atoms, more preferably 2 to 20 carbon atoms, and even more preferably 2 to 10 carbon atoms; for example, acetoxy, benzoyloxy or the like), a silyloxy ligand (having preferably 3 to 40 carbon atoms, more preferably 3 to 30 carbon atoms, and even more preferably 3 to 24 carbon atoms; for example, trimethylsilyloxy, triphenylsilyloxy or the like), a carbonyl ligand (for example, a ketone ligand, an ester ligand, an amido ligand or the like), and an ether ligand (for example, a dialkyl ether ligand, a diaryl ether ligand, a furyl ligand or the like). These ligands may be further substituted.

L¹¹, L¹², L¹³ or L¹⁴ which coordinates to M¹¹ through a sulfur atom is not particularly limited, but examples thereof include independently an alkylthio ligand (having preferably 1 to 30 carbon atoms, more preferably 1 to 20 carbon atoms, and even more preferably 1 to 12 carbon atoms; for example, methylthio, ethylthio or the like), an arylthio ligand (having preferably 6 to 30 carbon atoms, more preferably 6 to 20 carbon atoms, and even more preferably 6 to 12 carbon atoms; for example, phenylthio or the like), a heterocyclic thio ligand (having preferably 1 to 30 carbon atoms, more preferably 1 to 20 carbon atoms, and even more preferably 1 to 12 carbon atoms; for example, pyridylthio, 2-benzimidazolylthio, 2-benzoxazolylthio, 2-benzthiazolylthio or the like), a thiocarbonyl ligand (for example, a thioketone ligand, a thioester ligand or the like) and a thioether ligand (for example, a dialkylthio ether ligand, a diarylthio ether ligand, a thiofuryl ligand or the like). These ligands may be further substituted.

L¹¹, L¹², L¹³ or L¹⁴ which coordinates to M¹¹ through a phosphorus atom is not particularly limited, but examples thereof include independently a dialkylphosphino group, a diarylphosphino group, a trialkylphosphino group, a triarylphosphino group, a phosphinino group and the like. The groups may be further substituted.

L¹¹ and L¹⁴ each independently represent preferably an aromatic carbon ring ligand, an alkyloxy ligand, an aryloxy ligand, an ether ligand, an alkylthio ligand, an arylthio ligand, an alkylamino ligand, an arylamino ligand, an acylamino ligand, and a nitrogen-containing heterocyclic ligand (for example, a pyridine ligand, a pyrazine ligand, a pyrimidine ligand, a pyridazine ligand, a triazine ligand, a thiazole ligand, an oxazole ligand, a pyrrole ligand, an imidazole ligand, a pyrazole ligand, a triazole ligand, an oxadiazole ligand, a thiadiazole ligand, or a condensed ring body thereof (for example, a quinoline ligand, a benzoxazole ligand, a benzimidazole ligand or the like) or a tautomer thereof, more preferably an aromatic carbon ring ligand, an aryloxy ligand, an arylthio ligand, an arylamino ligand, a pyridine ligand, a pyrazine ligand, an imidazole ligand, a condensed ring body thereof (for example, a quinoline ligand, a quinoxaline ligand, a benzimidazole ligand or the like) or a tautomer thereof, and even more preferably an aromatic carbon ring ligand, an aryloxy ligand, an arylthio ligand, or an arylamino ligand. Among them, an aromatic carbon ring ligand or an aryloxy ligand is particularly preferable.

L¹²and L¹³ each independently preferably represent a ligand forming a coordination bond with M¹¹. Examples of the ligand forming a coordination bond with M¹¹ preferably include a pyridine ring, a pyrazine ring, a pyrimidine ring, a triazine ring, a thiazole ring, an oxazole ring, a pyrrole ring, a triazole ring, a condensed ring body thereof (for example, a quinoline ring, a benzoxazole ring, a benzimidazole ring, an indolenine ring or the like) and a tautomer thereof, more preferably a pyridine ring, a pyrazine ring, a pyrimidine ring, a pyrrole ring, a condensed ring body thereof (for example, a quinoline ring, a benzpyrrole ring or the like) and a tautomer thereof, and even more preferably a pyridine ring, a pyrazine ring, a pyrimidine ring and a condensed ring body thereof (for example, a quinoline ring or the like). Among them, a pyridine ring or a condensed ring body including a pyridine ring (for example, a quinoline ring or the like) is particularly preferable.

In formula (A), L¹⁵ represents a ligand which coordinates to M¹¹. L¹⁵ is preferably a monodentate to tetradentate ligand, and more preferably an anionic monodentate to tetradentate ligand. The anionic monodentate to tetradentate ligand is not particularly limited, but preferred examples thereof include a halogen ligand, a 1,3-diketone ligand (for example, an acetylacetone ligand or the like), a monoanionic bidentate ligand including a pyridine ligand (for example, a picolinic acid ligand, a 2-(2-hydroxyphenyl)-pyridine ligand or the like) and a tetradentate ligand formed by L¹¹, Y¹², L¹², Y¹¹, L¹³, Y¹³ and L¹⁴, more preferably a 1,3-diketone ligand (for example, an acetylacetone ligand, or the like), a monoanionic bidentate ligand including a pyridine ligand (for example, a picolinic acid ligand, a 2-(2-hydroxyphenyl)-pyridine ligand or the like), and a tetradentate ligand formed by L¹¹, Y¹², L¹², Y¹¹, L¹³, Y¹³ and L¹⁴, and even more preferably a 1,3-diketone ligand (for example, an acetylacetone ligand or the like) and a monoanionic bidentate ligand including a pyridine ligand (for example, a picolinic acid ligand, a 2-(2-hydroxyphenyl)-pyridine ligand, or the like). Among them, a 1,3-diketone ligand (for example, acetylacetone ligand or the like) is particularly preferable. The coordination numbers and ligand numbers do not exceed the coordination number of the metal. However, L¹⁵ may bond to both L¹¹ and L¹⁴ to form a cyclic ligand with them.

In formula (A), Y¹¹, Y¹² and Y¹³ each independently represent a linking group, a single bond or a double bond. The linking group is not particularly limited, but a linking group comprising an atom selected from carbon atom, nitrogen atom, oxygen atom, sulfur atom, silicon atom and phosphorus atom is preferable. Specific examples of the linking group are described below.

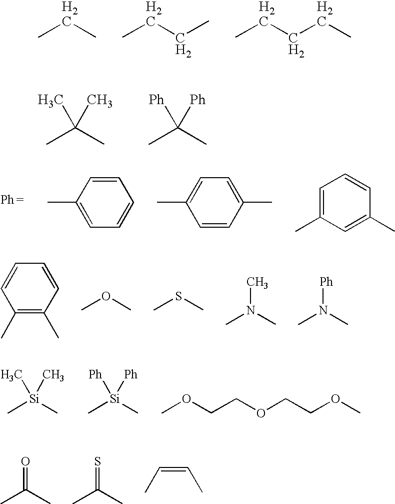

In the case where Y¹¹, Y¹² or Y¹³ represents a linking group, bonds between L¹¹ and Y¹², Y¹² and L¹², L¹² and Y¹¹, Y¹¹ and L¹¹, L¹³ and Y¹³, and Y¹³ and L¹⁴ each independently represent a single bond or a double bond.

Preferably, Y¹¹, Y¹² and Y¹³ each independently represent a single bond, a double bond, a carbonyl linking group, an alkylene linking group, or an alkenylene group. Y¹¹ is more preferably a single bond or an alkylene group, and even more preferably an alkylene group. Y¹² and Y¹³ each independently represent more preferably a single bond or an alkenylene group, and even more preferably a single bond.

The ring formed by Y¹², L¹¹, L¹², and M¹¹, the ring formed by Y¹¹, L¹², L¹³ and M¹¹, and the ring formed by Y¹³, L¹³, L¹⁴ and M¹¹ are each preferably a 4- to 10-membered ring, more preferably a 5- to 7-membered ring, and even more preferably a 5- or 6-membered ring.

In formula (A), n11 represents an integer of from 0 to 4. When M¹¹ is a metal having a coordination number of 4, n11 represents 0. In the case where M¹¹ is a metal having a coordination number of 6, n¹¹ preferably represents 1 or 2, and more preferably 1. When M¹¹ is a metal having a coordination number of 6 and n11 represents 1, L¹⁵ represents a bidentate ligand. When M¹¹ is a metal having a coordination number of 6 and n11 represents 2, L¹⁵ represents a monodentate ligand. In the case where M¹¹ is a metal having a coordination number of 8, n11 preferably represents 1 to 4, more preferably 1 or 2, and even more preferably 1. When M¹¹ is a metal having a coordination number of 8 and n11 represents 1, L¹⁵ represents a tetradentate ligand. When M¹¹ is a metal having a coordination number of 8 and n11 represents 2, L¹⁵ represents a bidentate ligand. When n11 is 2 or more, plural L¹⁵s may be the same or different from each other.

Specific examples of the compound represented by formula (A) include the following compounds, but it should be noted that the present invention is not limited thereto.

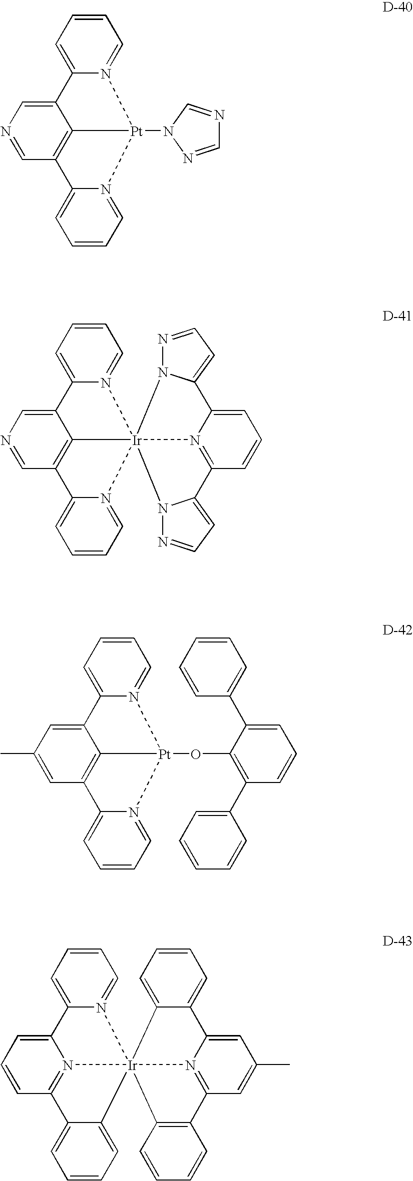

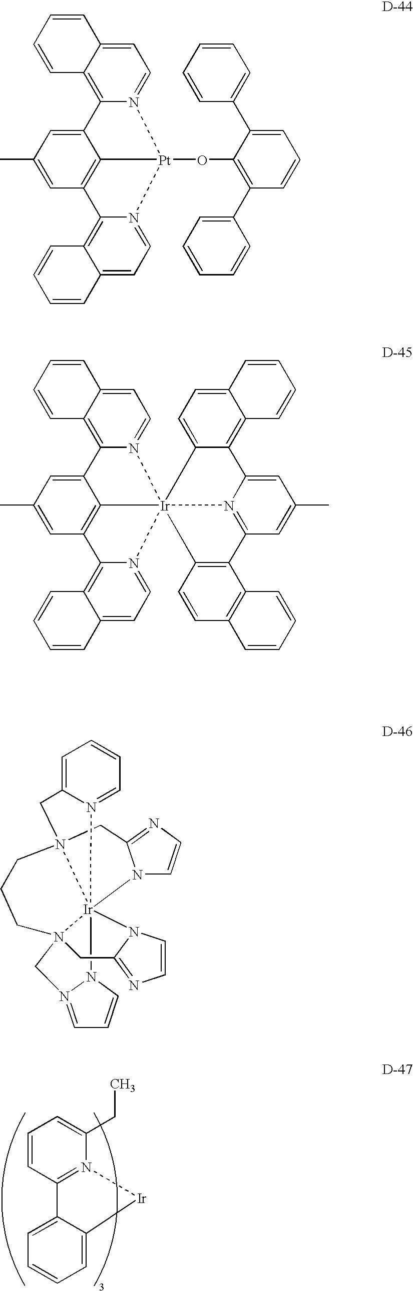

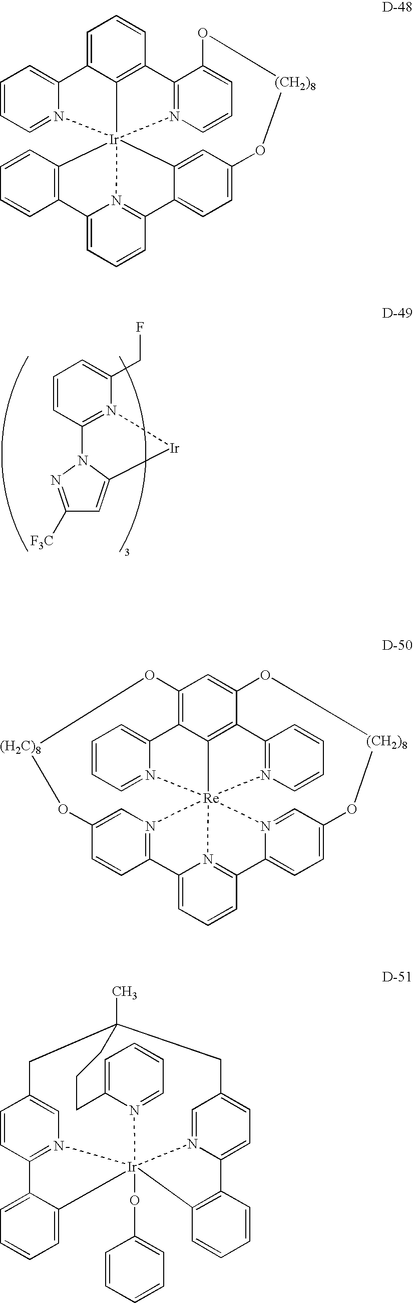

Among the compound represented by formula (A), a platinum complex, wherein M is a platinum atom, is particularly preferable as a polydentate metal complex.

Preferable embodiments of the platinum complex include a platinum complex represented by formula (C-1) described below.

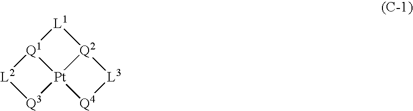

In the formula, Q¹, Q², Q³ and Q⁴ each independently represent a ligand which coordinates to Pt. L¹, L² and L³ each independently represent a single bond or a divalent linking group.

Formula (C-1) is to be described in detail. Q¹, Q², Q³ and Q⁴ each independently represent a ligand which coordinates to Pt. Bonds between Pt and Q¹, Q², Q³ or Q⁴ are each a covalent bond, an ionic bond or a coordination bond. Examples of the atom which is contained in Q¹, Q², Q³ and Q⁴, and bonds to Pt preferably include a carbon atom, a nitrogen atom, an oxygen atom, a sulfur atom and a phosphorus atom, wherein at least one of the atoms which is contained in Q¹, Q², Q³ and Q⁴, and bonds to Pt is preferably a carbon atom, and more preferably at least two of the atoms are carbon atoms.

Q¹, Q², Q³ and Q⁴ which bond to Pt through a carbon atom are each an anionic ligand or a neutral ligand. Examples of the anionic ligand include a vinyl ligand, an aromatic hydrocarbon ring ligand (for example, a benzene ligand, a naphthalene ligand, an anthracene ligand, a phenanthrene ligand or the like) and a heterocyclic ligand (for example, a furan ligand, a thiophene ligand, a pyridine ligand, a pyrazine ligand, a pyrimidine ligand, a pyridazine ligand, a triazine ligand, a thiazole ligand, an oxazole ligand, a pyrrole ligand, an imidazole ligand, a pyrazole ligand, a triazole ligand or a condensed ring body thereof (for example, a quinoline ligand, a benzothiazole ligand or the like)). Examples of the neutral ligand include a carben ligand.

Q¹, Q², Q³ and Q⁴ which bond to Pt through a nitrogen atom are each a neutral ligand or an anionic ligand. Examples of the neutral ligand include a nitrogen-containing aromatic heterocyclic ligand (for example, a pyridine ligand, a pyrazine ligand, a pyrimidine ligand, a pyridazine ligand, a triazine ligand, an imidazole ligand, a pyrazole ligand, a triazole ligand, an oxazole ligand, a thiazole ligand or a condensed ring body thereof (for example, a quinoline ligand, a benzimidazole ligand or the like)), an amine ligand, a nitrile ligand and an imine ligand. Examples of the anionic ligand include an amino ligand, an imino ligand and a nitrogen-containing aromatic heterocyclic ligand (for example, a pyrrole ligand, an imidazole ligand, a triazole ligand or a condensed ring body thereof (for example, an indole ligand, a benzimidazole ligand or the like)).

Q¹, Q², Q³ and Q⁴ which bond to Pt through an oxygen atom are each a neutral ligand or an anionic ligand. Examples of the neutral ligand include an ether ligand, a ketone ligand, an ester ligand, an amido ligand and an oxygen-containing heterocyclic ligand (for example, a furan ligand, an oxazole ligand or a condensed ring body thereof (for example, a benzoxazole ligand or the like)). Examples of the anionic ligand include an alkoxy ligand, an aryloxy ligand, a heteroaryloxy ligand, an acyloxy ligand, a silyloxy ligand and the like.

Q¹, Q², Q³ and Q⁴ which bond to Pt through a sulfur atom are each a neutral ligand or an anionic ligand. Examples of the neutral ligand include a thioether ligand, a thioketone ligand, a thioester ligand, a thioamido ligand and a sulfur-containing heterocyclic ligand (for example, a thiophene ligand, a thiazole ligand or a condensed ring body thereof (for example, a benzothiazole ligand or the like)). Examples of the anionic ligand include an alkylmercapto ligand, an arylmercapto ligand, a heteroarylmercapto ligand and the like.

Q¹, Q², Q³ and Q⁴ which bond to Pt through a phosphorus atom are each a neutral ligand or an anionic ligand. Examples of the neutral ligand include a phosphine ligand, a phosphoric acid ester ligand, a phosphorus acid ester ligand and a phosphorus-containing heterocyclic ligand (for example, a phosphinine ligand or the like). Examples of the anionic ligand include a phosphino ligand, a phosphinyl ligand, a phosphoryl ligand and the like.

The groups represented by Q¹, Q², Q³ and Q⁴ may have a substituent. As the substituent, the substituents mentioned below with respect to substituent group A can be properly applied. The substituents may be linked with each other (in the case where Q³ and Q⁴ are linked, a Pt complex with a cyclic tetradentate ligand is formed).

(Substituent Group A)

The substituent group A consists of an alkyl group (having preferably 1 to 30 carbon atoms, more preferably 1 to 20 carbon atoms, and particularly preferably 1 to 10 carbon atoms; for example, a methyl group, an ethyl group, an iso-propyl group, a tert-butyl group, a n-octyl group, a n-decyl group, a n-hexadecyl group, a cyclopropyl group, a cyclopentyl group, a cyclohexyl group or the like), an alkenyl group (having preferably 2 to 30 carbon atoms, more preferably 2 to 20 carbon atoms, and particularly preferably 2 to 10 carbon atoms; for example, a vinyl group, an allyl group, a 2-butenyl group, a 3-pentenyl group or the like), an alkynyl group (having preferably 2 to 30 carbon atoms, more preferably 2 to 20 carbon atoms, and particularly preferably 2 to 10 carbon atoms; for example, a propargyl group, a 3-pentynyl group or the like), an aryl group (having preferably 6 to 30 carbon atoms, more preferably 6 to 20 carbon atoms, and particularly preferably 6 to 12 carbon atoms; for example, a phenyl group, a p-methylphenyl group, a naphthyl group, an anthranyl group or the like), an amino group (having preferably 0 to 30 carbon atoms, more preferably 0 to 20 carbon atoms, and particularly preferably 0 to 10 carbon atoms; for example, an amino group, a methylamino group, a dimethylamino group, a diethylamino group, a dibenzylamino group, a diphenylamino group, a ditolylamino group or the like), an alkoxy group (having preferably 1 to 30 carbon atoms, more preferably 1 to 20 carbon atoms, and particularly preferably 1 to 10 carbon atoms; for example, a methoxy group, an ethoxy group, a butoxy group, a 2-ethylhexyloxy group or the like), an aryloxy group (having preferably 6 to 30 carbon atoms, more preferably 6 to 20 carbon atoms, and particularly preferably 6 to 12 carbon atoms; for example, a phenyloxy group, a 1-naphthyloxy, a 2-naphthyloxy group or the like), a heterocyclic oxy group (having preferably 1 to 30 carbon atoms, more preferably 1 to 20 carbon atoms, and particularly preferably 1 to 12 carbon atoms; for example, a pyridyloxy group, a pyrazinyloxy group, a primidyloxy group, a quinolyloxy group or the like), an acyl group (having preferably 1 to 30 carbon atoms, more preferably 1 to 20 carbon atoms, and particularly preferably 1 to 12 carbon atoms; for example, an acetyl group, a benzoyl group, a formyl group, a pivaloyl group or the like), an alkoxycarbonyl group (having preferably 2 to 30 carbon atoms, more preferably 2 to 20 carbon atoms, and particularly preferably 2 to 12 carbon atoms; for example, a methoxycarbonyl group, an ethoxycarbonyl group or the like), an aryloxycarbonyl group (having preferably 7 to 30 carbon atoms, more preferably 7 to 20 carbon atoms, and particularly preferably 7 to 12 carbon atoms; for example, a phenyloxycarbonyl group or the like), an acyloxy group (having preferably 2 to 30 carbon atoms, more preferably 2 to 20 carbon atoms, and particularly preferably 2 to 10 carbon atoms; for example, an acetoxy group, a benzoyloxy group or the like), an acylamino group (having preferably 2 to 30 carbon atoms, more preferably 2 to 20 carbon atoms, and particularly preferably 2 to 10 carbon atoms; for example, an acetylamino group, a benzoylamino group or the like), an alkoxylcarbonylamino group (having preferably 2 to 30 carbon atoms, more preferably 2 to 20 carbon atoms, and particularly preferably 2 to 12 carbon atoms; for example, a methoxycarbonylamino group or the like), an aryloxycarbonylamino group (having preferably 7 to 30 carbon atoms, more preferably 7 to 20 carbon atoms, and particularly preferably 7 to 12 carbon atoms; for example, a phenyloxycarbonylamino group or the like), a sulfonylamino group (having preferably 1 to 30 carbon atoms, more preferably 1 to 20 carbon atoms, and particularly preferably 1 to 12 carbon atoms; for example, a methanesulfonylamino group, a benzenesulfonylamino group or the like), a sulfamoyl group (having preferably 0 to 30 carbon atoms, more preferably 0 to 20 carbon atoms, and particularly preferably 0 to 12 carbon atoms; for example, a sulfamoyl group, a methylsulfamoyl group, a dimethylsulfamoyl group, a phenylsulfamoyl group or the like), a carbamoyl group (having preferably 1 to 30 carbon atoms, more preferably 1 to 20 carbon atoms, and particularly preferably 1 to 12 carbon atoms; for example, a carbamoyl group, a methylcarbamoyl group, a diethylcarbamoyl group, a phenylcarbamoyl group or the like), an alkylthio group (having preferably 1 to 30 carbon atoms, more preferably 1 to 20 carbon atoms, and particularly preferably 1 to 12 carbon atoms; for example, a methylthio group, an ethylthio group or the like), an arylthio group (having preferably 6 to 30 carbon atoms, more preferably 6 to 20 carbon atoms, and particularly preferably 6 to 12 carbon atoms; for example, a phenylthio group or the like), a heterocyclic thio group (having preferably 1 to 30 carbon atoms, more preferably 1 to 20 carbon atoms, and particularly preferably 1 to 12 carbon atoms; for example, a pyridylthio group, a 2-benzimidazolylthio group, a 2-benzoxazolylthio group, a 2-benzthiazolylthio group or the like), a sulfonyl group (having preferably 1 to 30 carbon atoms, more preferably 1 to 20 carbon atoms, and particularly preferably 1 to 12 carbon atoms; for example, a mesyl group, a tosyl group or the like), a sulfinyl group (having preferably 1 to 30 carbon atoms, more preferably 1 to 20 carbon atoms, and particularly preferably 1 to 12 carbon atoms; for example, a methanesulfinyl group, a benzenesulfinyl group or the like), a ureido group (having preferably 1 to 30 carbon atoms, more preferably 1 to 20 carbon atoms, and particularly preferably 1 to 12 carbon atoms; for example, a ureido group, a methylureido group, a phenylureido group or the like), a phosphoric amido group (having preferably 1 to 30 carbon atoms, more preferably 1 to 20 carbon atoms, and particularly preferably 1 to 12 carbon atoms; for example, a diethylphosphoric amido group, a phenylphosphoric amido group or the like), a hydroxy group, a mercapto group, a halogen atom (for example, a fluorine atom, a chlorine atom, a bromine atom, or an iodine atom), a cyano group, a sulfo group, a carboxy group, a nitro group, a hydroxamic acid group, a sulfino group, a hydrazino group, an imino group, a heterocyclic group (having preferably 1 to 30 carbon atoms, and more preferably 1 to 12 carbon atoms; examples of the heteroatom including a nitrogen atom, an oxygen atom and a sulfur atom; specific examples of the heterocyclic group including an imidazolyl group, a pyridyl group, a quinolyl group, a furyl group, a thienyl group, a piperidyl group, a morpholino group, a benzoxazolyl group, a benzimidazolyl group, a benzthiazolyl group, a carbazolyl group, an azepinyl group or the like), a silyl group (having preferably 3 to 40 carbon atoms, more preferably 3 to 30 carbon atoms, and particularly preferably 3 to 24 carbon atoms; for example, a trimethylsilyl group, a triphenylsilyl group or the like), and a silyloxy group (having preferably 3 to 40 carbon atoms, more preferably 3 to 30 carbon atoms, and particularly preferably 3 to 24 carbon atoms; for example, a trimethylsilyloxy group, a triphenylsilyloxy group or the like).

Q¹, Q², Q³ and Q⁴ are each preferably an aromatic hydrocarbon ring ligand which bonds to Pt through a carbon atom, an aromatic heterocyclic ligand which bonds to Pt through a carbon atom, a nitrogen-containing aromatic heterocyclic ligand which bonds to Pt through a nitrogen atom, an acyloxy ligand, an alkyloxy ligand, an aryloxy ligand, a heteroaryloxy ligand or a silyloxy ligand, more preferably an aromatic hydrocarbon ring ligand which bonds to Pt through a carbon atom, an aromatic heterocyclic ligand which bonds to Pt through a carbon atom, a nitrogen-containing aromatic heterocyclic ligand which bonds to Pt through a nitrogen atom, an acyloxy ligand or an aryloxy ligand, and even more preferably an aromatic hydrocarbon ring ligand which bonds to Pt through a carbon atom, an aromatic heterocyclic ligand which bonds to Pt through a carbon atom, a nitrogen-containing aromatic heterocyclic ligand which bonds to Pt through a nitrogen atom or an acyloxy ligand.

L¹, L² and L³ represent a single bond or a divalent linking group. Examples of the divalent linking group represented by L¹, L² and L³ include an alkylene group (for example, methylene, ethylene, propylene or the like), an arylene group (for example, phenylene, or naththalenediyl), a heteroarylene group (for example, pyridinediyl, thiophenediyl or the like), an imino group (—NR—) (for example, a phenylimino group or the like), an oxy group (—O—), a thio group (—S—), a phosphinidene group (—PR—) (for example, a phenylphosphinidene group or the like), a silylene group (—SiRR′—) (for example, a dimethylsilylene group, a diphenylsilylene group or the like) and a combination thereof. These linking groups may be substituted further by a substituent.

Examples of L¹, L² and L³ include preferably a single bond, an alkylene group, an arylene group, a heteroarylene group, an imino group, an oxy group, a thio group and a silylene group, more preferably a single bond, an alkylene group, an arylene group and an imino group, more preferably a single bond, an alkylene group and an arylene group, more preferably a single bond, a methylene group and a phenylene group, more preferably a single bond, and a disubstituted methylene group, and even more preferably a single bond, a dimethylmethylene group, a diethylmethylene group, a diisobutylmethylene group, a dibenzylmethylene group, an ethylmethylmethylene group, a methylpropylmethylene group, a isobutylmethylmethylene group, a diphenylmethylene group, a methylphenylmethylene group, a cyclohexanediyl group, a cyclopentanediyl group, a fluorenediyl group and a fluoromethylmethylene group. Among them, a single bond, a dimethylmethylene group, a diphenylmethylene group and a cyclohexanediyl group are particularly preferable.

Preferable embodiments of the platinum complex represented by formula (C-1) include a platinum complex represented by the following formula (C-2).

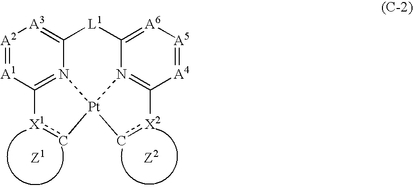

In the formula, L¹ represents a single bond or a divalent linking group. A¹ to A⁶ each independently represent C—R or N. R represents a hydrogen atom or a substituent. X¹ and X² represent C or N. Z¹ and Z² represent a 5-membered or 6-membered aromatic ring or aromatic heterocycle formed together with X—C in the formula.

Formula (C-2) is to be described in detail. L¹ represents a single bond or a divalent linking group. Examples of the divalent linking group represented by L¹ include an alkylene group (for example, methylene, ethylene, propylene or the like), an arylene group (for example, phenylene or naththalenediyl), a heteroarylene group (for example, pyridinediyl, thiophenediyl or the like), an imino group (—NR—) (for example, a phenylimino group or the like), an oxy group (—O—), a thio group (—S—), a phosphinidene group (—PR—) (for example, a phenylphosphinidene group or the like), a silylene group (—SiRR′—) (for example, a dimethylsilylene group, a diphenylsilylene group or the like) and a combination thereof. These linking groups may be substituted further by a substituent.

Examples of L¹ preferably include a single bond, an alkylene group, an arylene group, a heteroarylene group, an imino group, an oxy group, a thio group and a silylene group, more preferably a single bond, an alkylene group, an arylene group and an imino group, more preferably a single bond, an alkylene group and an arylene group, more preferably a single bond, a methylene group, and a phenylene group, more preferably a single bond, a disubstituted methylene group, and even more preferably a single bond, a dimethylmethylene group, a diethylmethylene group, a diisobutylmethylene group, a dibenzylmethylene group, an ethylmethylmethylene group, a methylpropylmethylene group, an isobutylmethylmethylene group, a diphenylmethylene group, a methylphenylmethylene group, a cyclohexanediyl group, a cyclopentanediyl group, a fluorenediyl group and a fluoromethylmethylene group. Among them, a single bond, a dimethylmethylene group, a diphenylmethylene group and a cyclohexanediyl group are particularly preferable. A¹ to A⁶ each independently represent C—R or N. R represents a hydrogen atom or a substituent. As the substituent represented by R, the substituents mentioned above with respect to the substituent for the compound represented formula (A) can be applied.

A¹ to A⁶ are preferably C—R, and Rs may combine together to form a ring. In the case where A¹ to A⁶ are C—R, examples of R included in A² and A⁵ preferably include a hydrogen atom, an alkyl group, an aryl group, an amino group, an alkoxy group, an aryloxy group, a fluorine atom and a cyano group, more preferably a hydrogen atom, an amino group, an alkoxy group, an aryloxy group and a fluorine atom, and particularly preferably a hydrogen atom and a fluorine atom. Examples of R included in A¹, A³, A⁴ and A⁶ preferably include a hydrogen atom, an alkyl group, an aryl group, an amino group, an alkoxy group, an aryloxy group, a fluorine atom and a cyano group, more preferably a hydrogen atom, an amino group, an alkoxy group, an aryloxy group and a fluorine atom, and particularly preferably a hydrogen atom. X¹ and X² represent C or N. Z¹ represents a 5-membered or 6-membered aromatic hydrocarbon ring or aromatic heterocycle formed together with X¹—C in the formula. Z² represents a 5-membered or 6-membered aromatic hydrocarbon ring or aromatic heterocycle formed together with X²—C in the formula. Examples of the aromatic hydrocarbon ring or aromatic heterocycle represented by Z¹ and Z² include a benzene ring, a naphthalene ring, an anthracene ring, a pyrene ring, a phenanthrene ring, a perylene ring, a pyridine ring, a quinoline ring, an isoquinoline ring, a phenanthridine ring, a pyrimidine ring, a pyrazine ring, a pyridazine ring, a triazine ring, a cinnoline ring, an acridine ring, a phthalazine ring, a quinazoline ring, a quinoxaline ring, a naphthyridine ring, a pteridine ring, a pyrrole ring, a pyrazole ring, a triazole ring, an indole ring, a carbazole ring, an indazole ring, a benzimidazole ring, an oxazole ring, a thiazole ring, an oxadiazole ring, a thiadiazole ring, a benzoxazole ring, a benzothiazole ring, an imidazopyridine ring, a thiophene ring, a benzothiophene ring, a furan ring, a benzofuran ring, a phosphole ring, a phosphinine ring, a silole ring and the like. Z¹ and Z² may have a substituent. As the substituent, the substituents mentioned above with respect to the substituent for the compound represented formula (A) can be applied. Furthermore, Z¹ and Z² may form a condensed ring by combining with another ring.

Examples of Z¹ and Z² include preferably a benzene ring, a naphthalene ring, a pyrazole ring, an imidazole ring, a triazole ring, a pyridine ring, a pyrimidine ring, an indole ring and a thiophene ring, and more preferably a benzene ring, a pyrazole ring and a pyridine ring.

Preferable embodiments of the platinum complex represented by formula (C-2) include a platinum complex represented by the following formula (C-3).

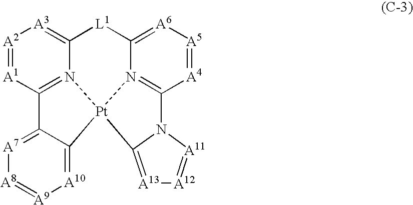

In the formula, A¹ to A¹³ each independently represent C—R or N. R represents a hydrogen atom or a substituent. L¹ represents a single bond or a divalent linking group.

Formula (C-3) is to be described in detail. L¹ and A¹ to A⁶ have the same meaning as L¹ and A¹ to A⁶ in formula (C-2) and a similar preferable range. A⁷, A⁸, A⁹ and A¹⁰ each independently represent C—R or N, wherein at least one from among A⁷, A⁸, A⁹ and A¹⁰ represents N. R represents a hydrogen atom or a substituent. As for the substituent represented by R, the substituents mentioned above with respect to the substituent group A can be applied. In the case where A⁷, A⁸, A⁹ and A¹⁰ are C—R, examples of R include preferably a hydrogen atom, an alkyl group, a perfluoroalkyl group, an aryl group, an aromatic heterocyclic group, a dialkylamino group, a diarylamino group, an alkyloxy group, a cyano group and a halogen atom, more preferably an alkyl group, a perfluoroalkyl group, an aryl group, a dialkylamino group, a cyano group and a fluorine atom, and even more preferably an alkyl group, a trifluoromethyl group and a fluorine atom. The substituent may combine together to form a condensed ring if possible.

At least one from among A⁷, A⁸, A⁹ and A¹⁰ represents a N atom, wherein a number of the N atoms is preferably 1 or 2, and more preferably 1.

The position of N atom among A⁷, A⁸, A⁹ and A¹⁰ is not limited, but preferably N atom is in A⁸ or A⁹, and more preferably in A⁸.

Examples of 6-membered ring formed by two carbon atoms, A⁷, A⁸, A⁹ and A¹⁰ preferably include a pyridine ring, a pyrazine ring, a pyrimidine ring, a pyridazine ring and a triazine ring, more preferably a pyridine ring, a pyrazine ring, a pyrimidine ring and a pyridazine ring, and particularly preferably a pyridine ring. In the case where the 6-membered ring described above is selected from a pyridine ring, a pyrazine ring, a pyrimidine ring and a pyridazine ring (particularly preferably a pyridine ring), the acidity of the hydrogen atom in the site where a metal-carbon bond is formed is increased, so that a metal complex can be easily formed compared with a benzene ring.

A¹¹, A¹² and A¹³ each independently represent C—R or N. R represents a hydrogen atom or a substituent. As the substituent represented by R, the substituents mentioned above with respect to the substituent for the compound represented by formula (A) can be applied. In the case where A¹¹, A¹² and A¹³ is C—R, examples of R include preferably a hydrogen atom, an alkyl group, a perfluoroalkyl group, an aryl group, an aromatic heterocyclic group, a dialkylamino group, a diarylamino group, an alkyloxy group, a cyano group and a halogen atom, more preferably an alkyl group, a perfluoroalkyl group, an aryl group, a dialkylamino group, a cyano group and a fluorine atom, and even more preferably an alkyl group, a trifluoromethyl group and a fluorine atom. The substituents may combine together to form a condensed ring.

Preferable embodiments of the platinum complex represented by formula (C-2) include a platinum complex represented by the following formula (C-4).

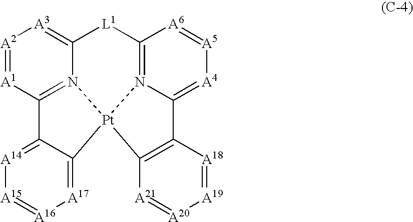

In formula (C-4), A¹ to A⁶ and A¹⁴ to A²¹ each independently represent C—R or N. R represents a hydrogen atom or a substituent. L¹ represents a single bond or a divalent linking group.

Formula (C-4) is to be described in detail.

A¹ to A⁶ and A¹⁴ to A²¹ each independently represent C—R or N. R represents a hydrogen atom or a substituent. A¹ to A⁶ and L¹ have the same meaning as A¹ to A⁶ and L¹ in formula (C-2) described above, and a similar preferable range.

As for A¹⁴ to A²¹, numbers of N (nitrogen atom) of A¹⁴ to A¹⁷ and A¹⁸ to A²¹ are preferably from 0 to 2, respectively, and more preferably 0 or 1. Preferably N is selected from A¹⁵ to A¹⁷ and A¹⁹ to A²¹, respectively, more preferably from A¹⁵, A¹⁶, A¹⁹ and A²⁰, and even more preferably from A¹⁵ and A¹⁹.

In the case where A¹⁴ to A²¹ represent C—R, examples of R included in A¹⁵ and A¹⁹ include preferably a hydrogen atom, an alkyl group, a perfluoroalkyl group, an aryl group, an amino group, an alkoxy group, an aryloxy group, a fluorine atom and a cyano group, more preferably a hydrogen atom, a perfluoroalkyl group, an alkyl group, an aryl group, a fluorine atom and a cyano group, and particularly preferably a hydrogen atom, a perfluoroalkyl group and a cyano group. Examples of R included in A⁴, A⁶, A¹⁸ and A²⁰ include preferably a hydrogen atom, an alkyl group, a perfluoroalkyl group, an aryl group, an amino group, an alkoxy group, an aryloxy group, a fluorine atom and a cyano group, more preferably a hydrogen atom, a perfluoroalkyl group, a fluorine atom and a cyano group, and particularly preferably a hydrogen atom and a fluorine atom. Examples of R included in A¹⁴ and A¹⁸ include preferably a hydrogen atom and a fluorine atom, and more preferably a hydrogen atom. In the case where any of A¹⁴ to A¹⁶ and A¹⁸ to A²⁰ represent C—R, Rs may combine together to form a ring.

Specific examples of the platinum complex described above include the following compounds, but it should be noted that the present invention is not limited thereto.

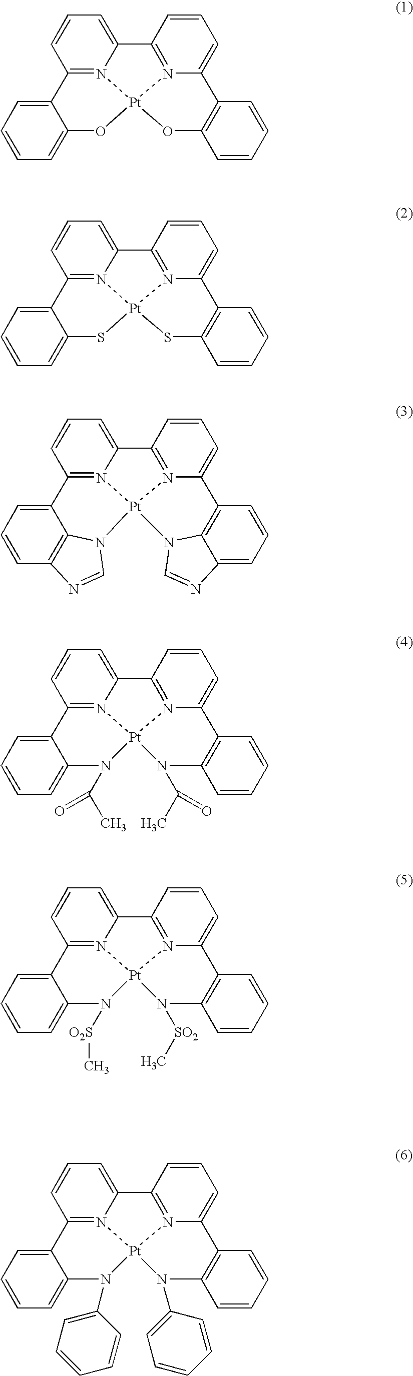

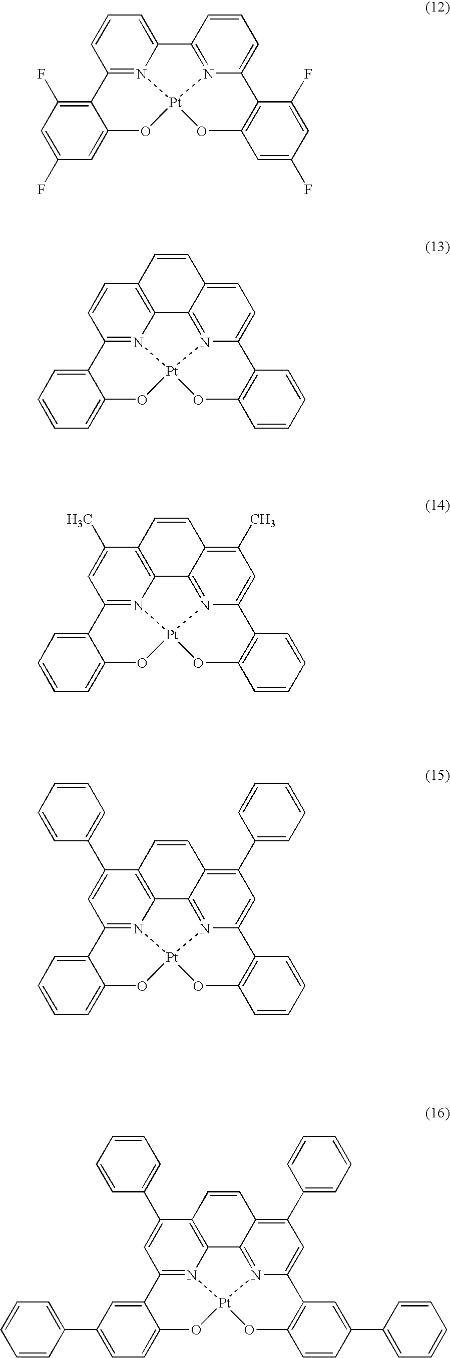

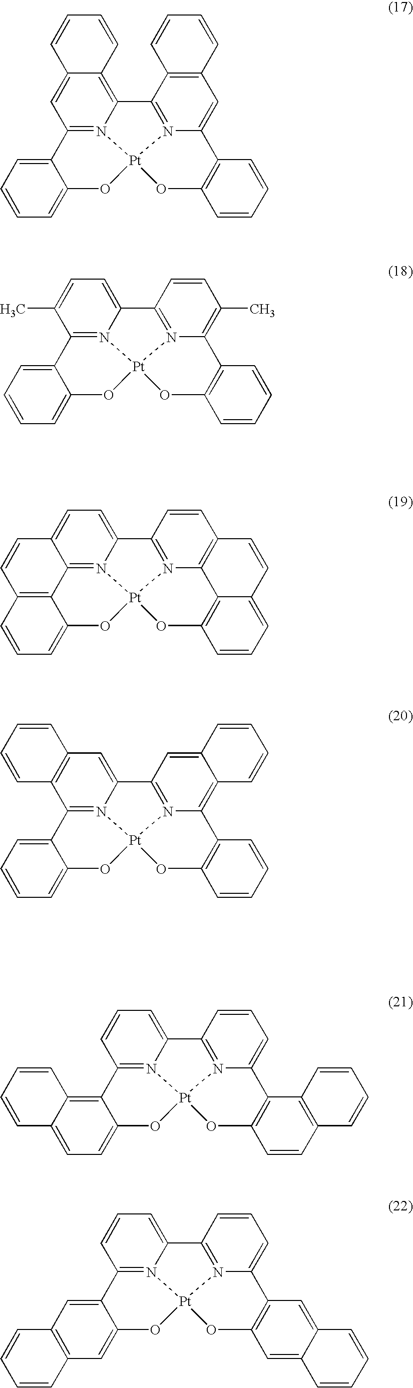

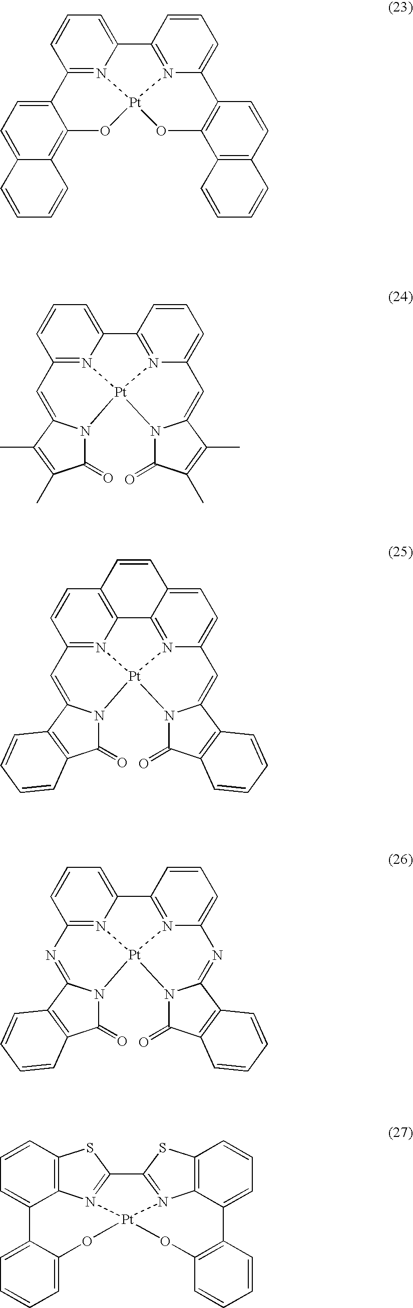

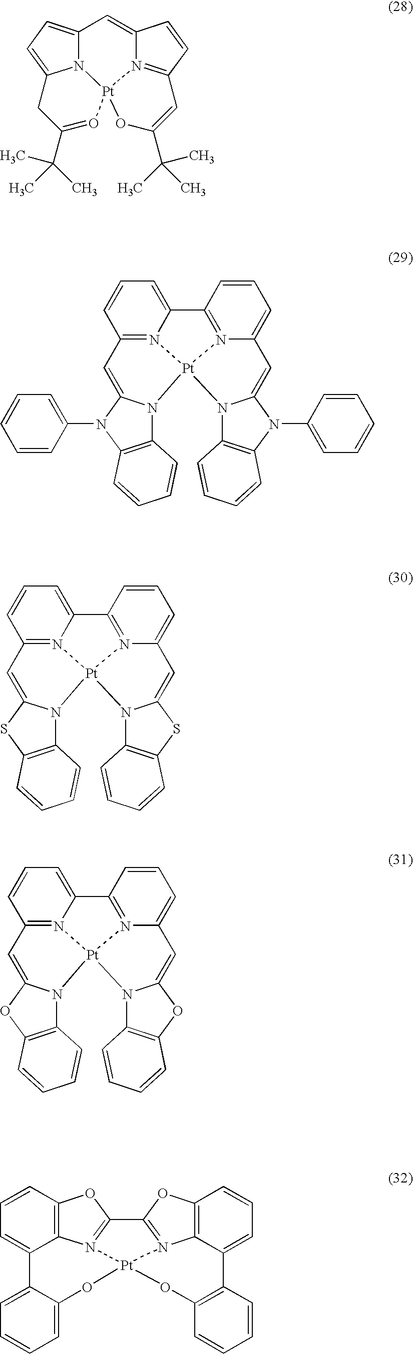

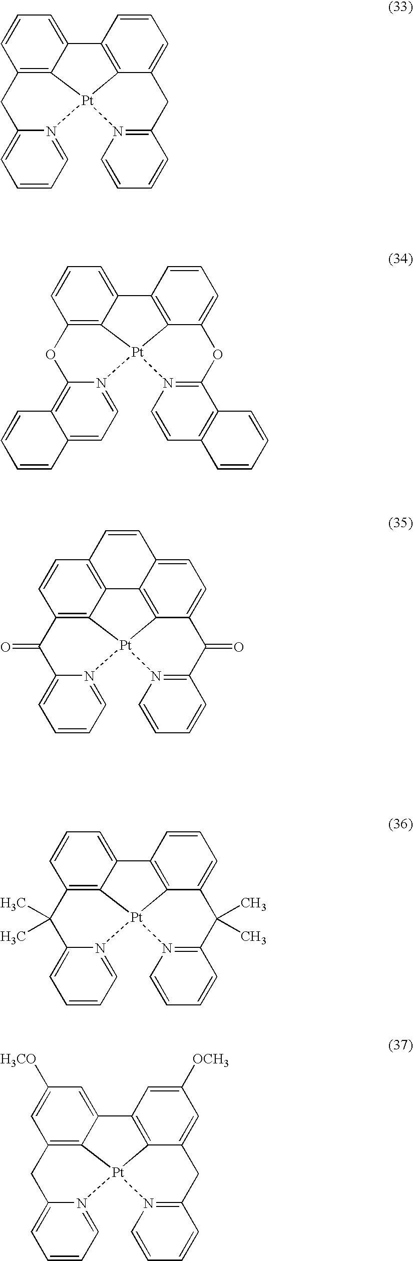

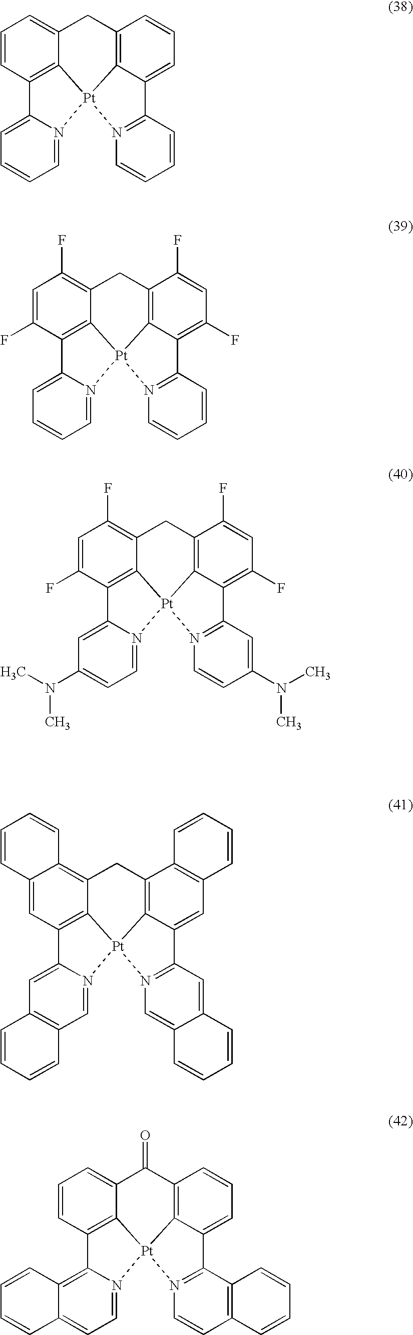

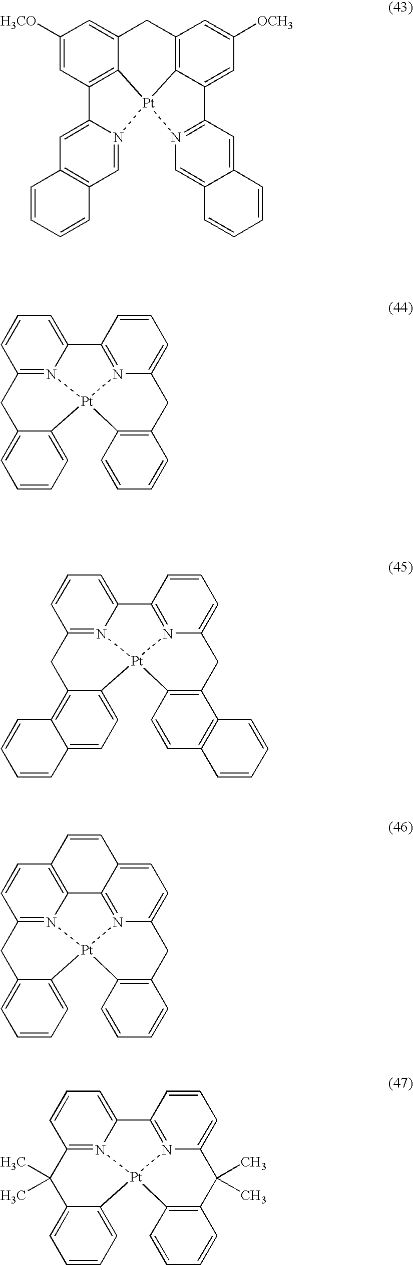

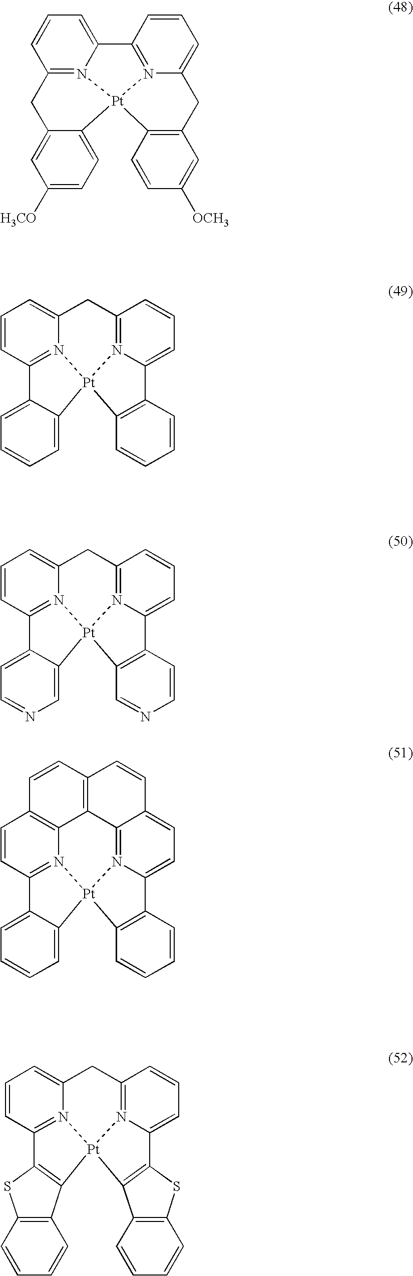

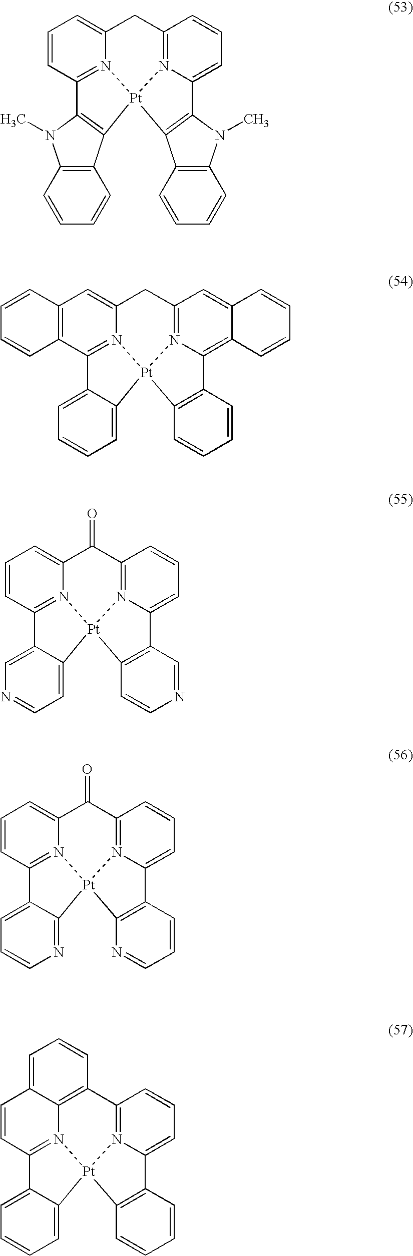

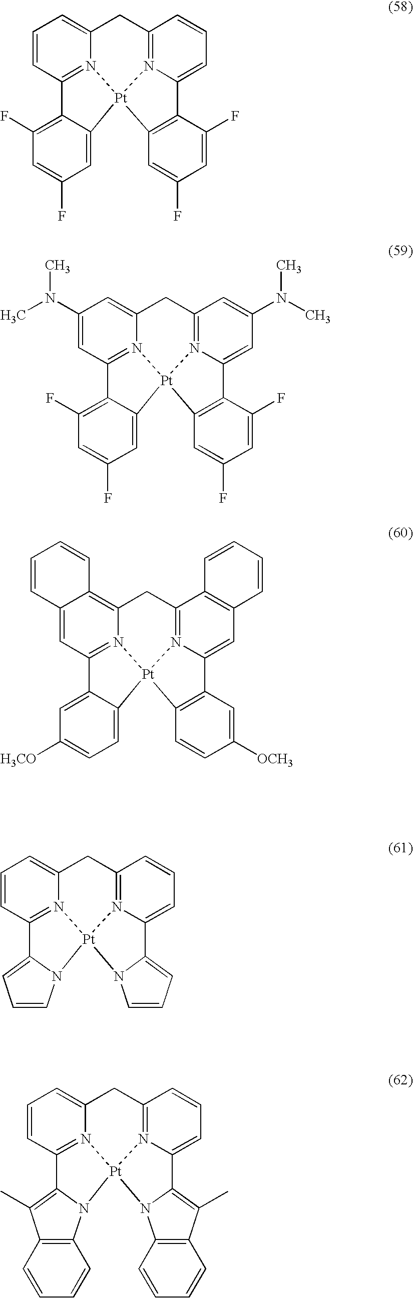

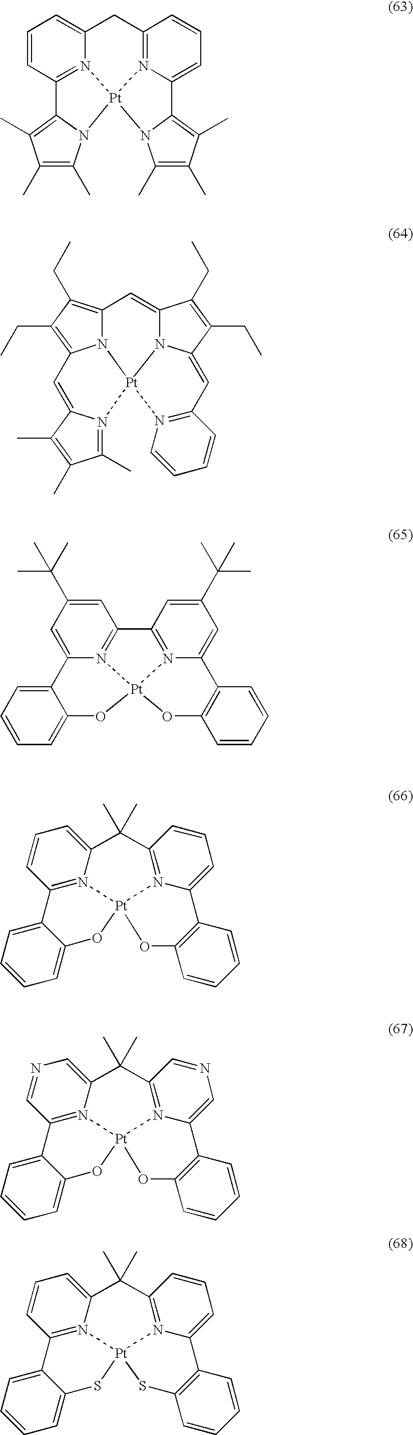

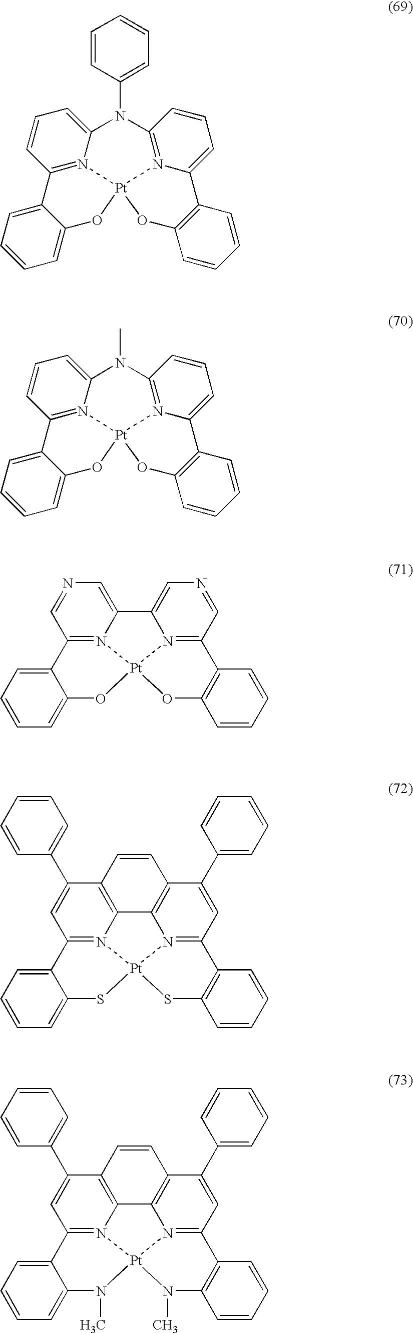

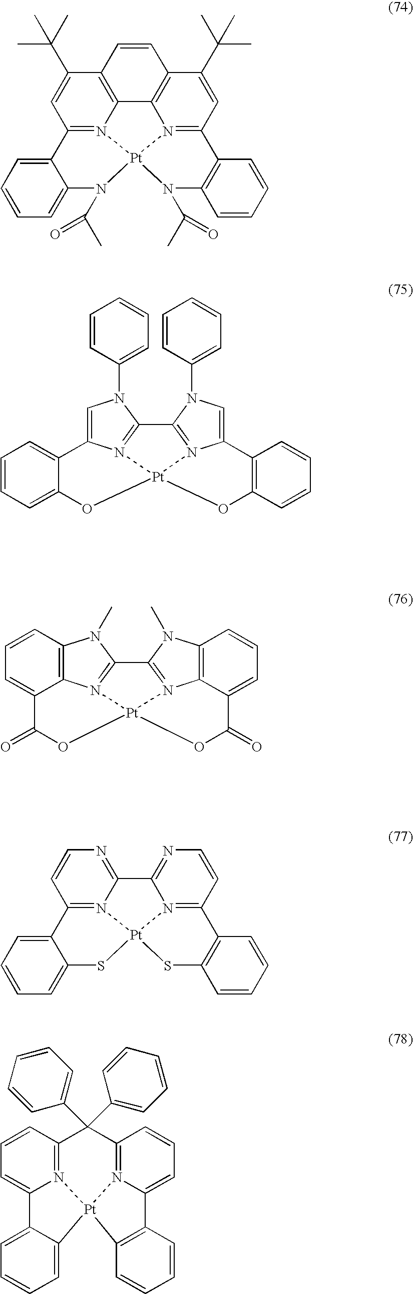

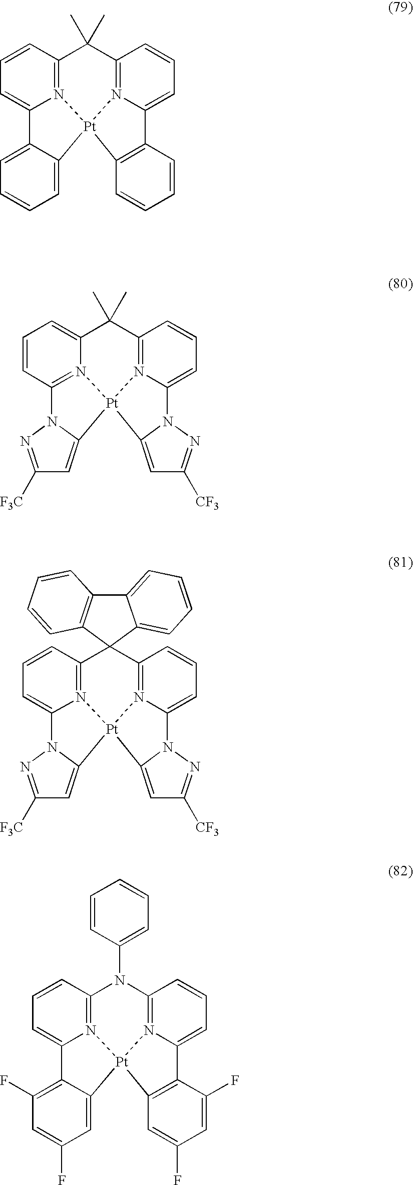

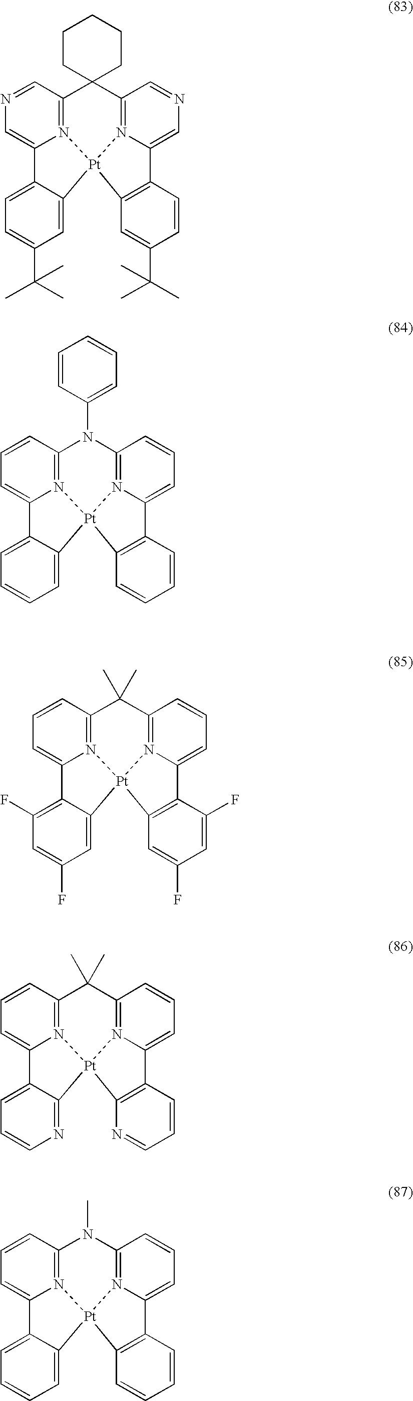

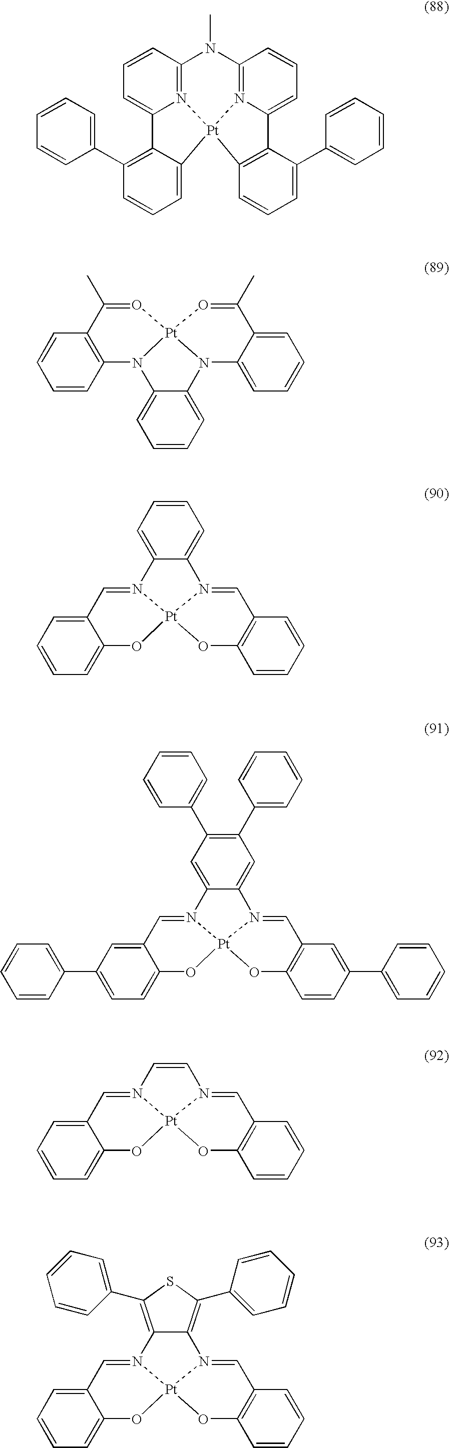

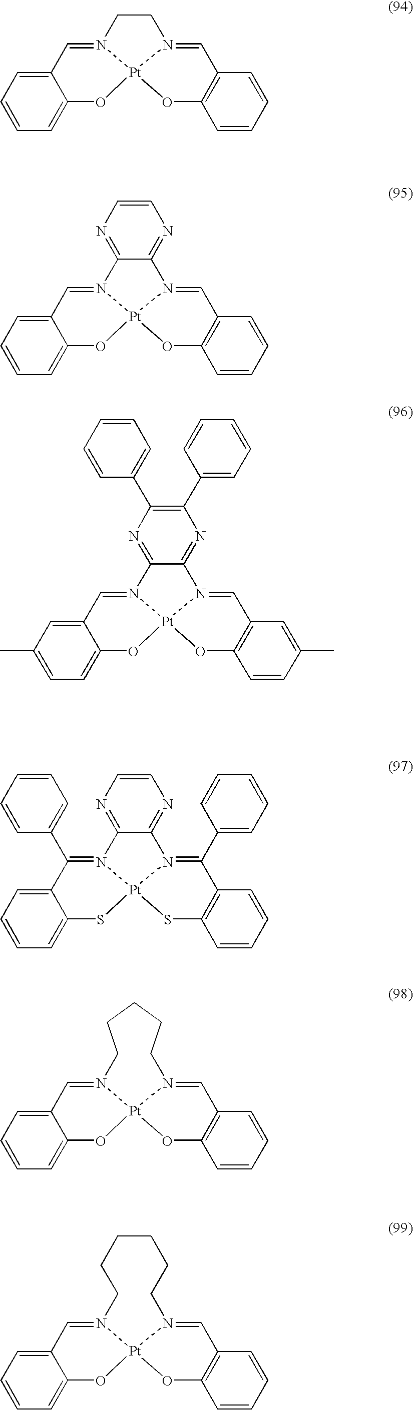

Specific examples of the platinum complex further include the following compounds, but it should be noted that the present invention is not limited thereto.

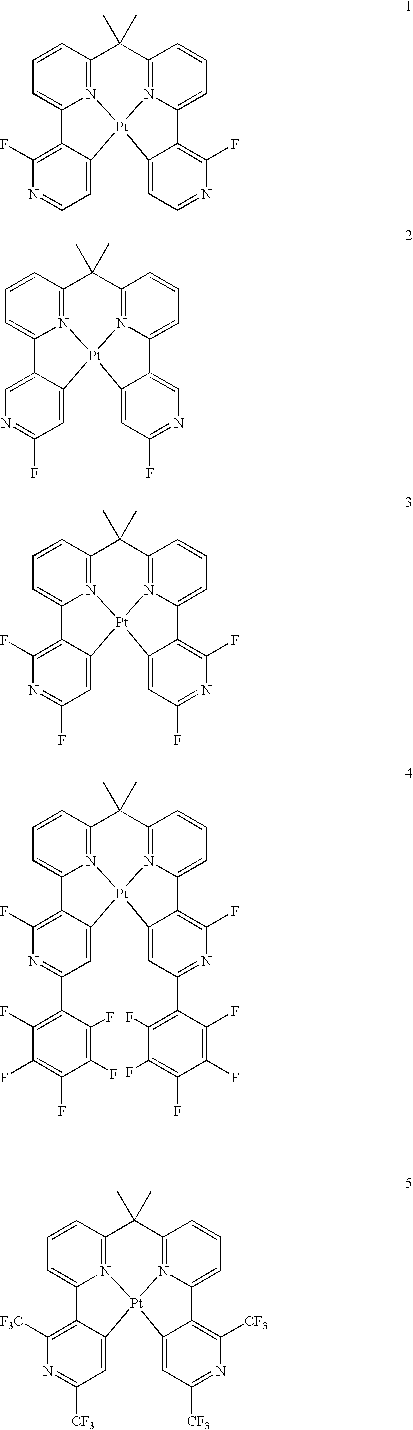

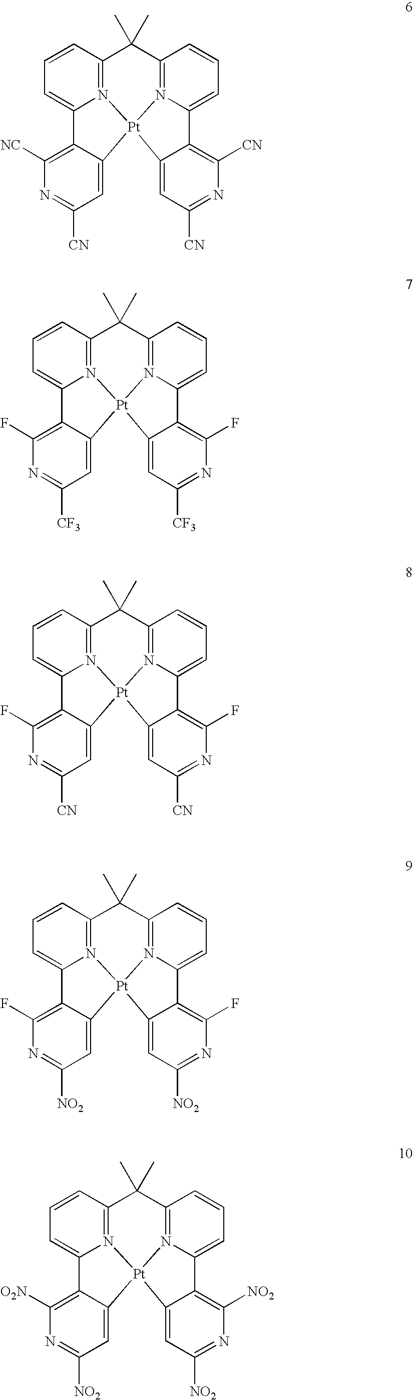

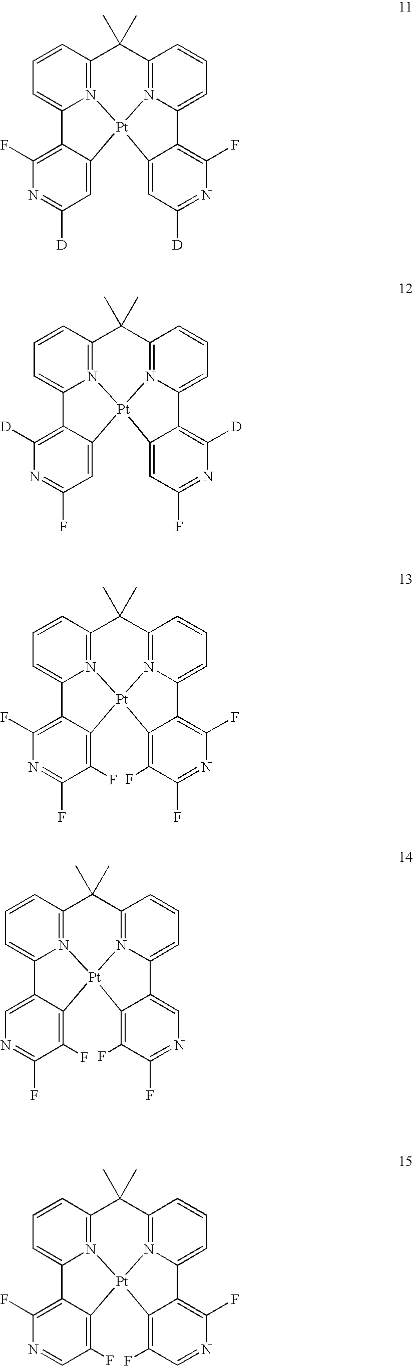

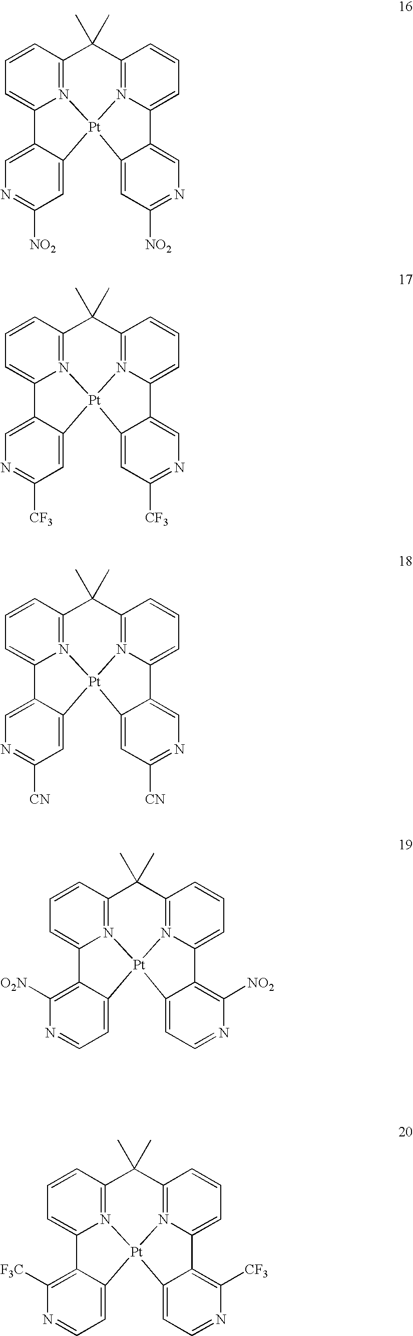

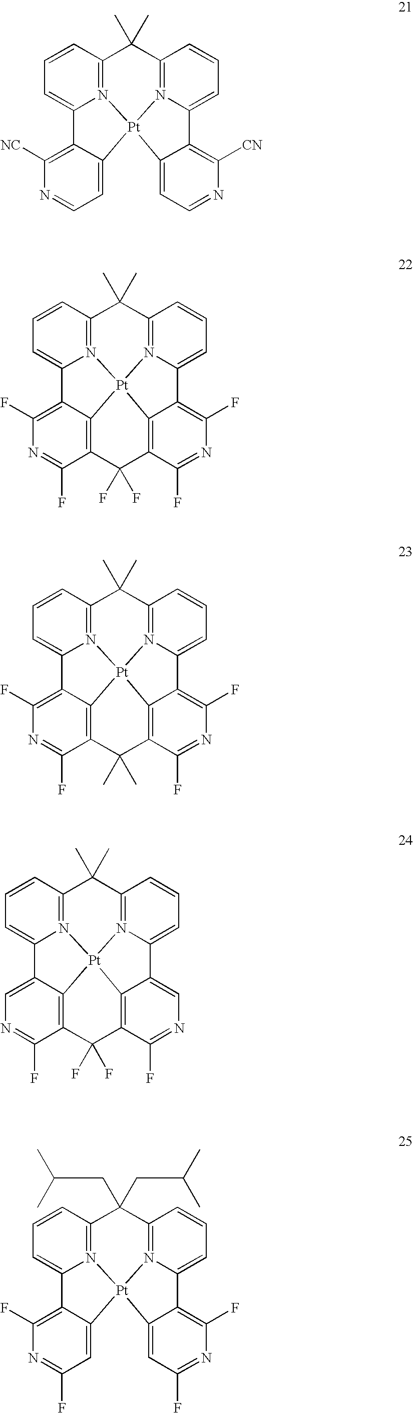

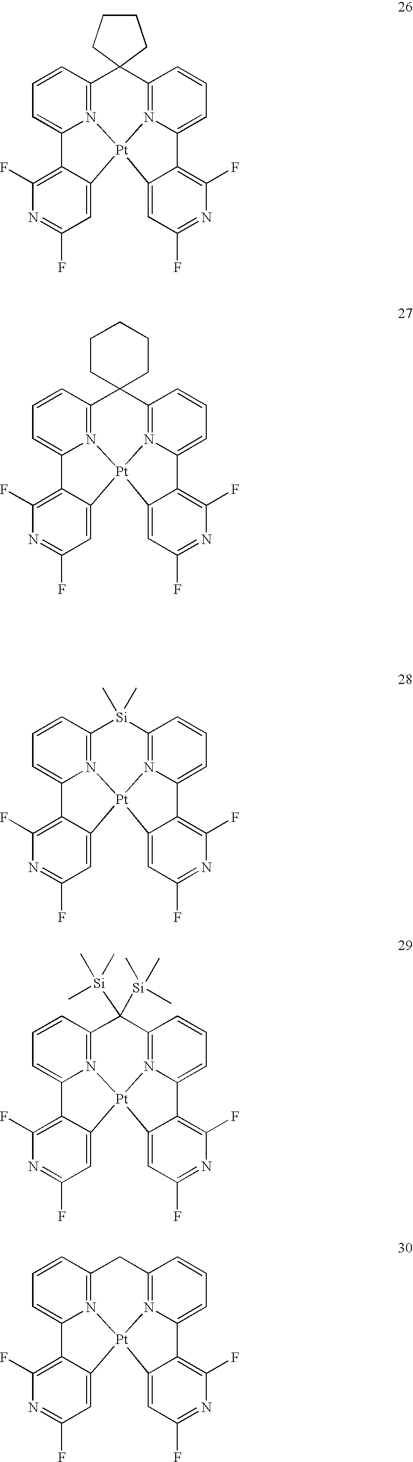

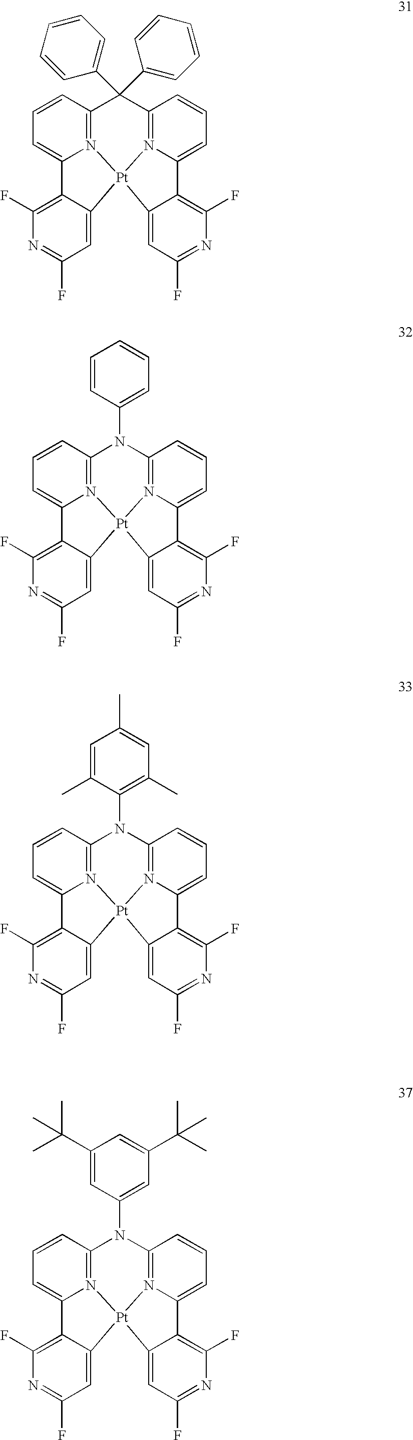

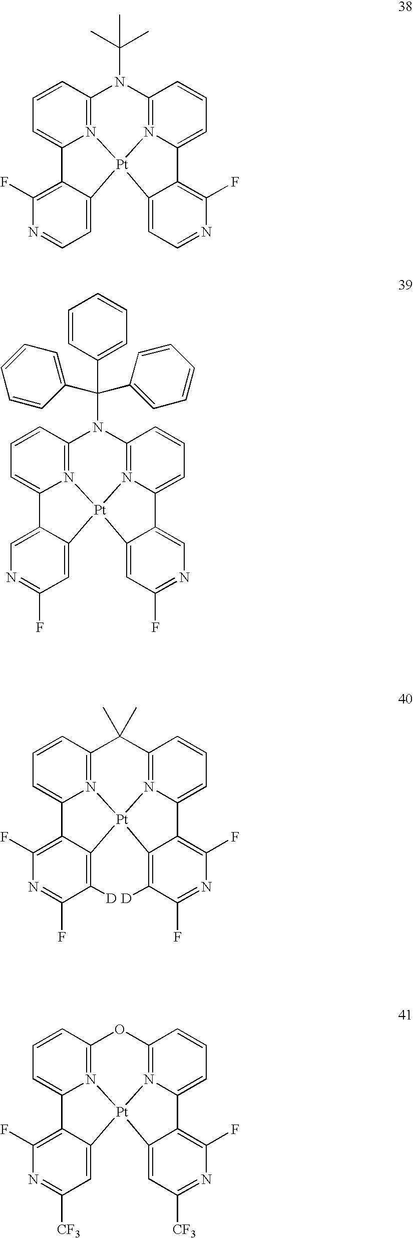

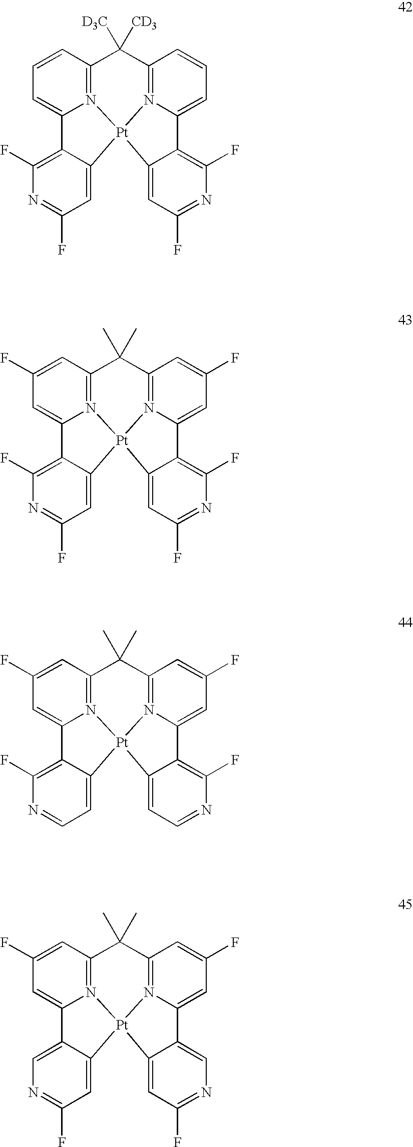

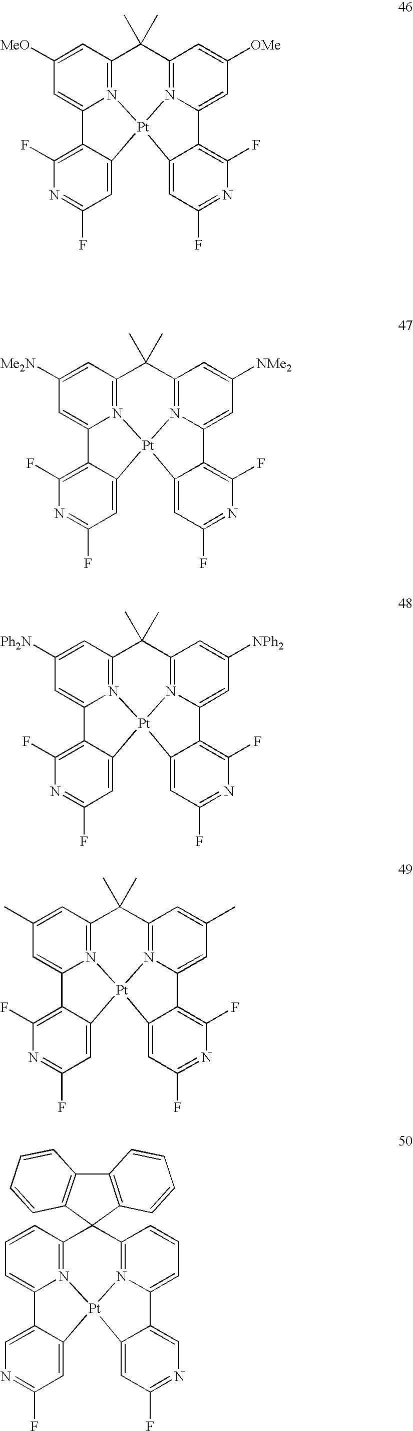

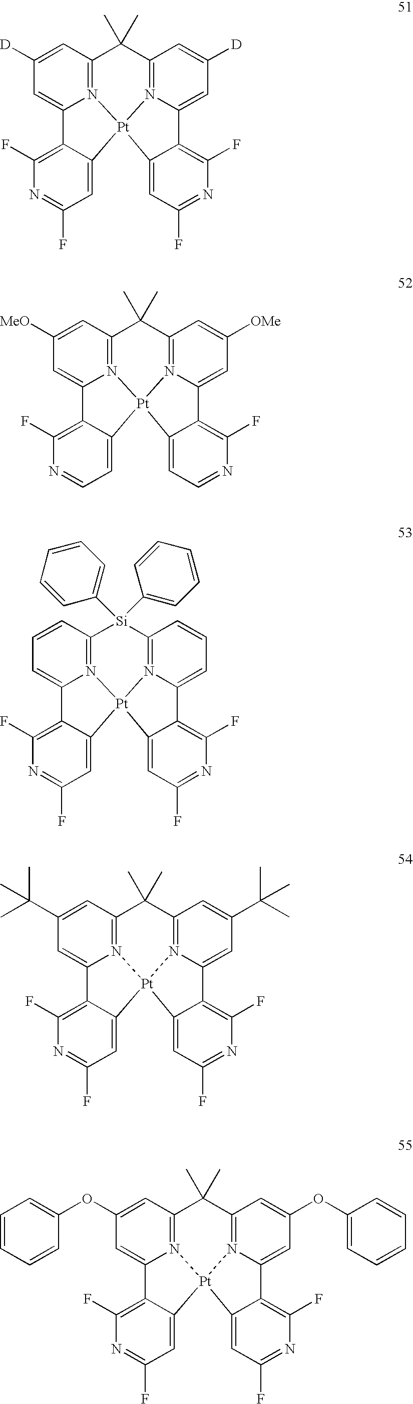

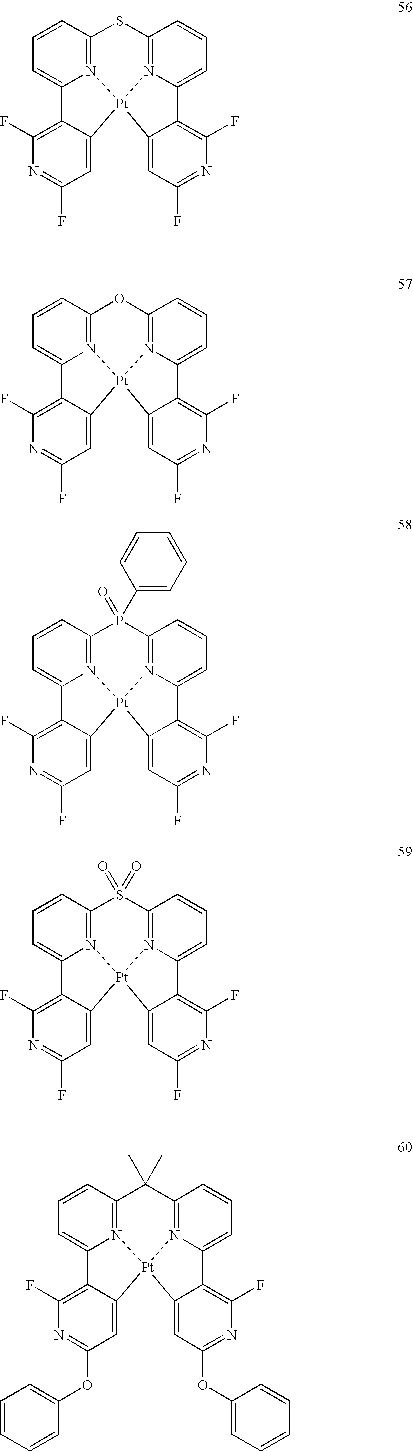

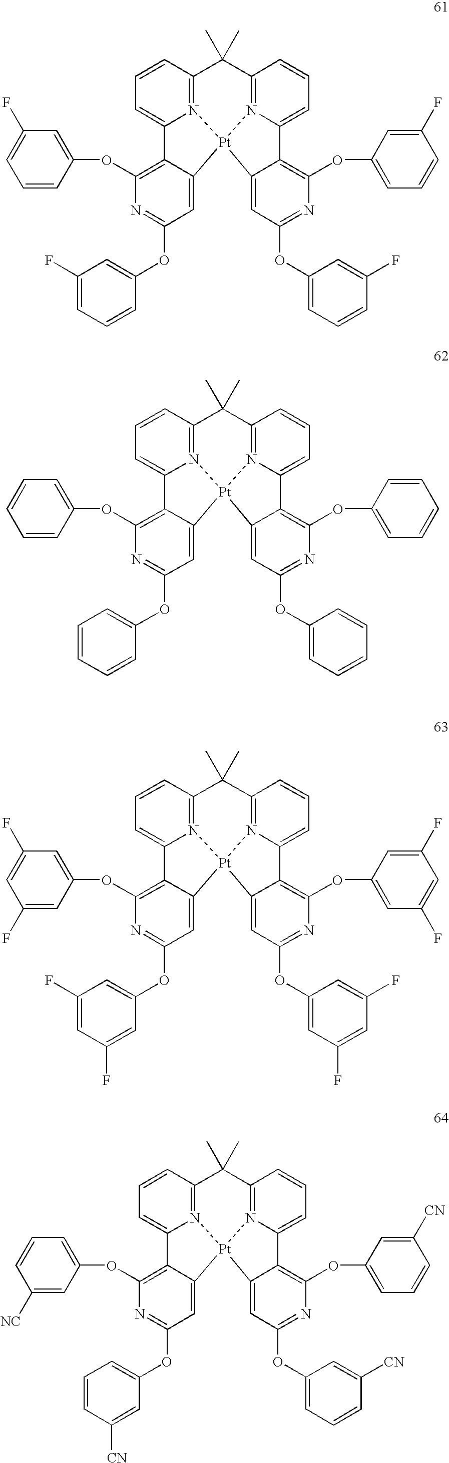

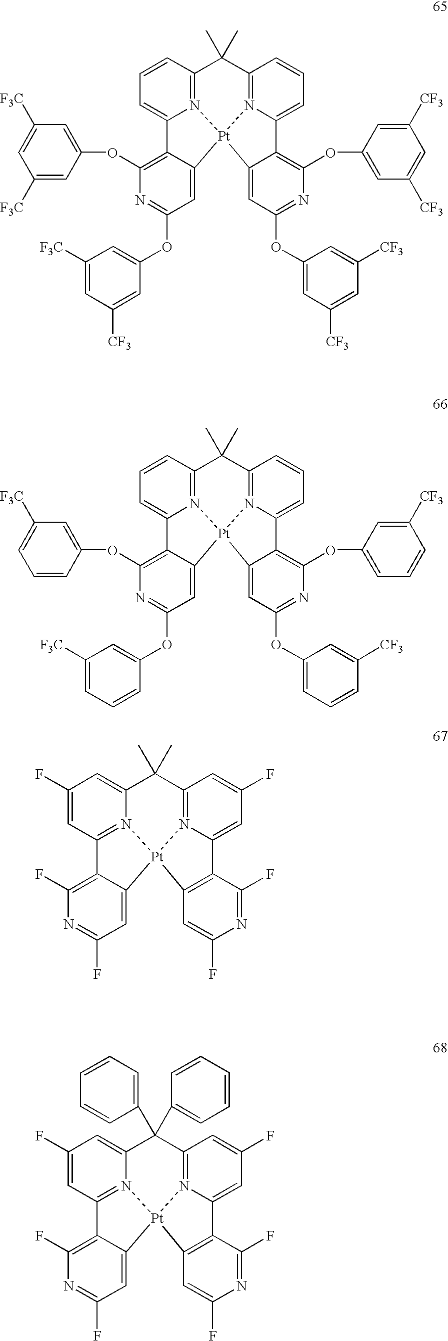

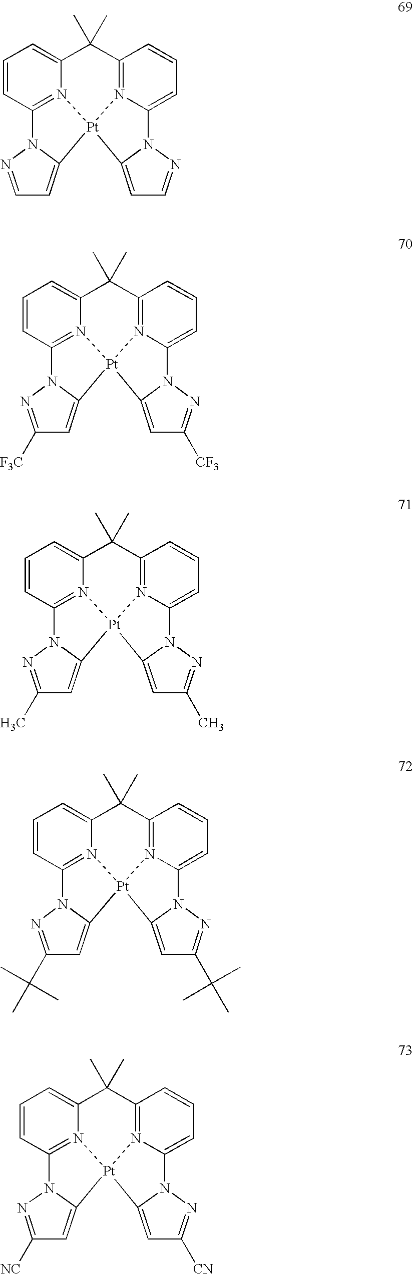

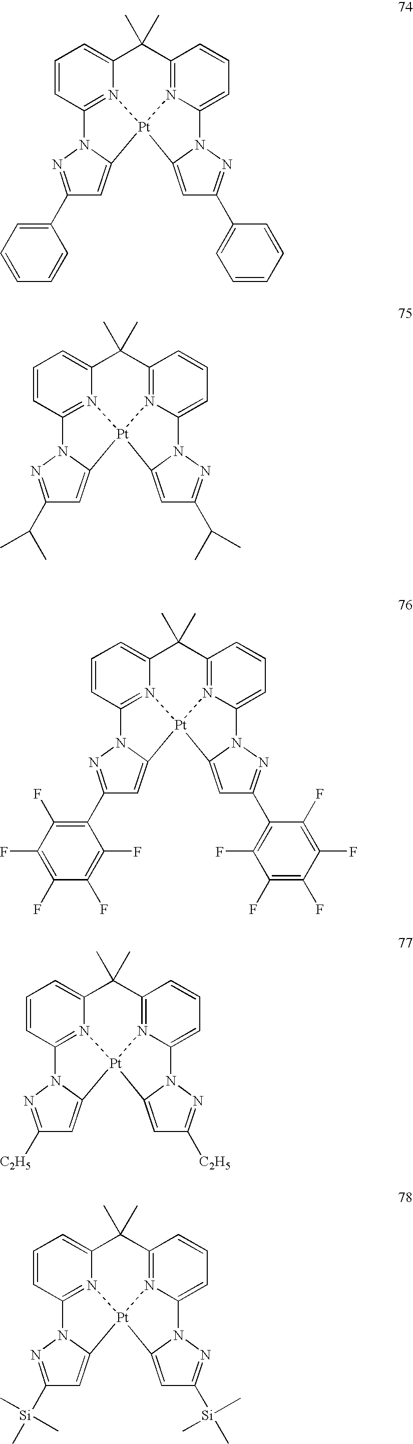

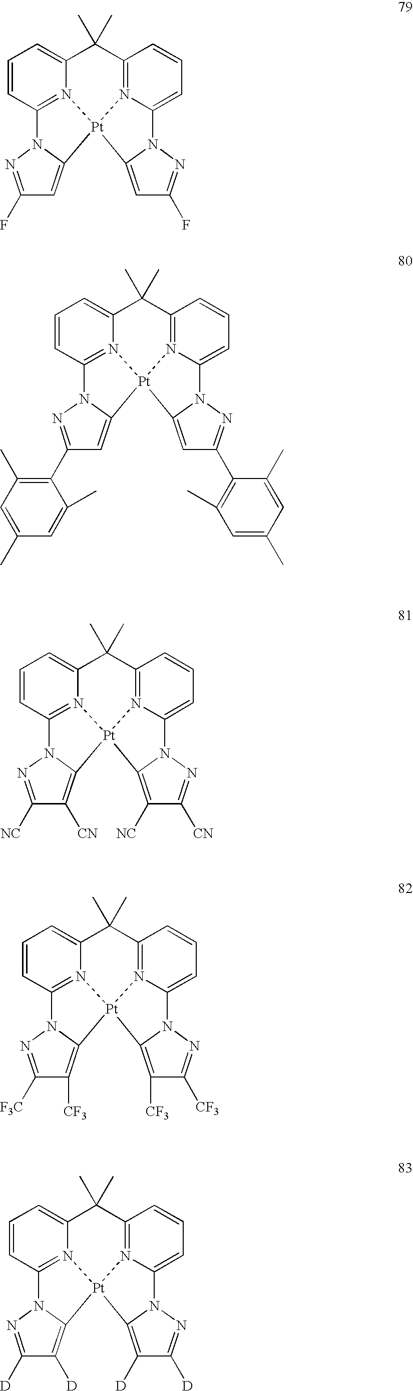

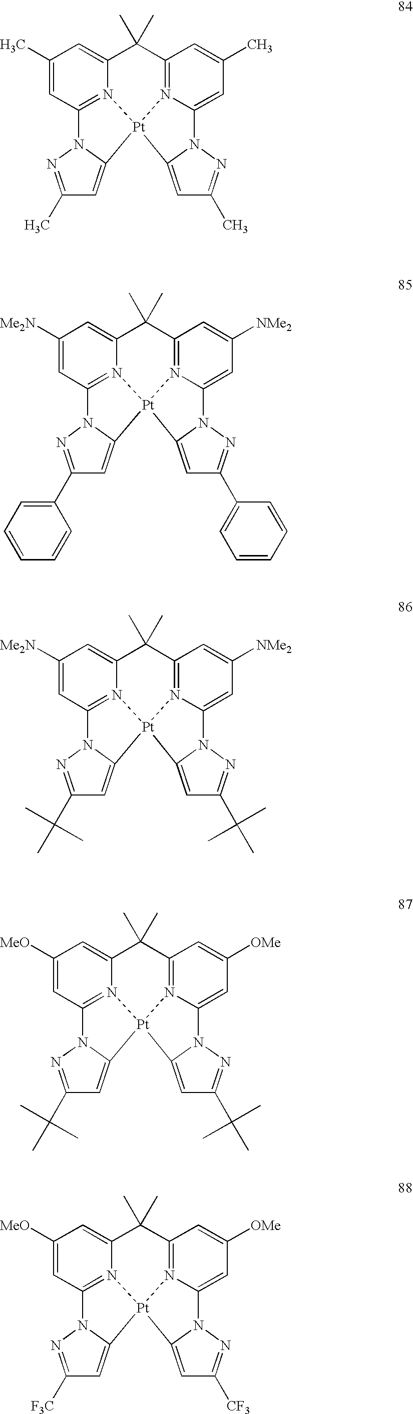

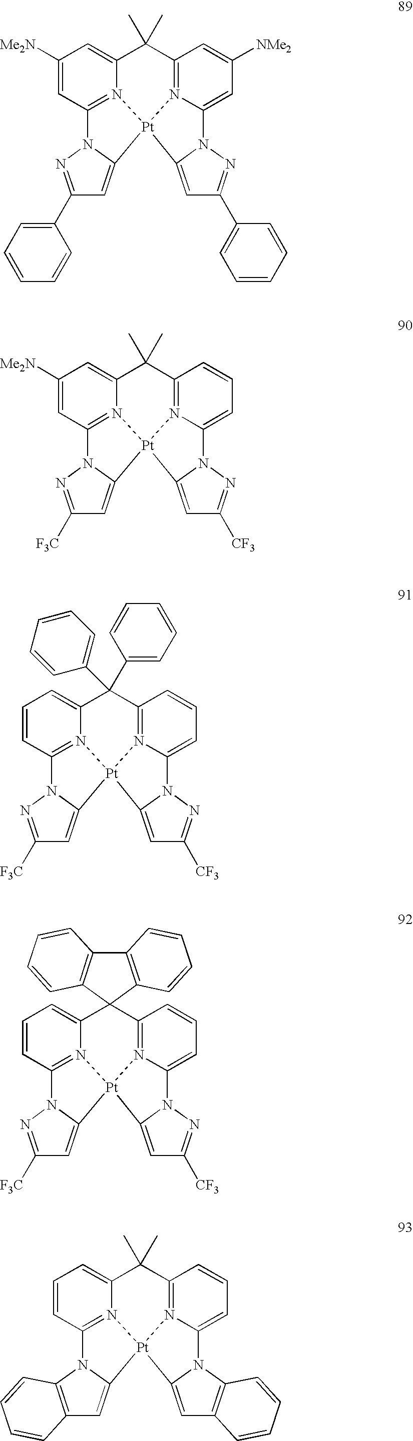

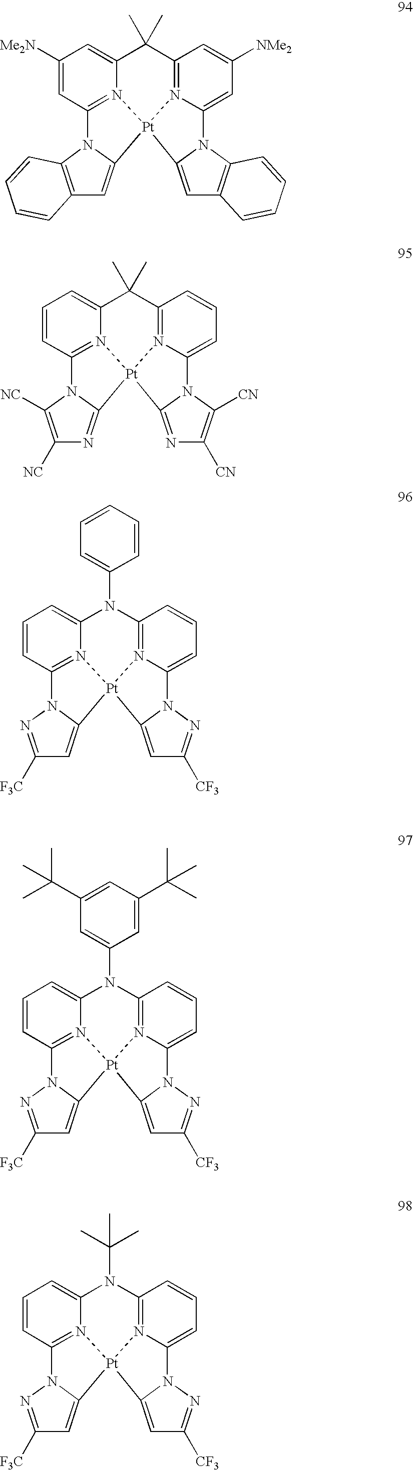

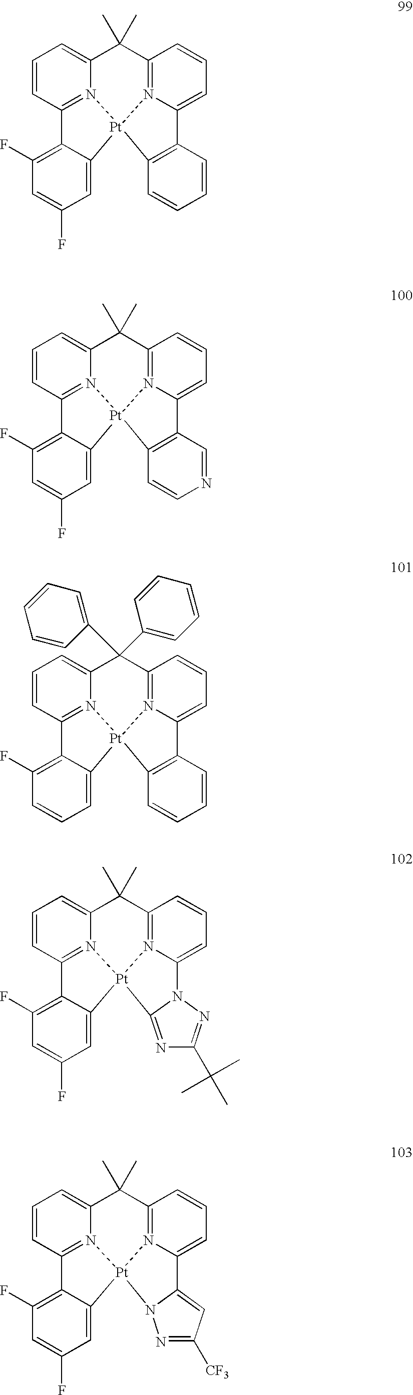

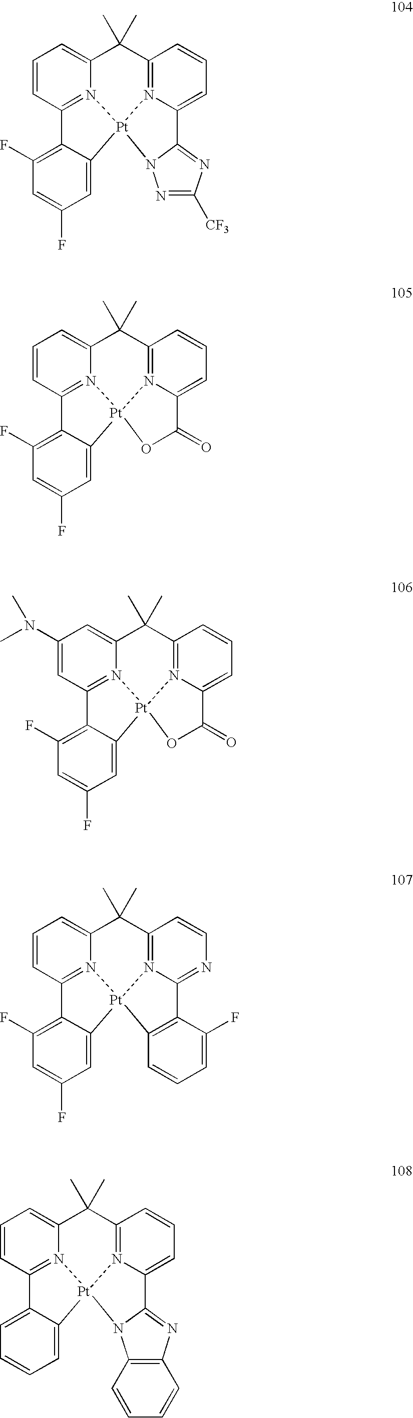

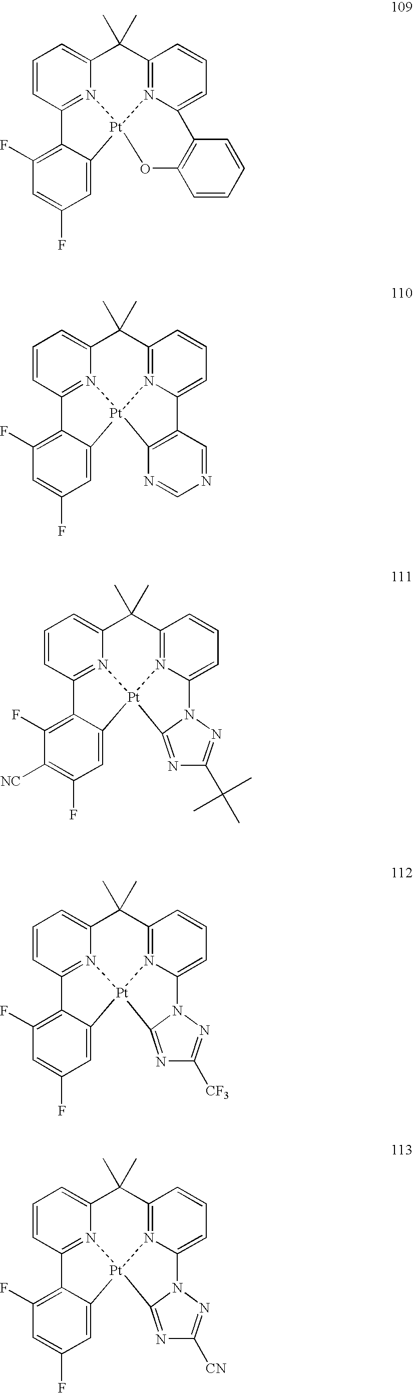

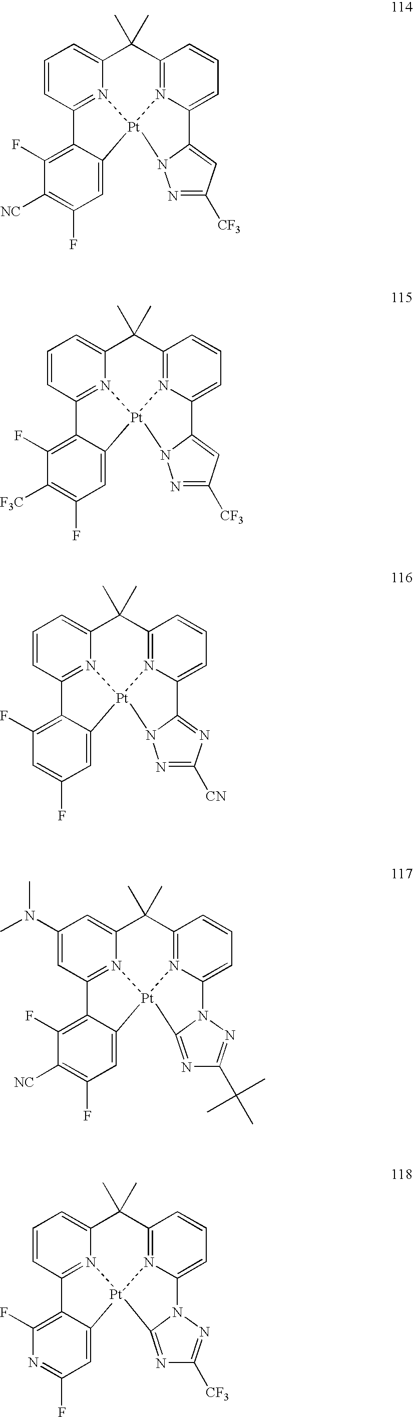

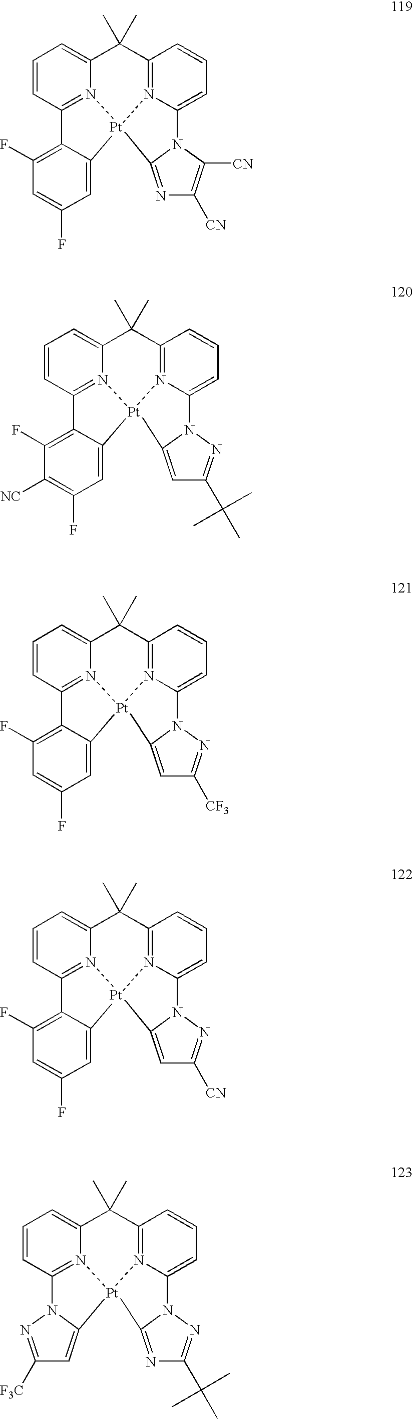

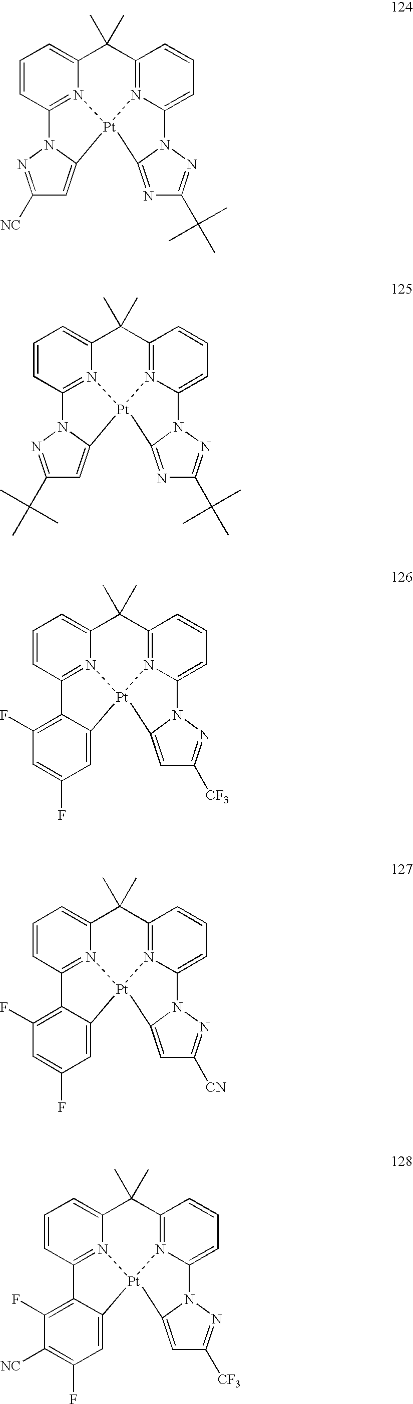

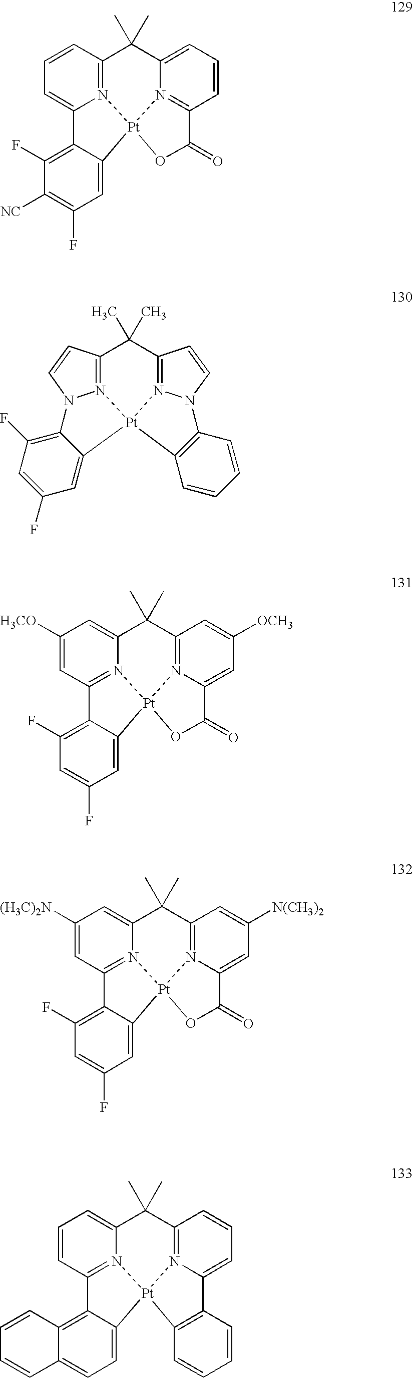

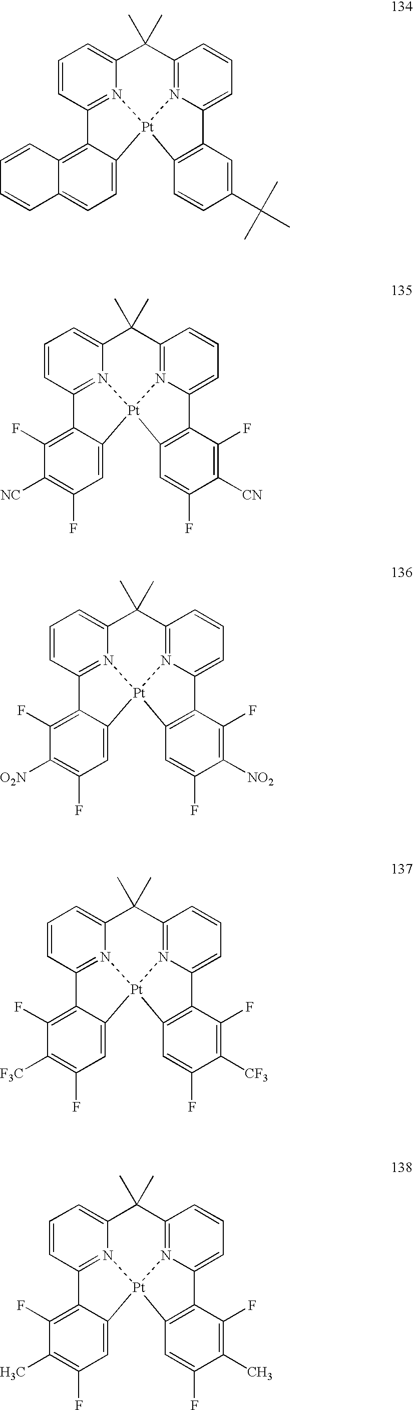

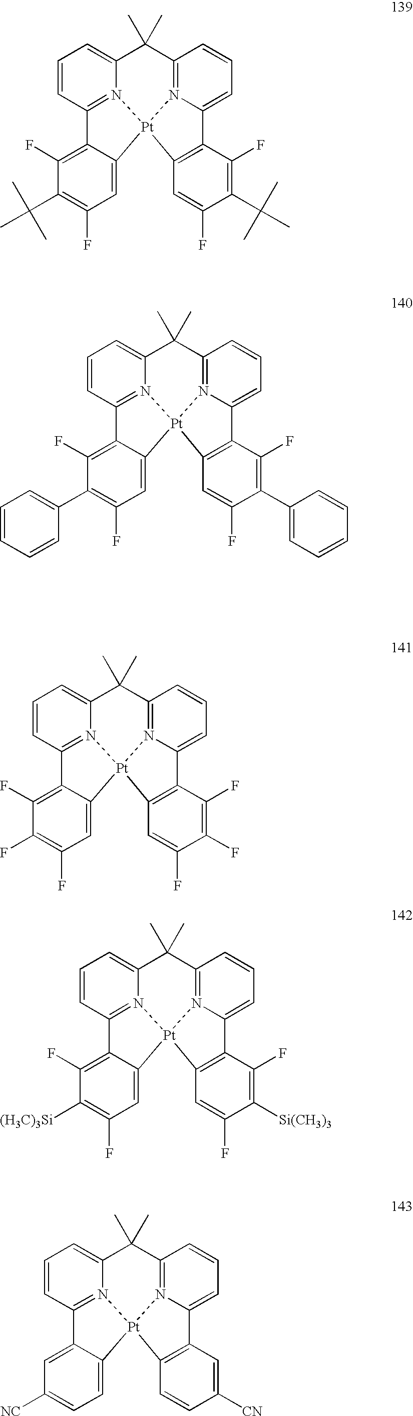

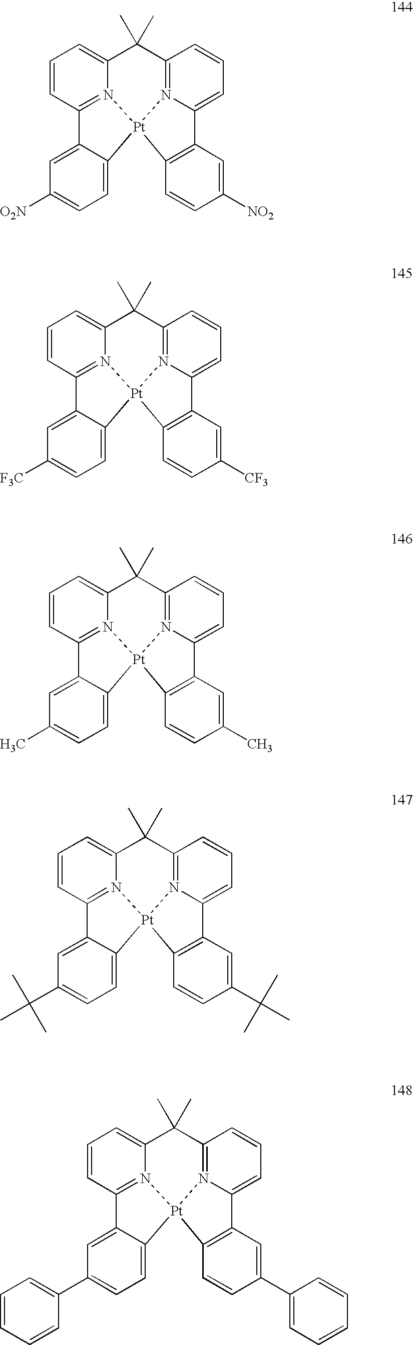

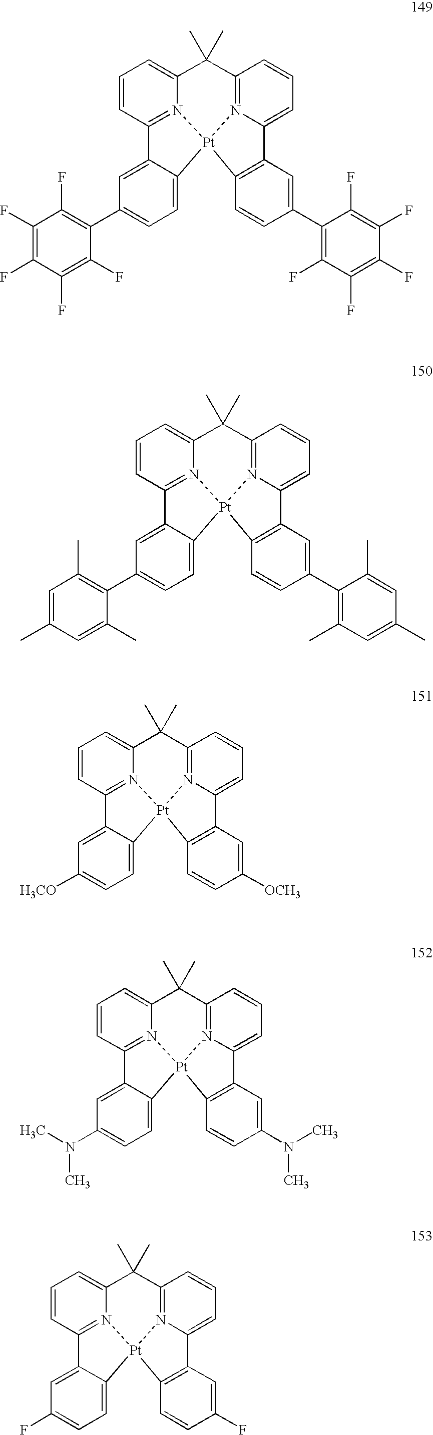

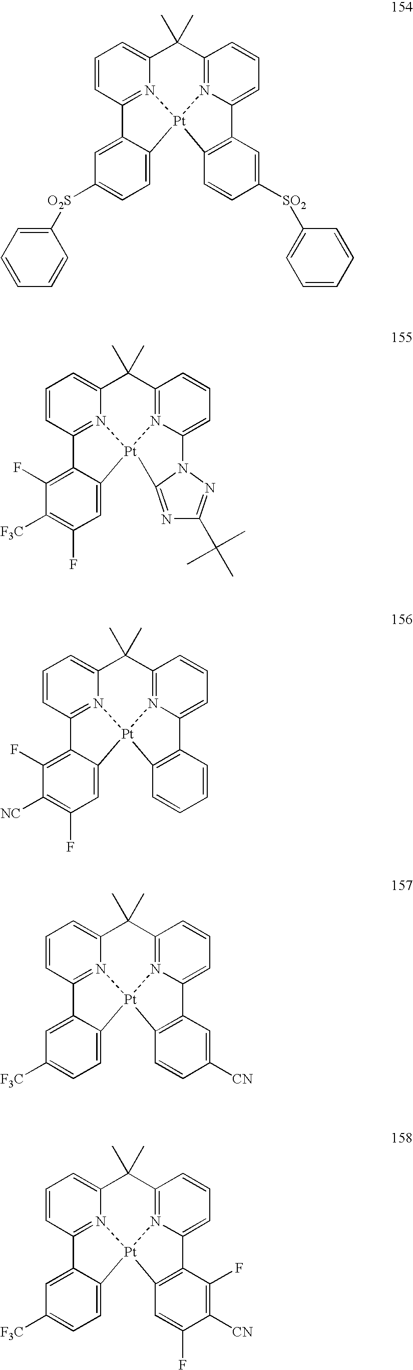

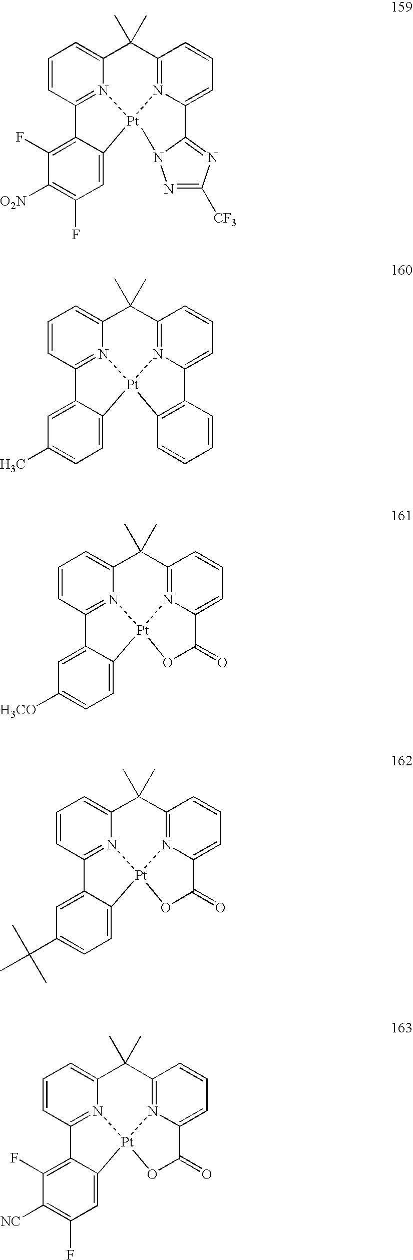

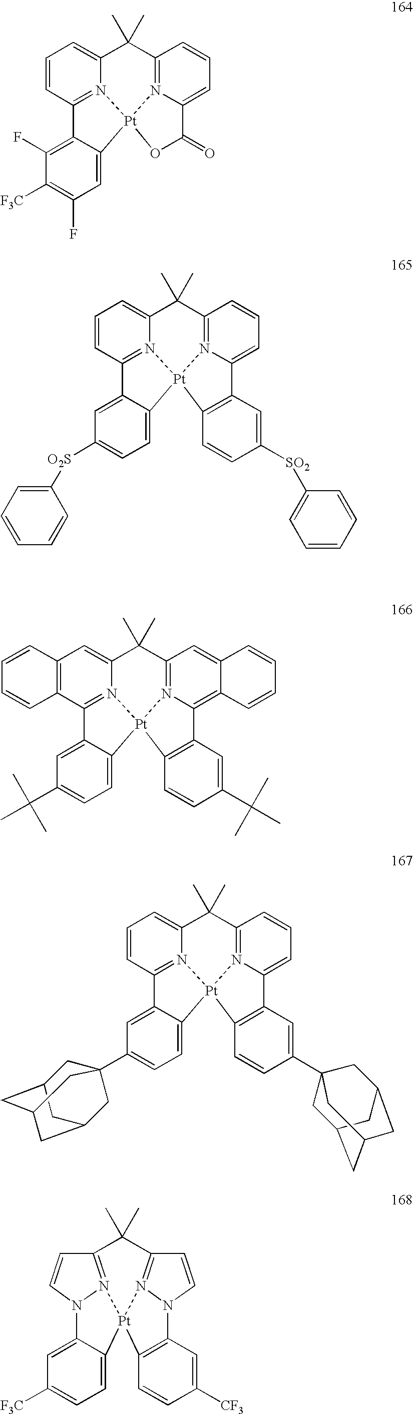

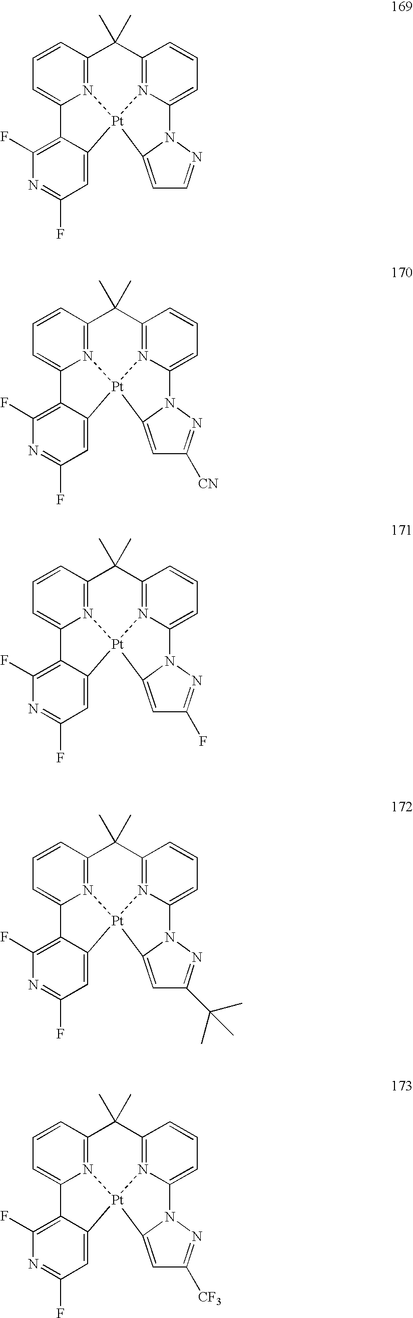

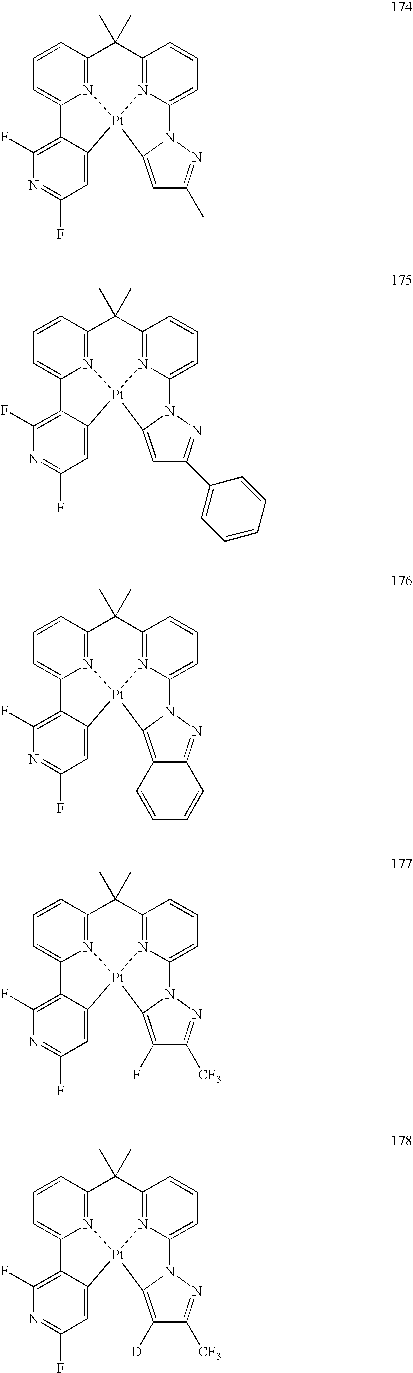

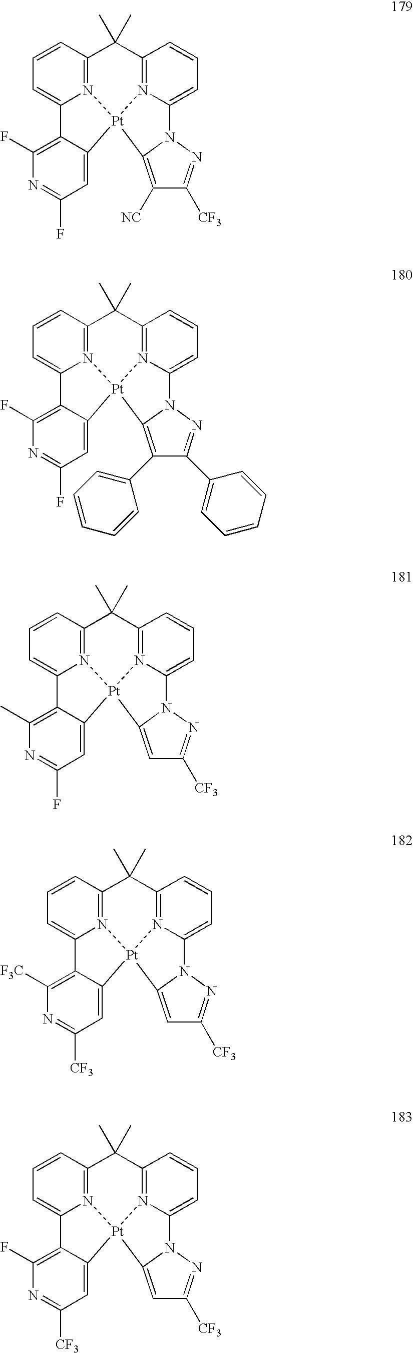

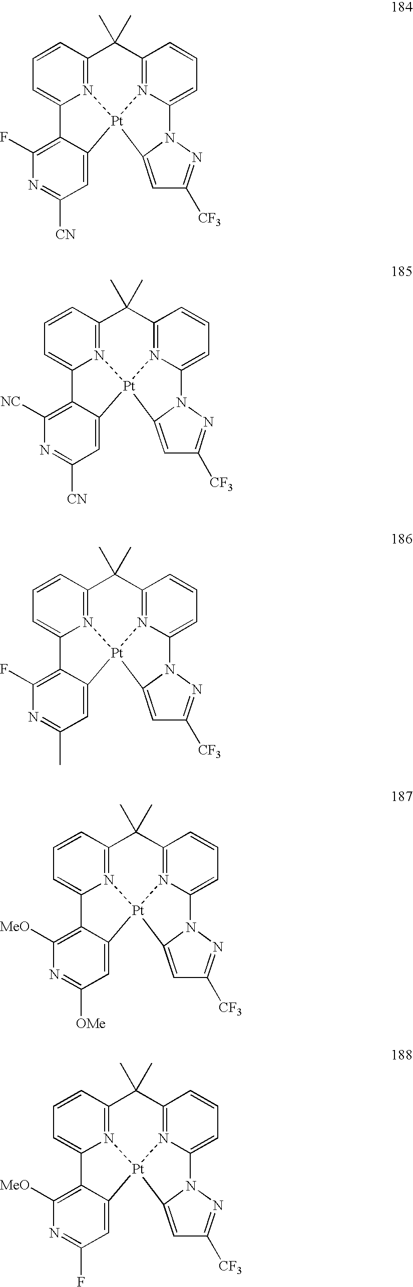

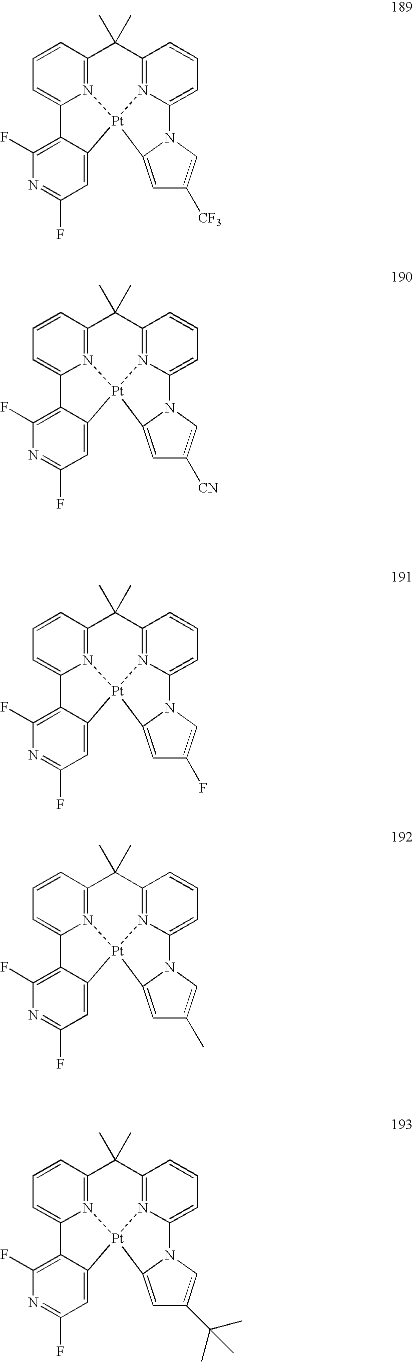

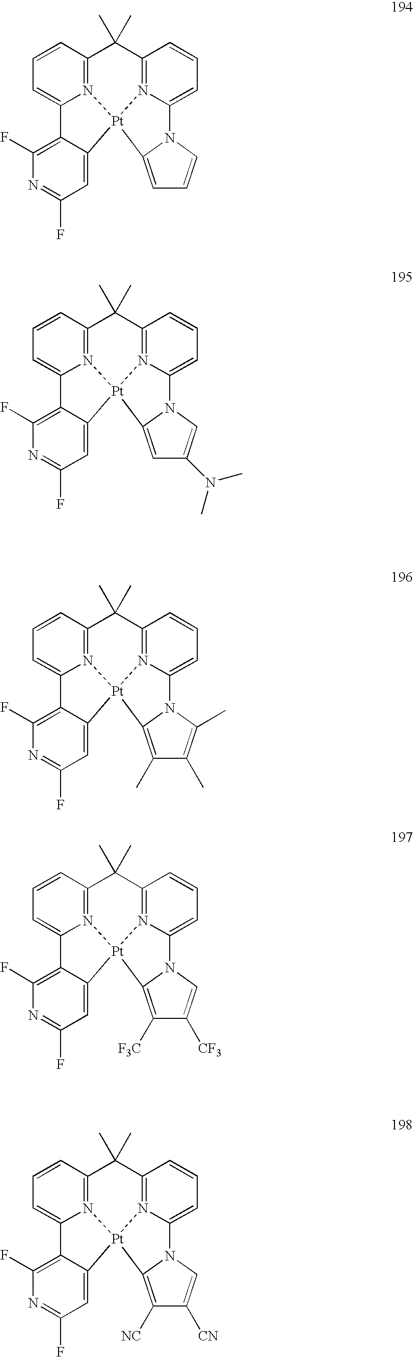

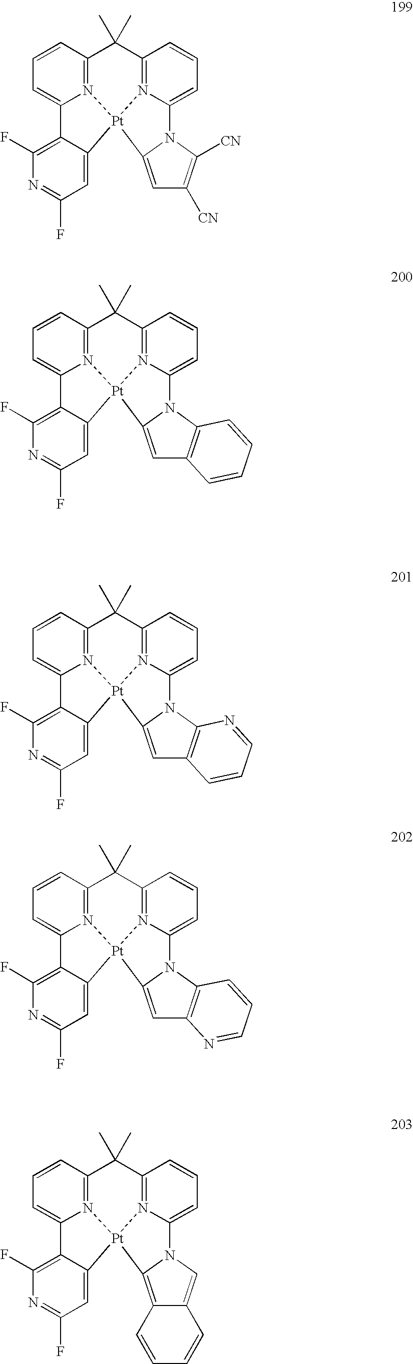

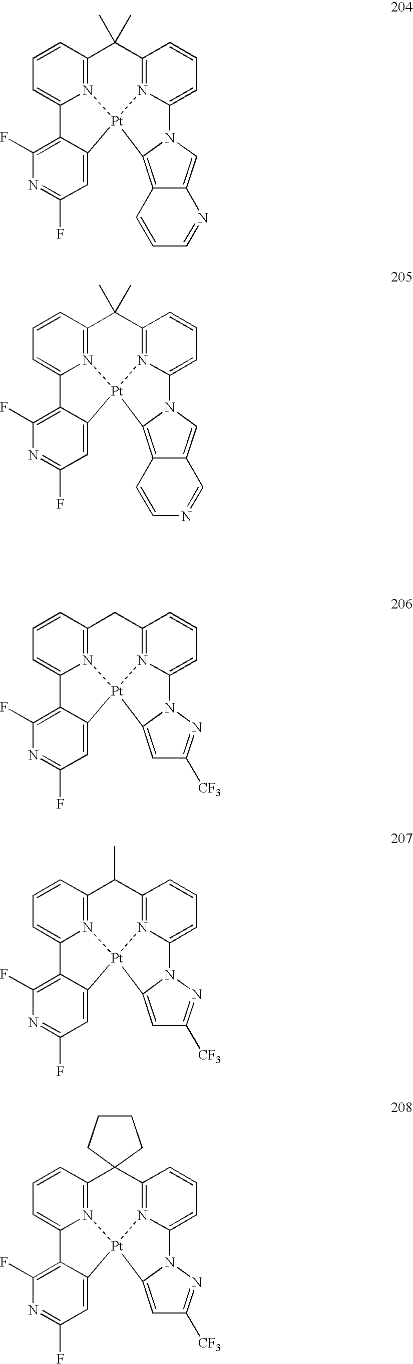

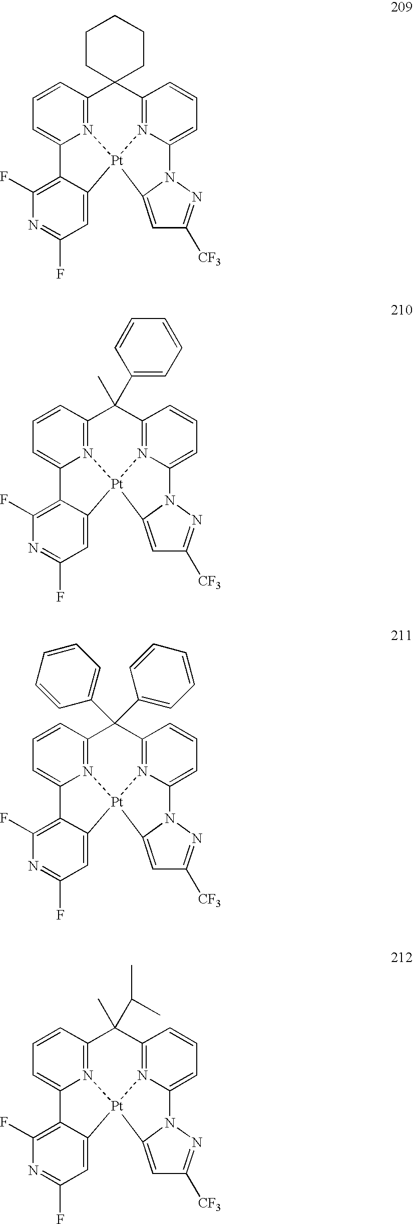

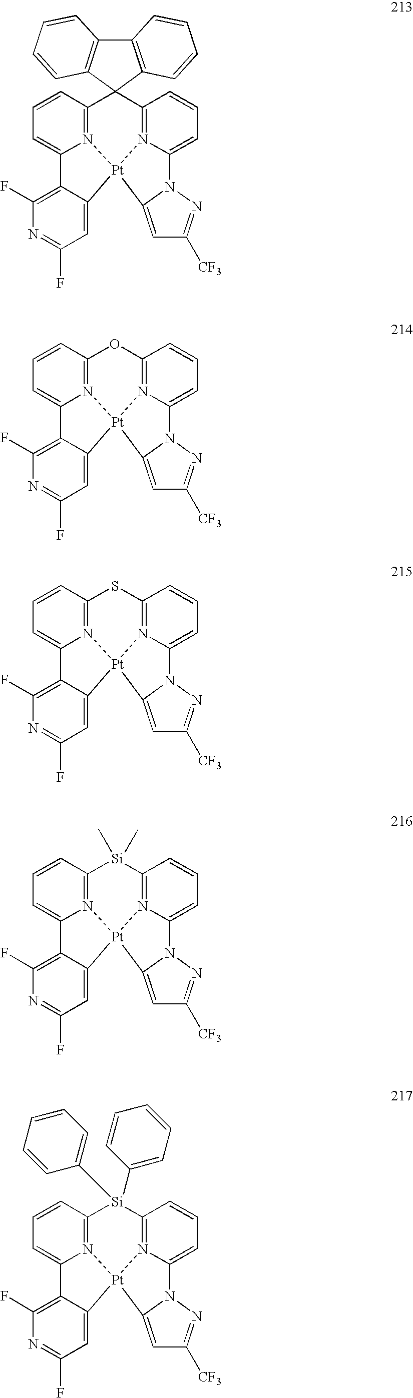

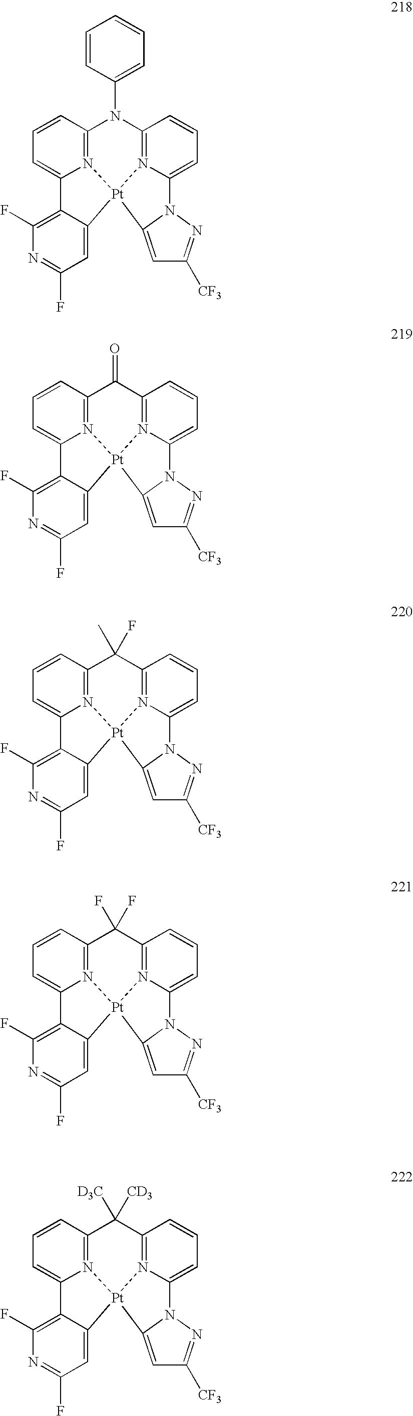

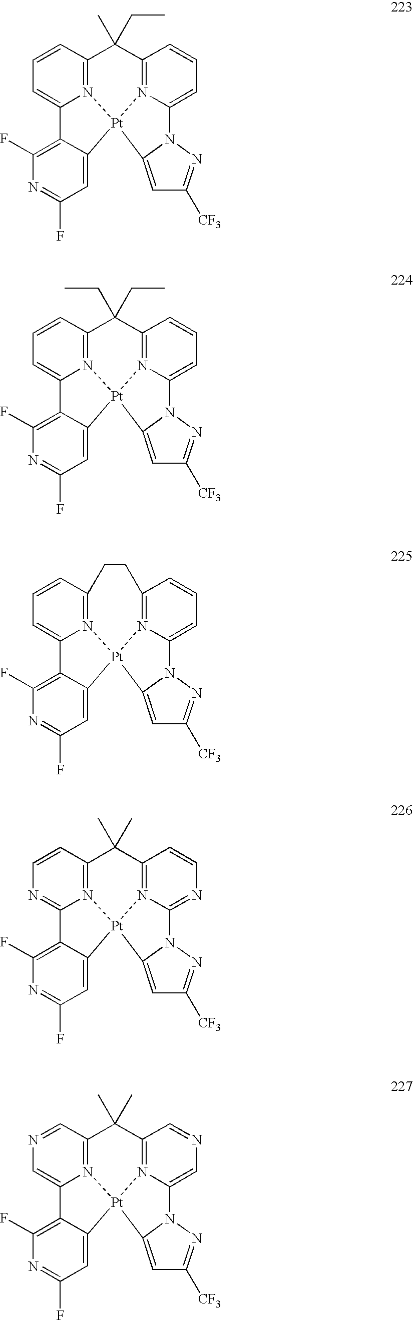

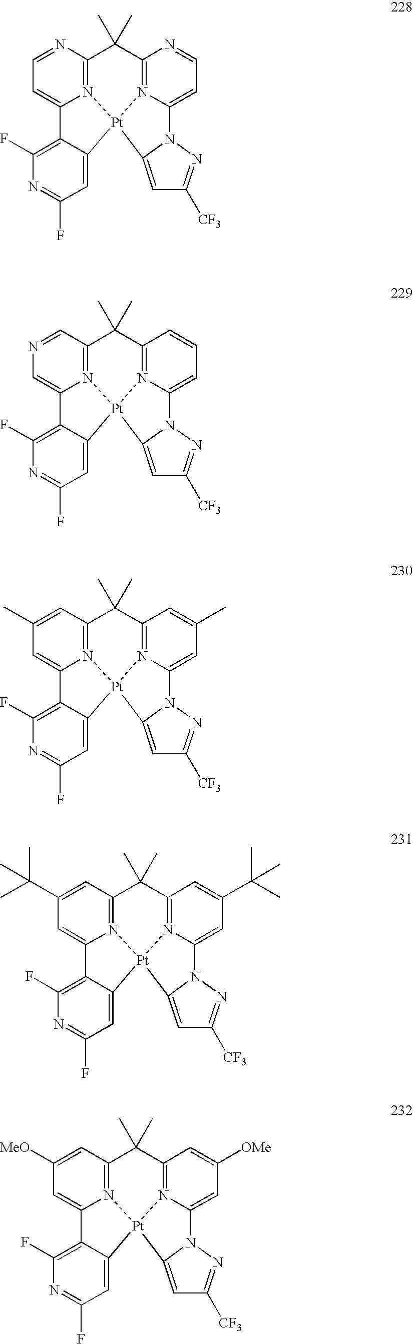

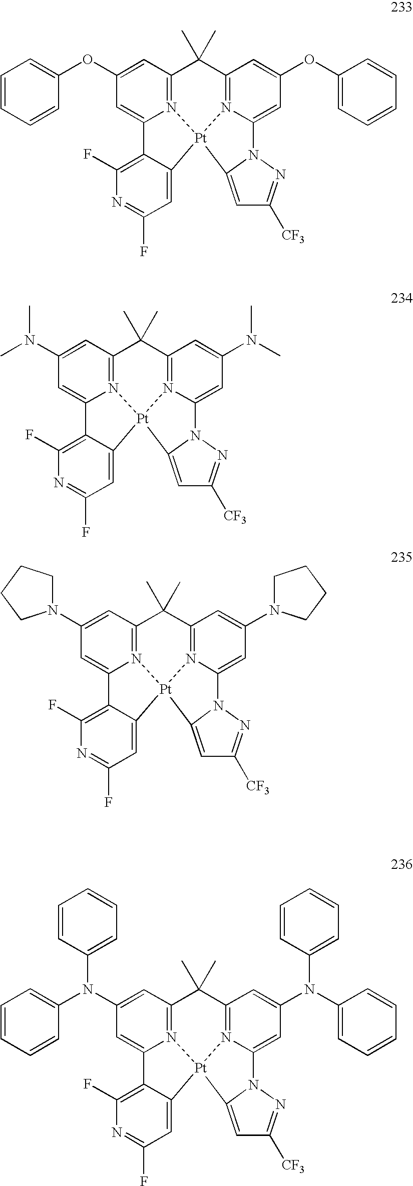

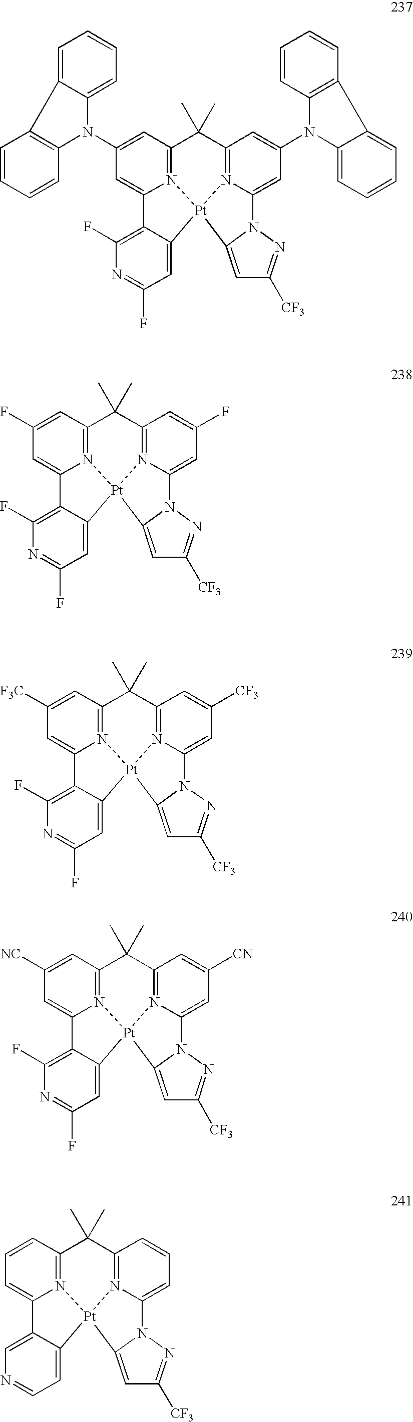

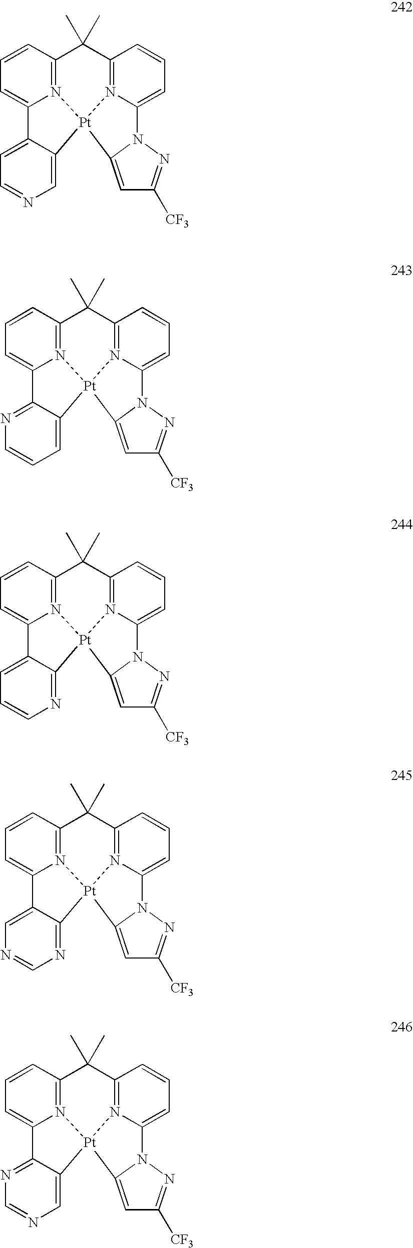

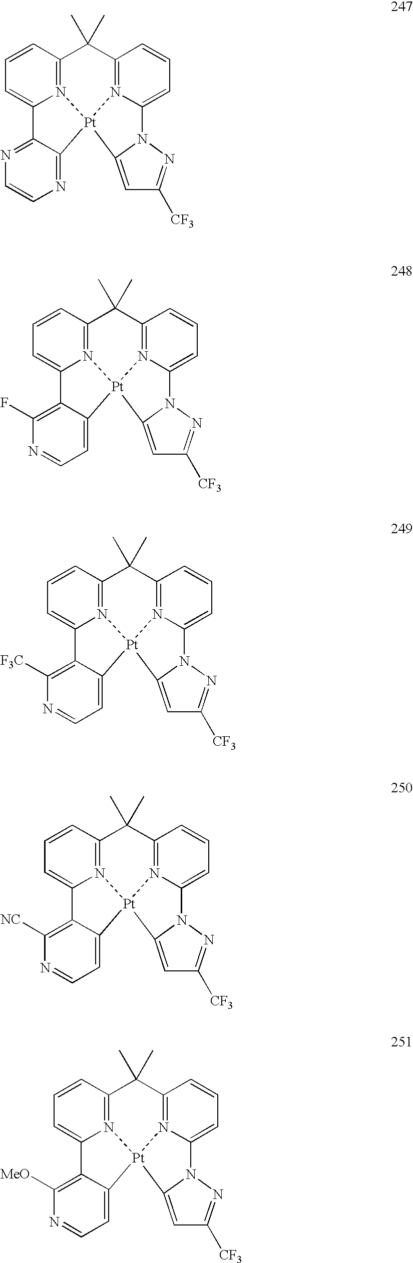

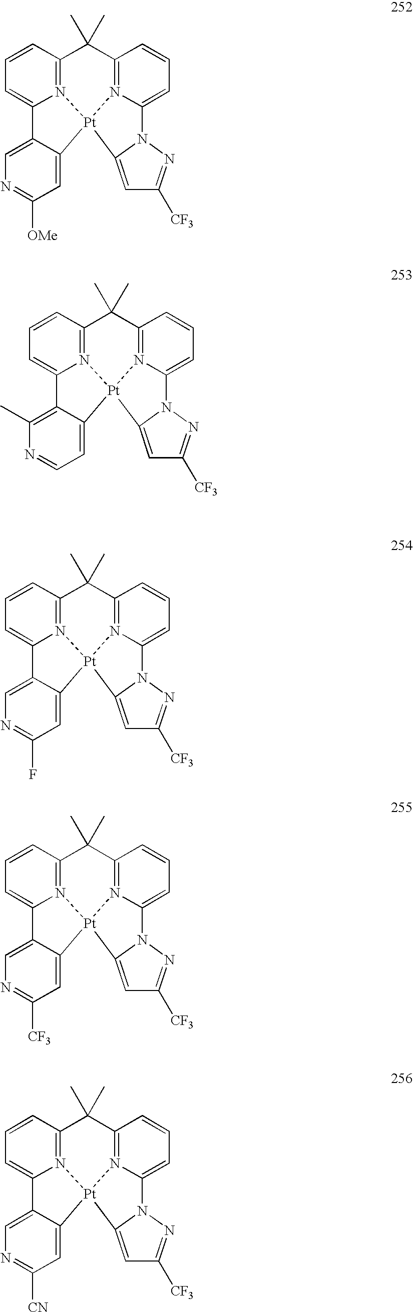

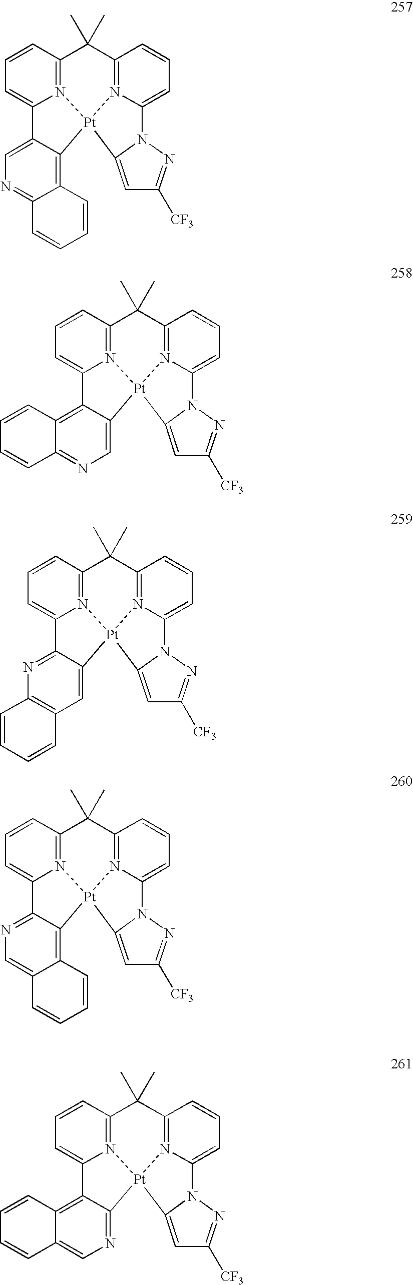

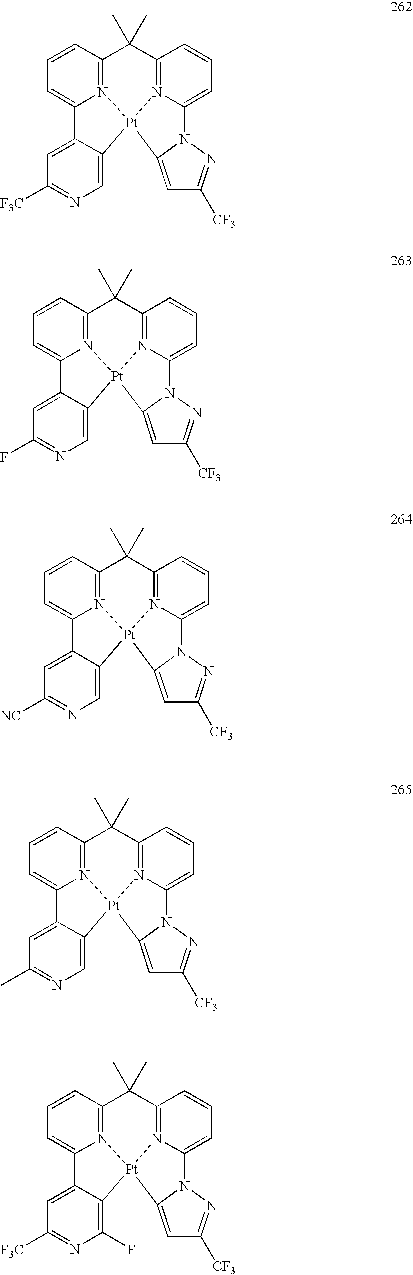

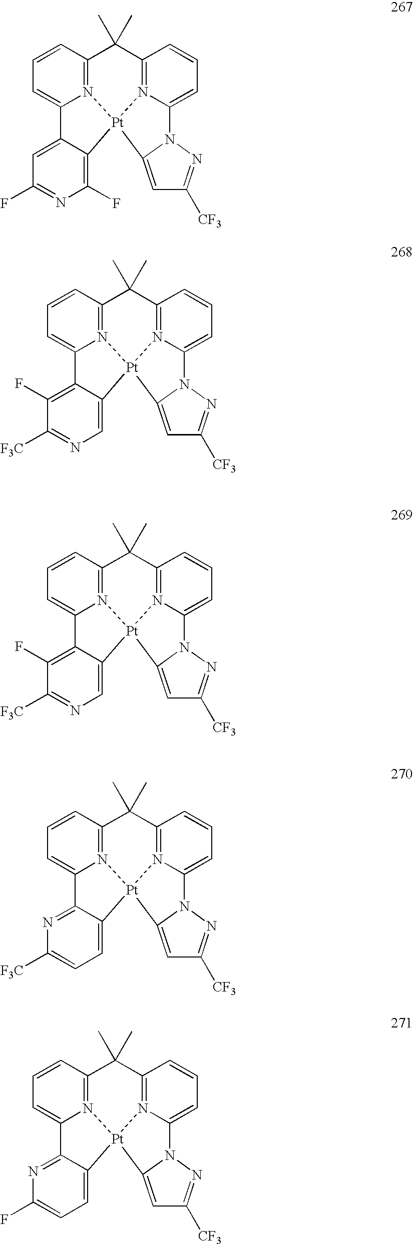

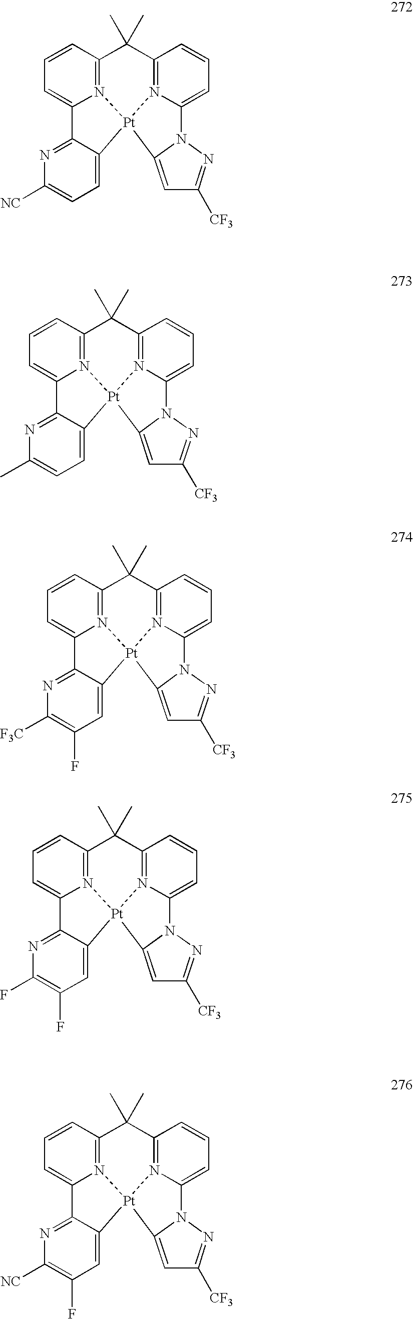

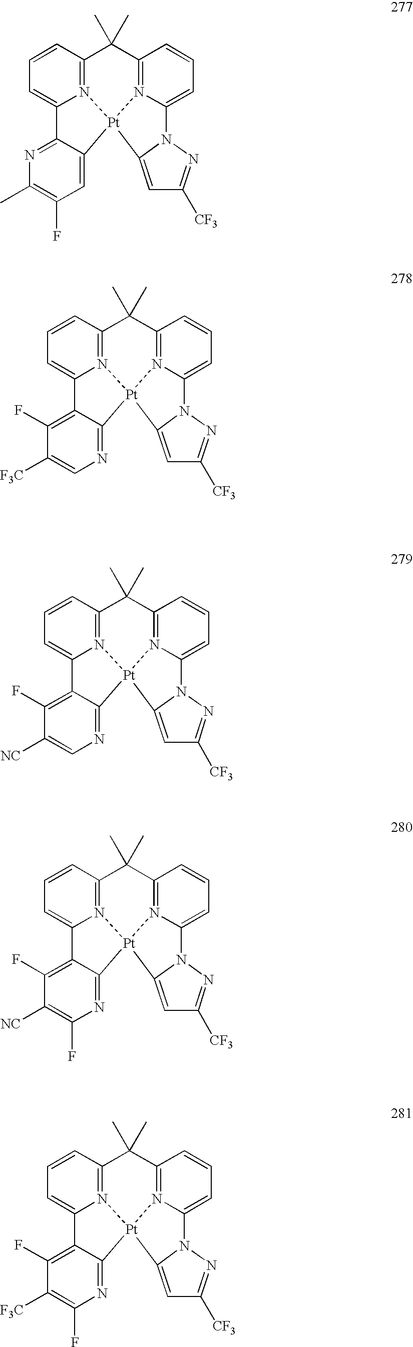

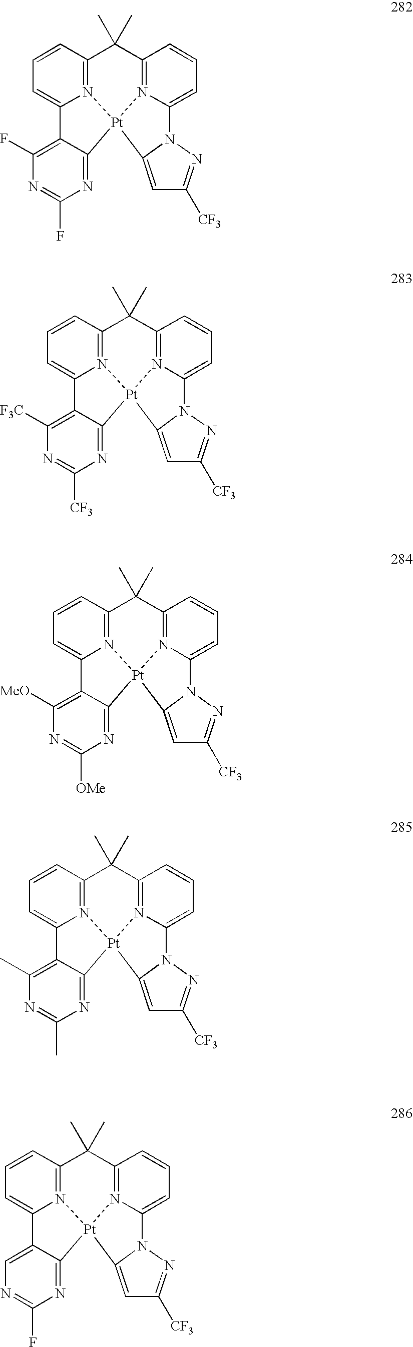

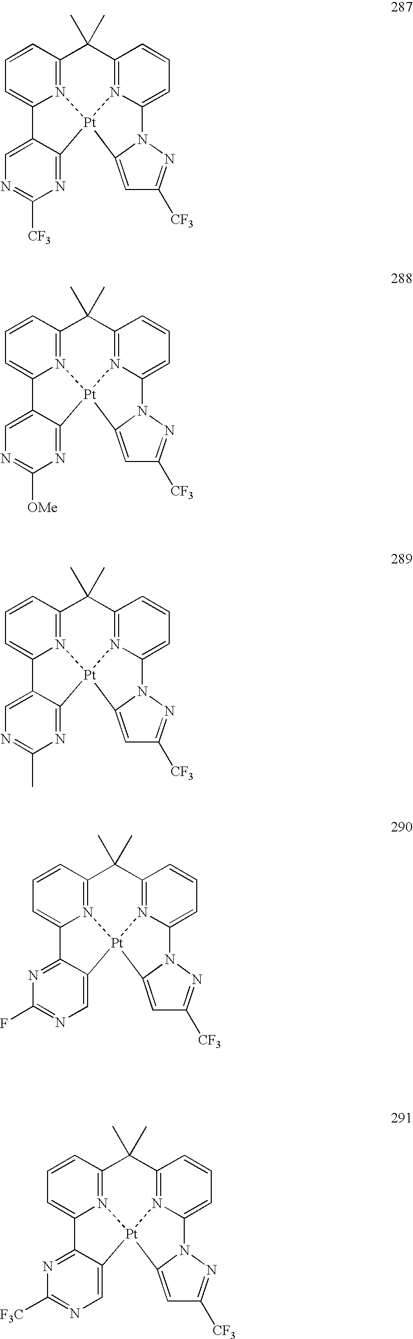

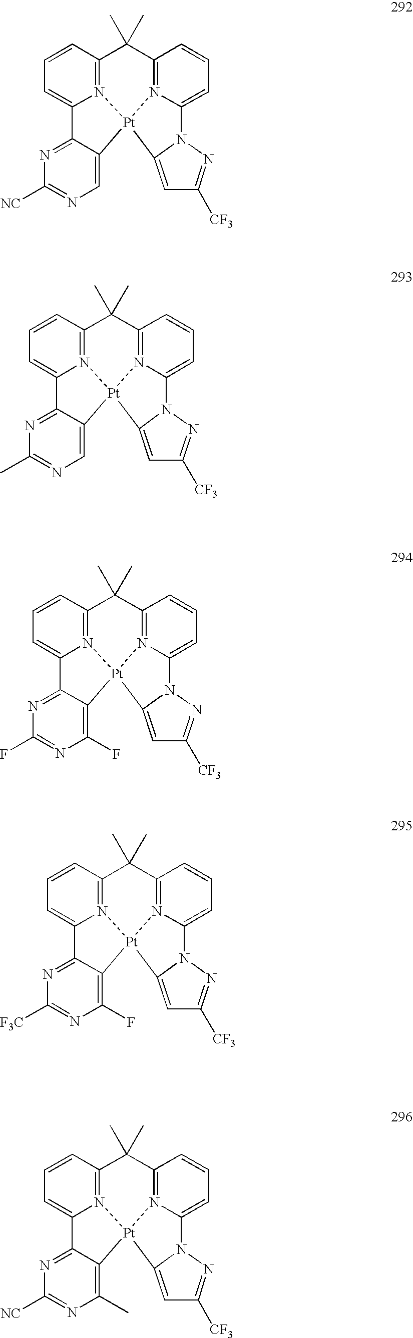

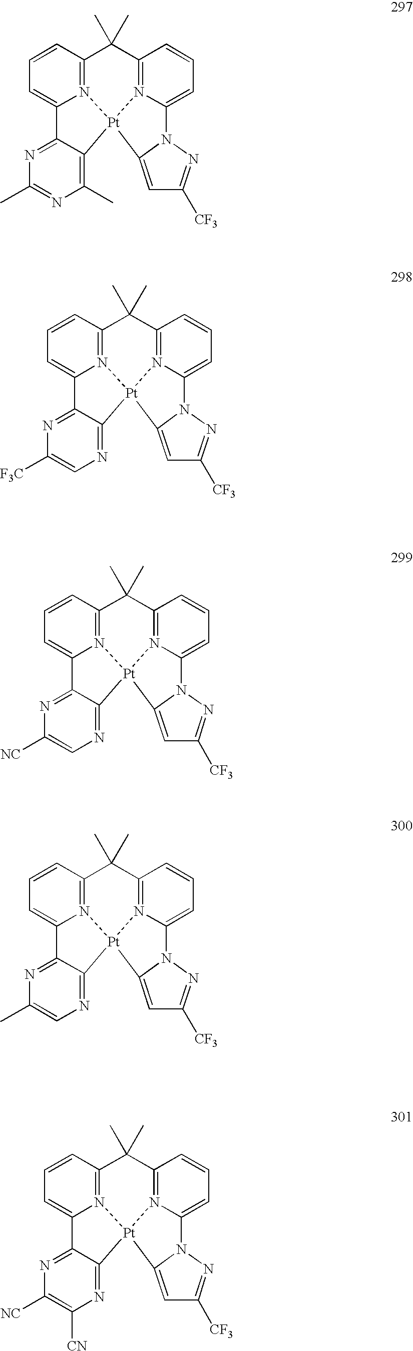

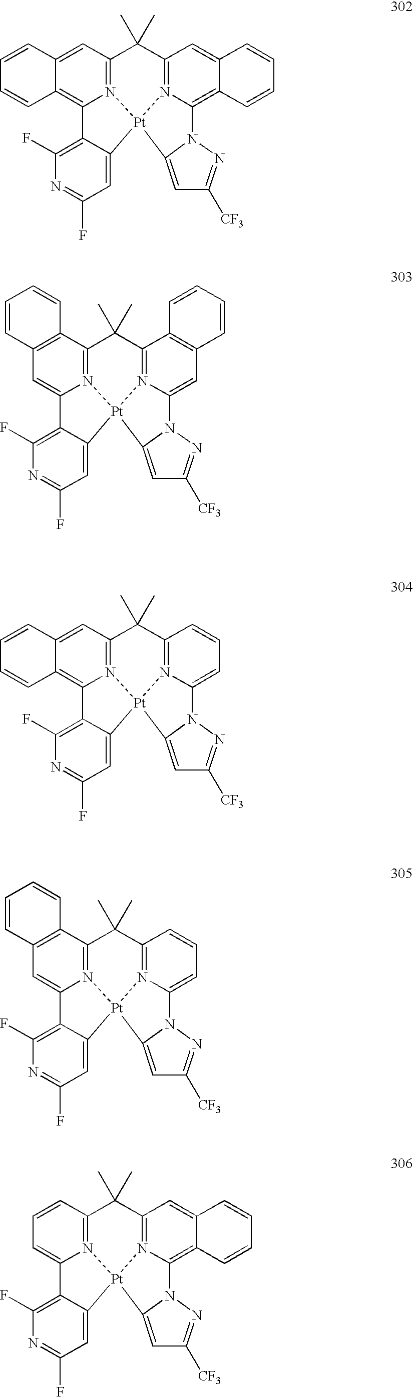

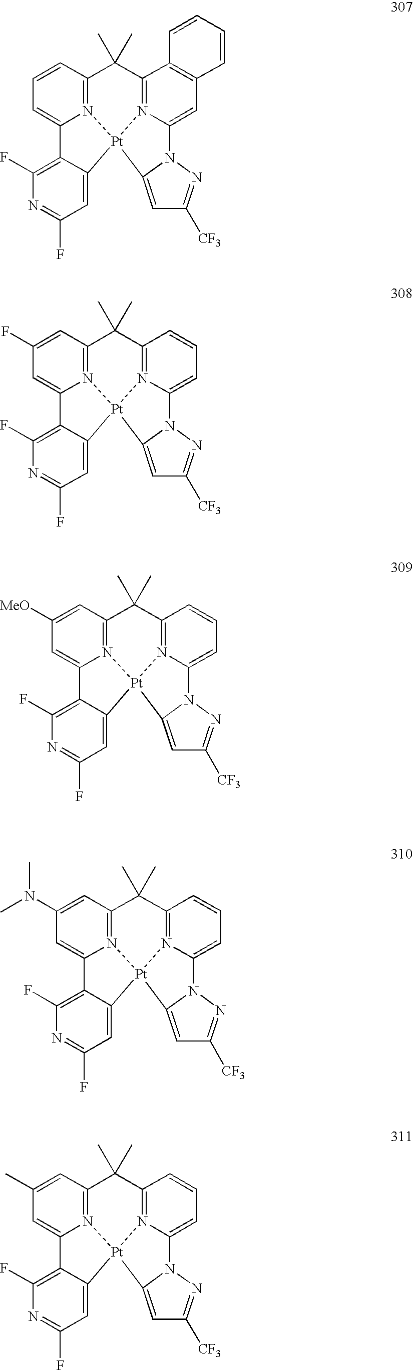

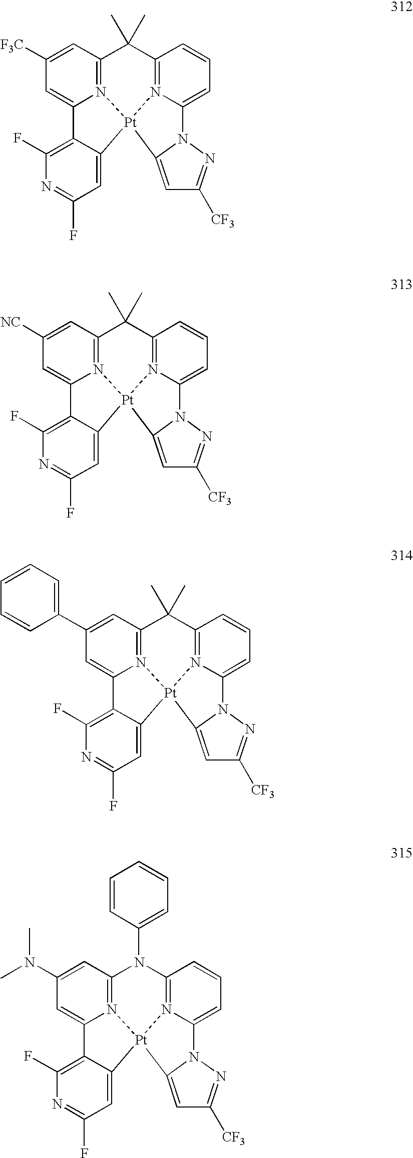

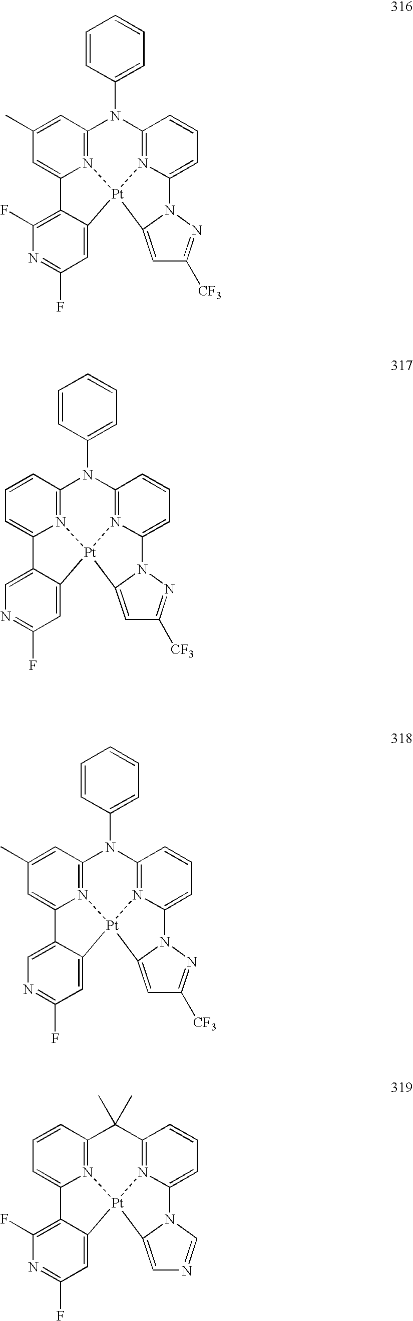

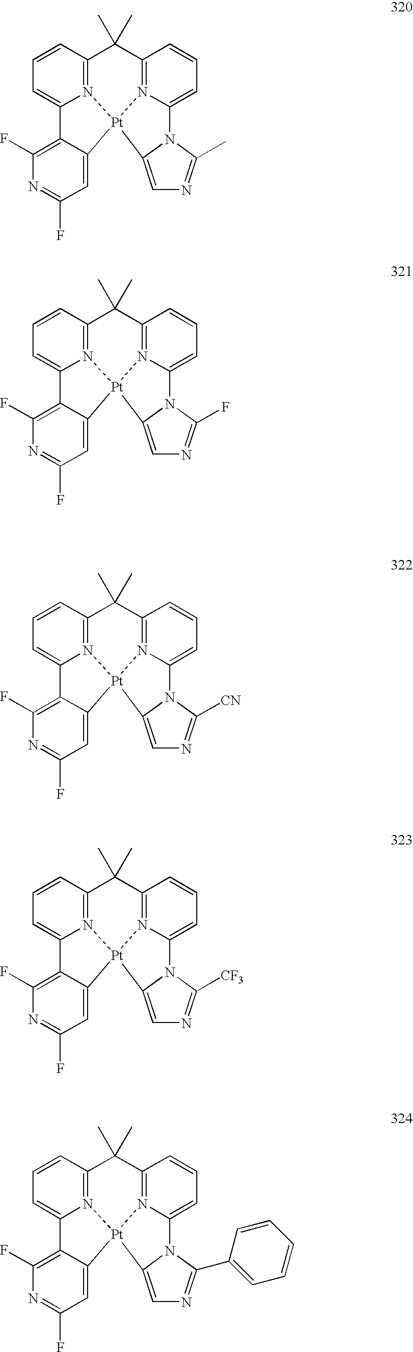

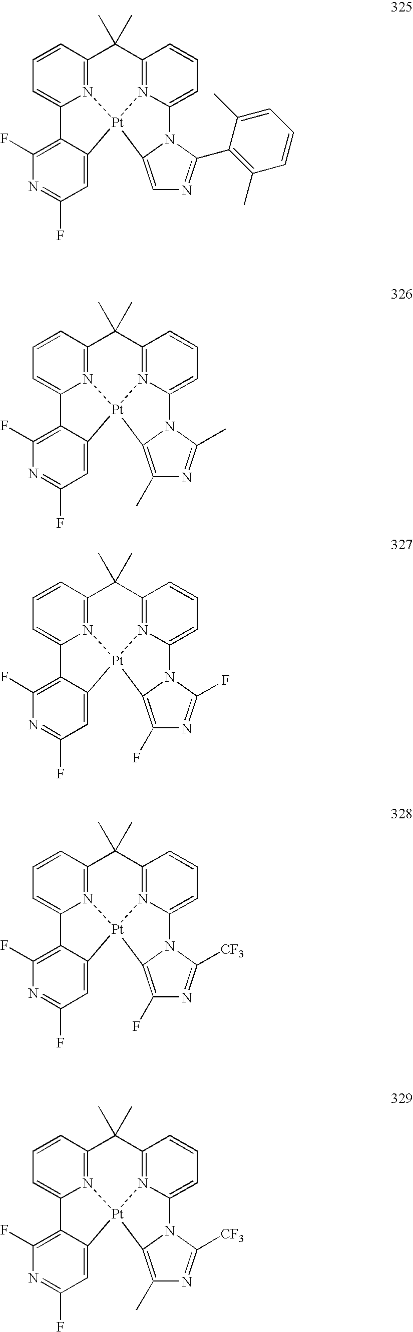

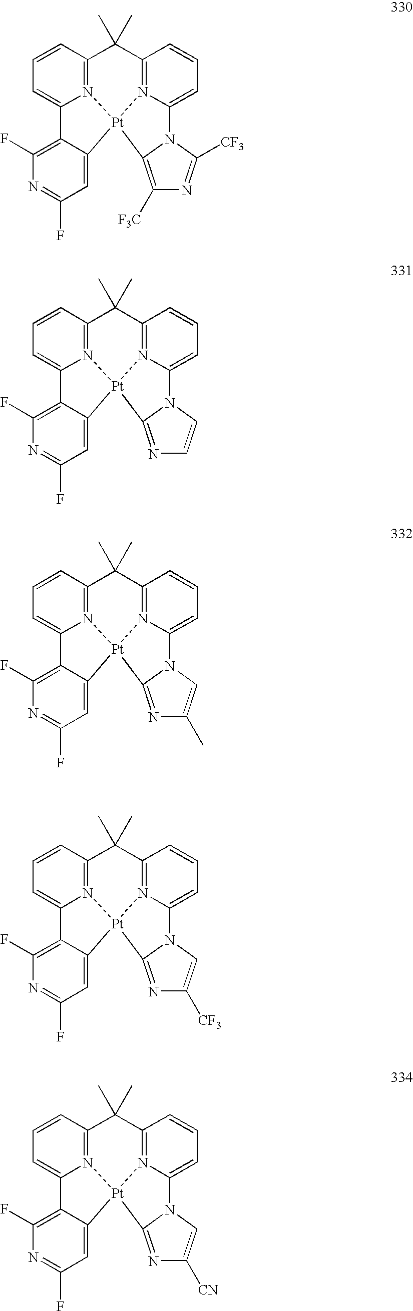

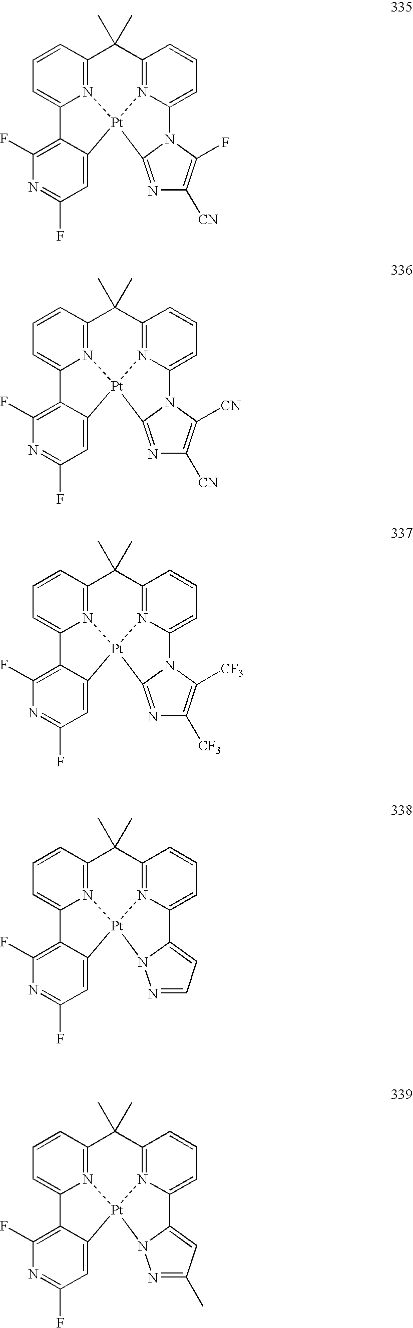

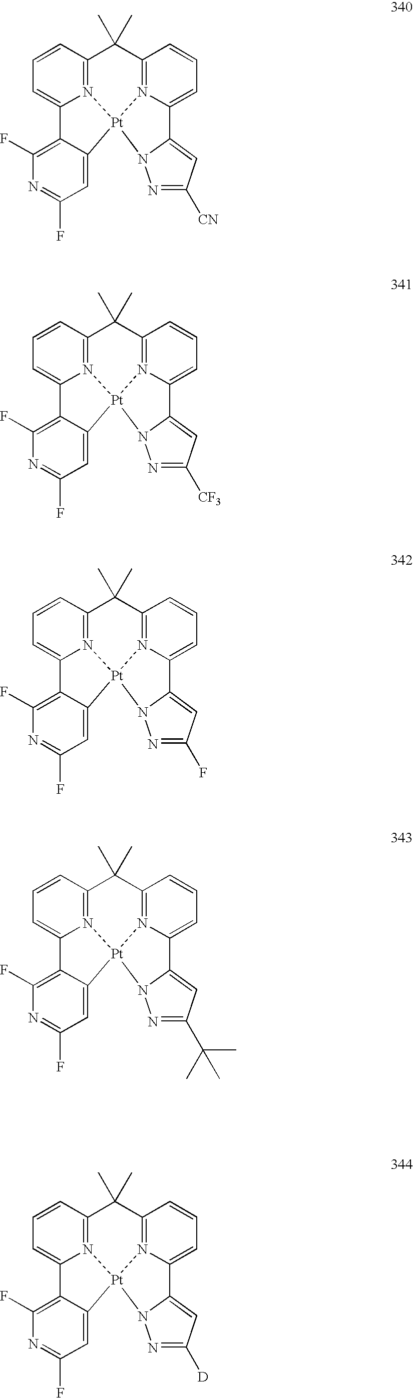

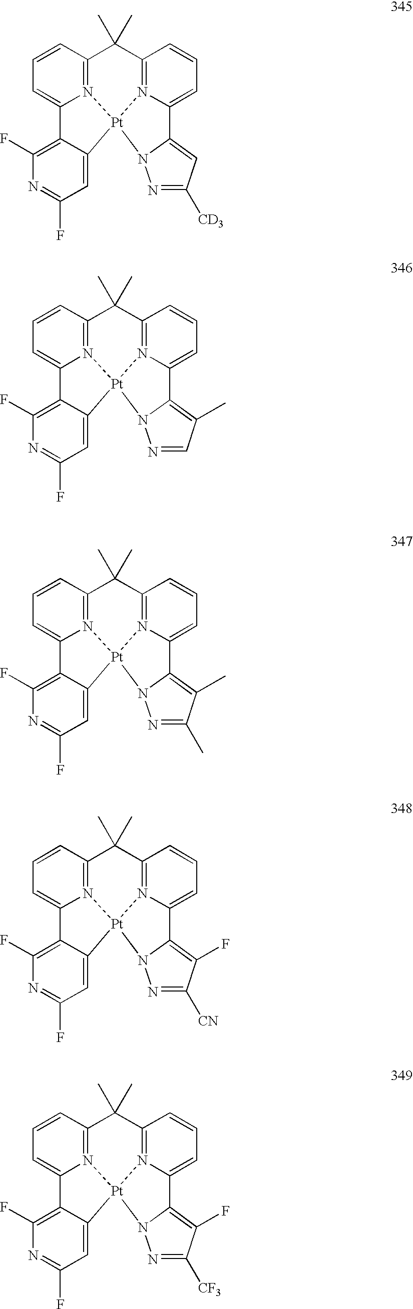

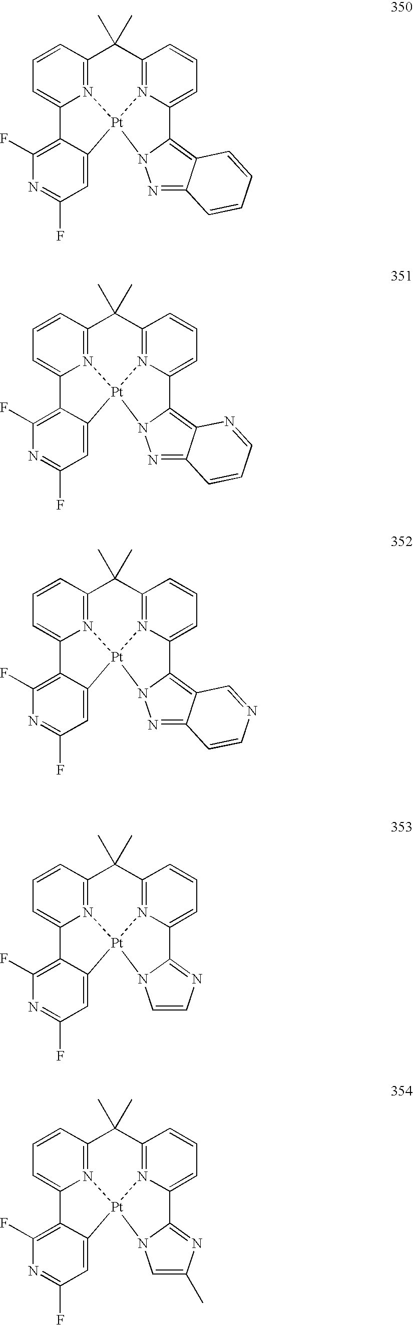

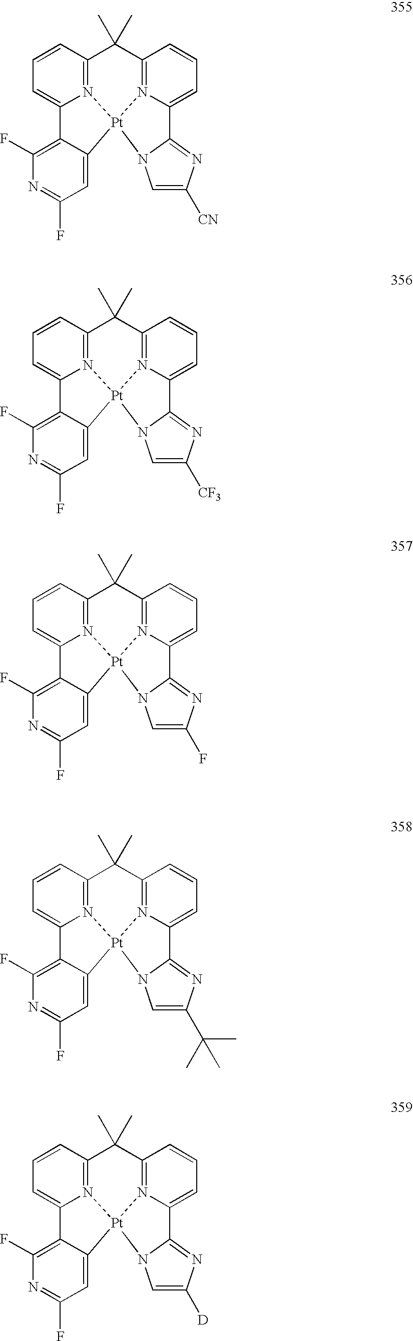

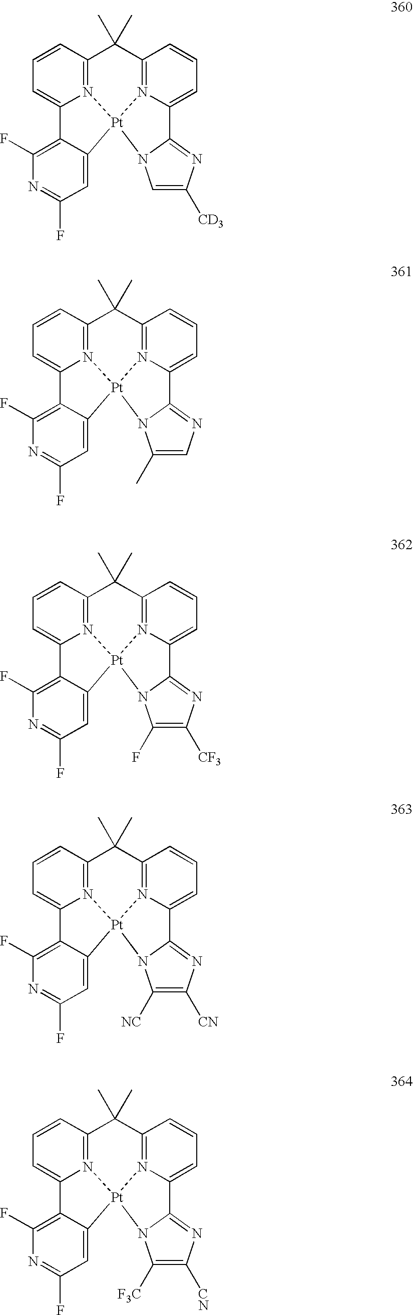

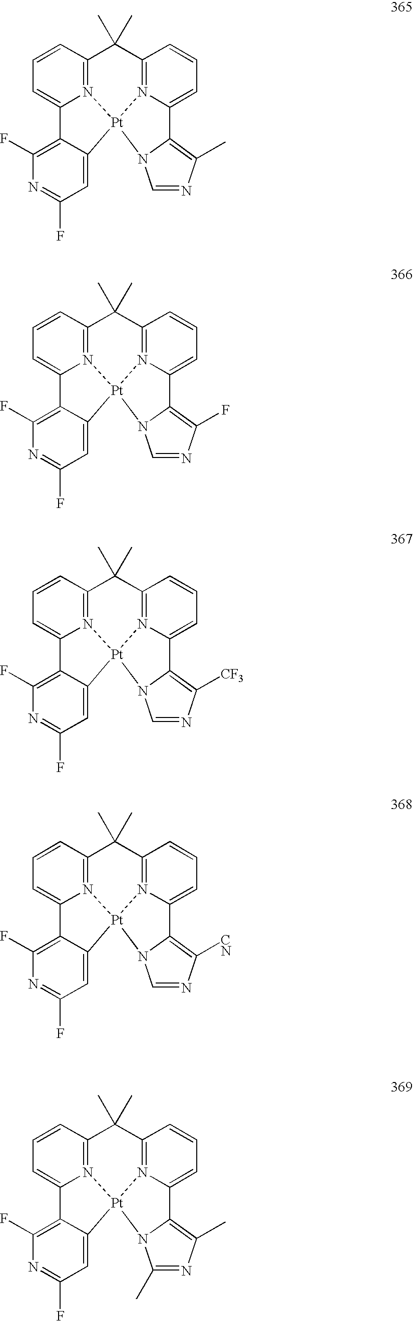

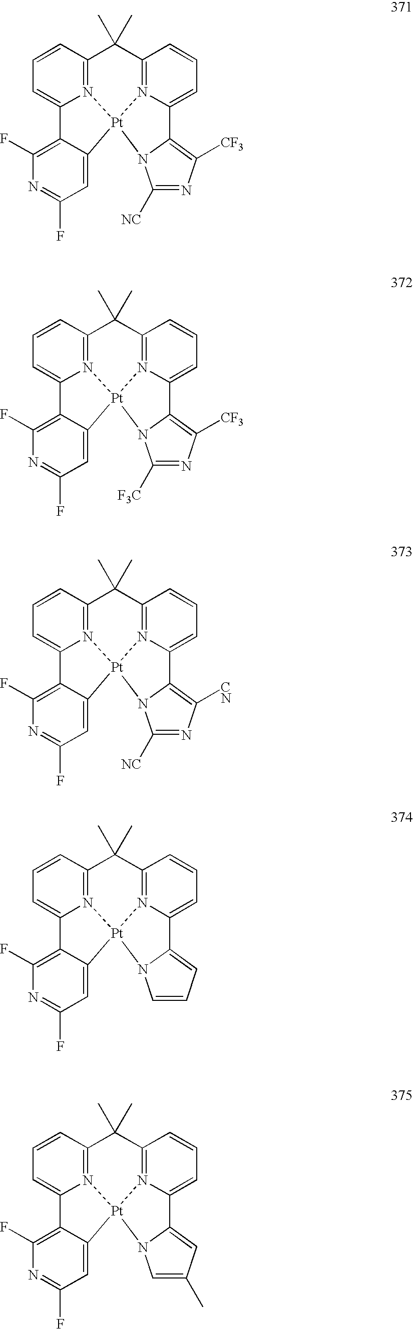

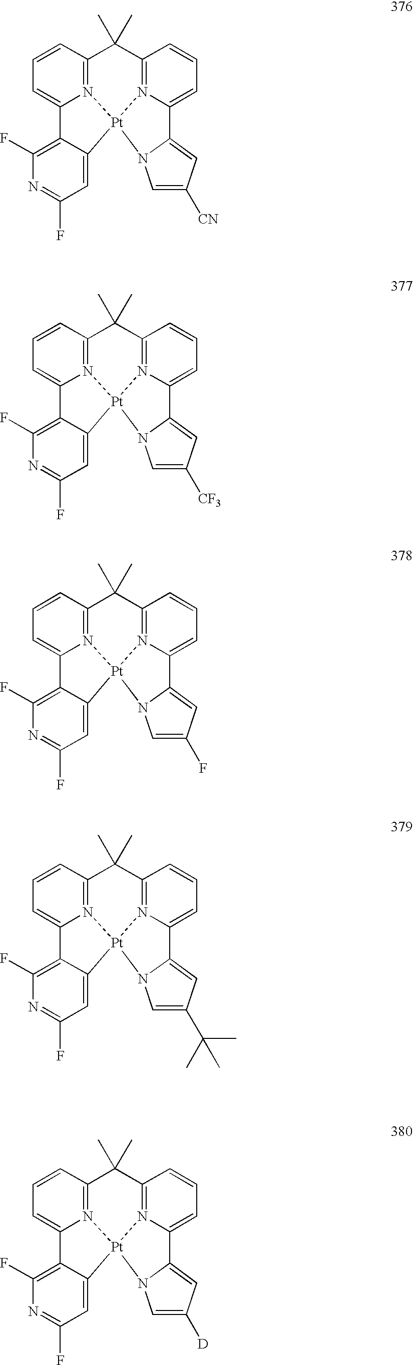

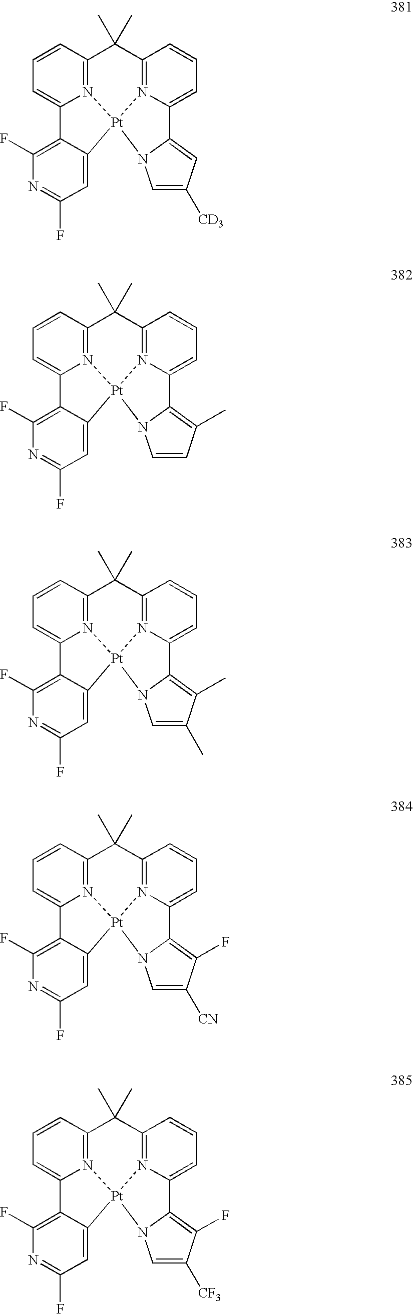

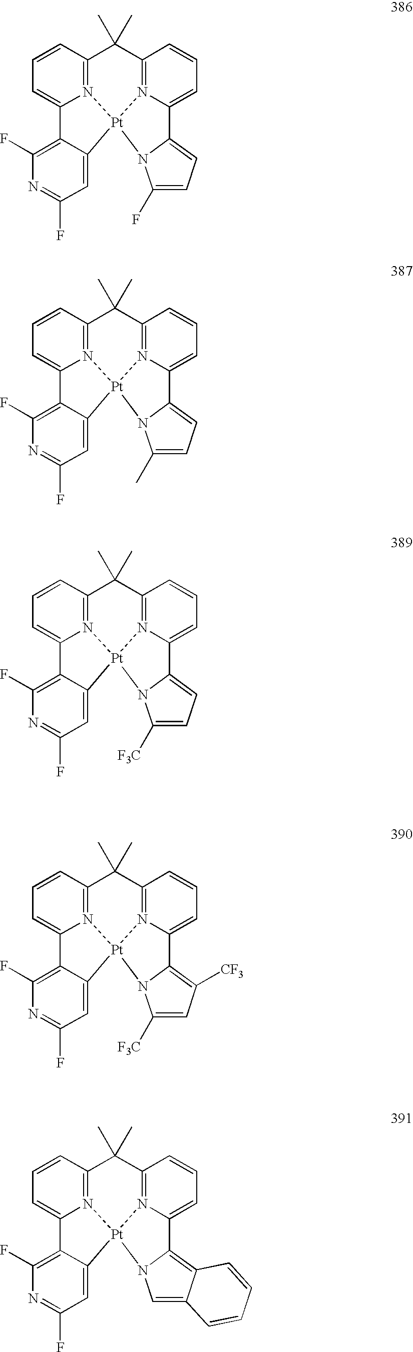

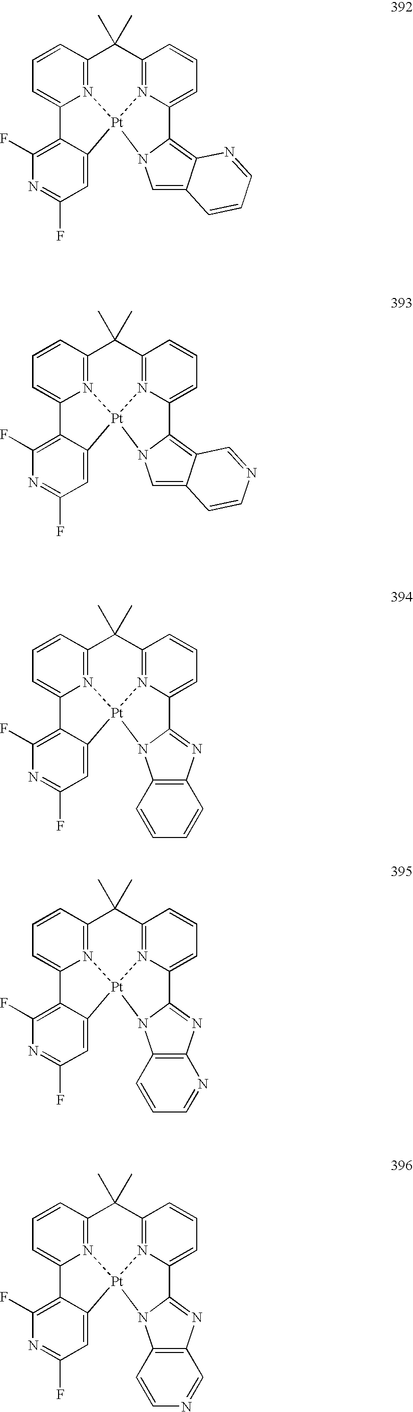

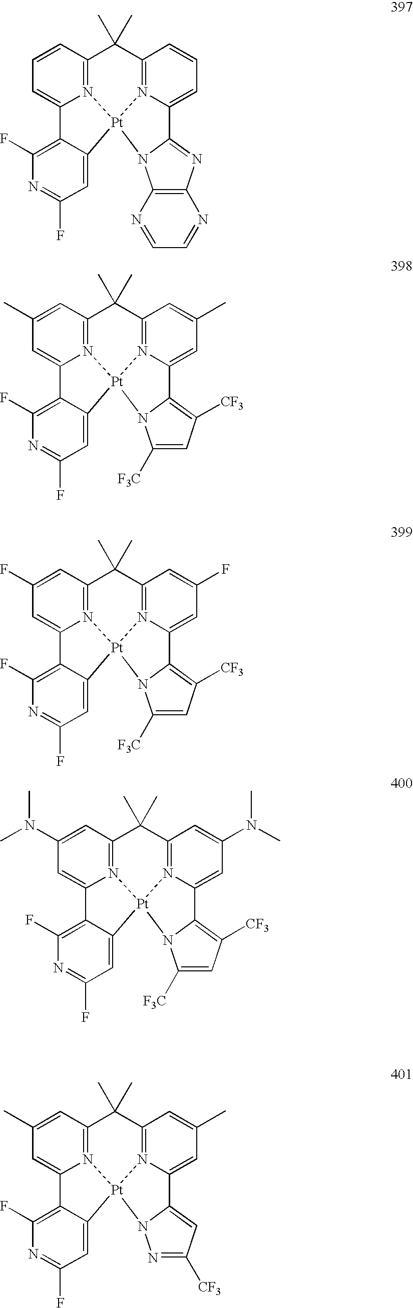

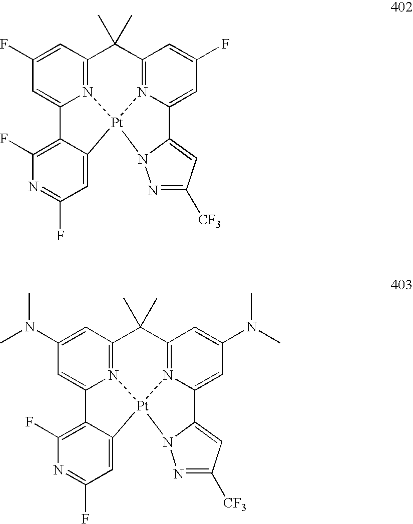

As shown by examples of the present invention, in the case where the platinum complex according to the present invention is used in the embodiments of the present invention, unexpectedly high light-emission efficiency and low driving voltage are attained. The cause bringing about the above high light-emission efficiency and low driving voltage is not clear, however, it is supposed as follows, from the characteristics of a platinum complex that the platinum complex generally tends to take a planar configuration. In a thin film, a planar platinum complex may easily form aggregates among molecules. In the case where the compound represented by formula (1) according to the present invention is existed simultaneously, the group having a double bond or a triple bond in the compound represented by formula (1) is easily interposed between plural platinum complexes, and thereby the aggregate formation between the platinum complexes is depressed. Therefore, it is considered that the presence of the compound represented by formula (1) increases the dispersibility of platinum complexes in the thin film, and thereby the improvement of the characteristics of organic EL elements is resulted.

### 2-2. Charge Transporting Material

The light-emitting layer in the present invention includes a charge transporting material together with a light emitting material and a compound represented by formula (1). Preferably, the charge transporting material used in the present invention is a hole-transporting material.

The hole-transporting material used for the light-emitting layer of the present invention preferably has an ionization potential Ip of from 5.1 eV to 6.4 eV, more preferably from 5.4 eV to 6.2 eV, and even more preferably from 5.6 eV to 6.0 eV in view of improvement in durability and decrease in driving voltage. Furthermore, it preferably has an electron affinity Ea of from 1.2 eV to 3.1 eV, more preferably from 1.4 eV to 3.0 eV, and even more preferably from 1.8 eV to 2.8 eV in view of improvement in durability and decrease in driving voltage.

Specific examples of such hole-transporting material include pyrrole, indole, carbazole, azaindole, azacarbazole, pyrazole, imidazole, polyarylalkane, pyrazoline, pyrazolone, phenylenediamine, arylamine, amino-substituted chalcone, styrylanthracene, fluorenone, hydrazone, stilbene, silazane, aromatic tertiary amine compounds, styrylamine compounds, aromatic dimethylidine compounds, porphyrin compounds, polysilane compounds, poly(N-vinylcarbazole), aniline copolymers, electric conductive high-moleculars or oligomers such as thiophene oligomers, polythiophenes and the like, organosilanes, carbon films, derivatives thereof, and the like.

Among these, indole derivatives, carbazole derivatives, azaindole derivatives, azacarbazole derivatives, aromatic tertiary amine compounds, and thiophene derivatives are preferable, and particularly, compounds containing a plurality of at least one of indole skeletons, carbazole skeletons, azaindole skeletons, azacarbazole skeletons, and aromatic tertiary amine skeletons in the molecule are preferred.

As specific examples of the hole-transporting material described above, the following compounds may be listed, but the present invention is not limited thereto.

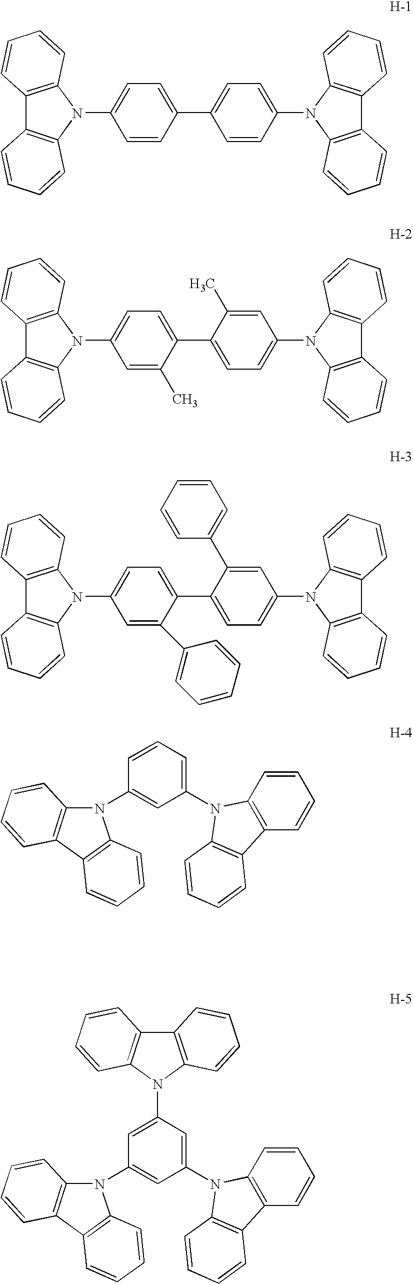

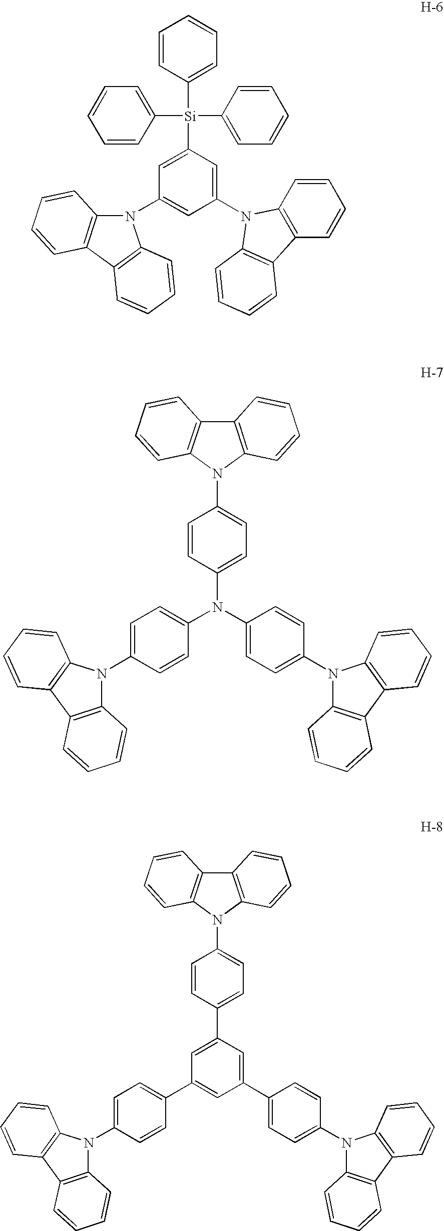

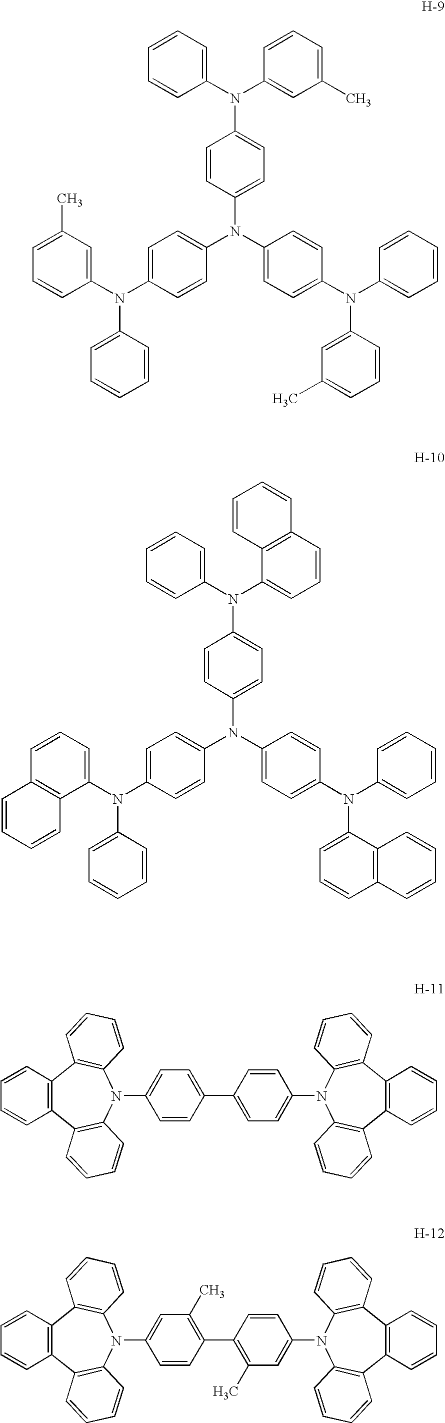

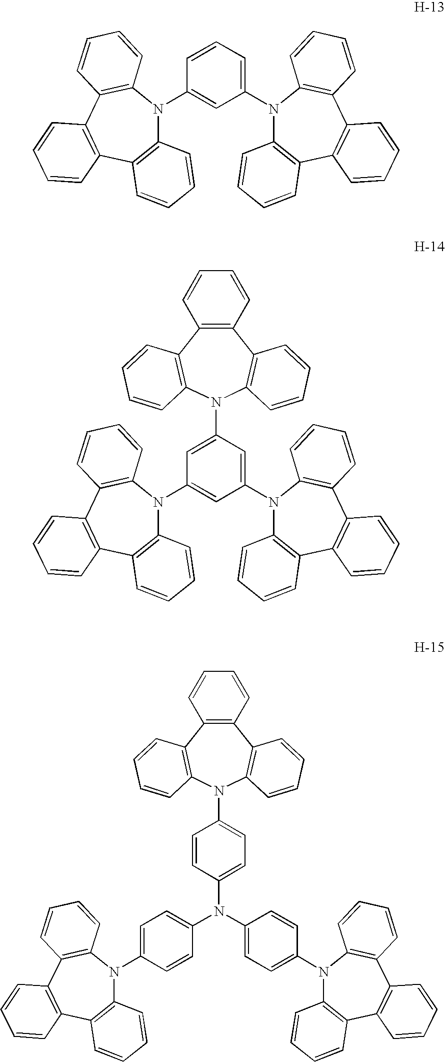

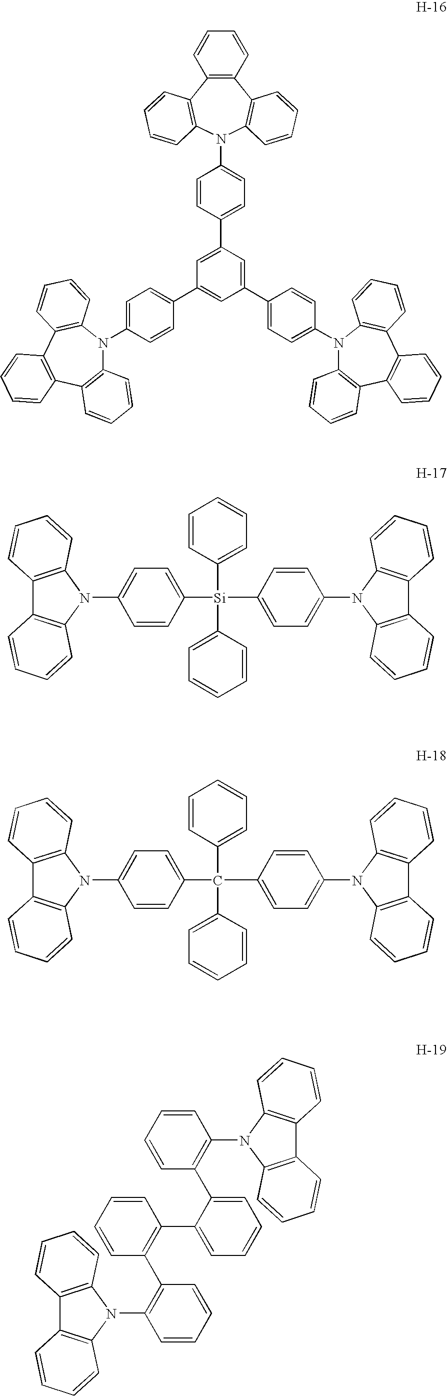

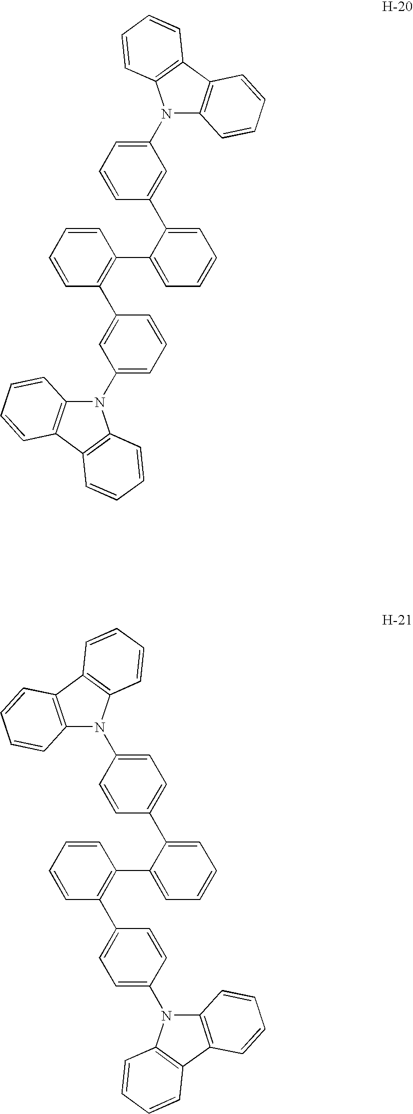

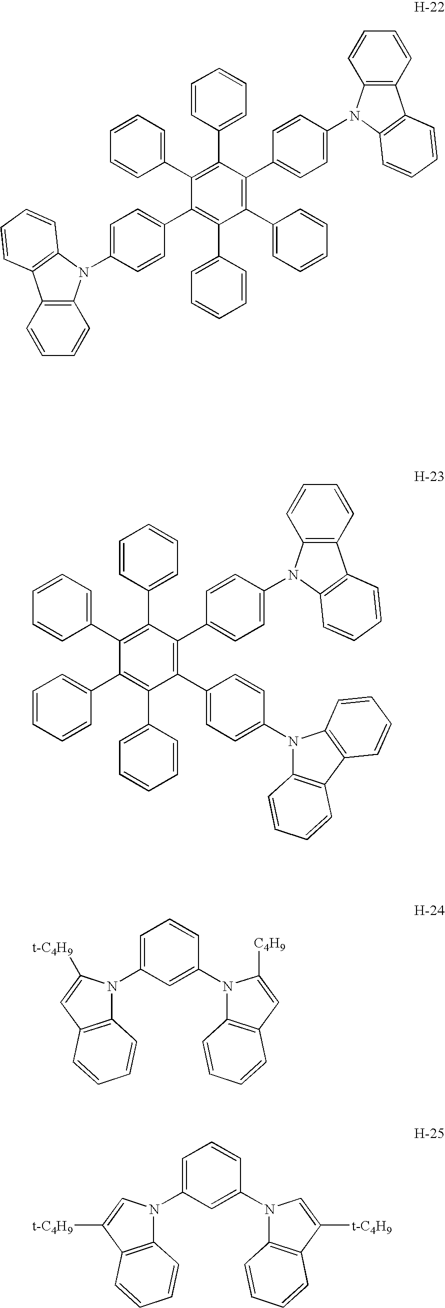

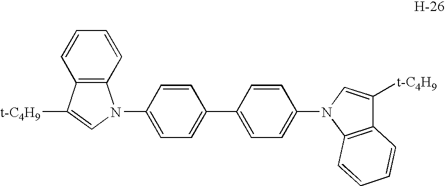

A thickness of the light-emitting layer is not particularly limited, but is generally preferably from 1 nm to 500 nm, more preferably from 5 nm to 200 nm, and even more preferably from 10 nm to 100 nm.

### 3. Constitution of Organic EL Element

In the following, the constitution of the organic EL element of the present invention will be described in detail.

The organic EL element in the present invention has an anode and a cathode on a substrate, and a plurality of organic layers including a light-emitting layer between the two electrodes, wherein organic compound layers are preferably disposed on both sides of the light-emitting layer and in contact with the light-emitting layer. Moreover, another organic compound layer may be disposed between the electrode and the organic compound layer in contact with the light-emitting layer.

Due to the nature of a light-emitting element, it is preferred that at least one electrode of an anode or a cathode is transparent. Generally, an anode is transparent.

As a lamination pattern of the organic compound layers of the organic EL element in the present invention, the organic compound layers are preferably laminated in the order of a hole transport layer, a light-emitting layer, and an electron transport layer from the anode side. Moreover, a charge blocking layer and the like may be disposed between the hole transport layer and the light-emitting layer, or between the light-emitting layer and the electron transport layer.

A preferable embodiment of the organic compound layer in the organic electroluminescence element of the present invention is as follows: the organic compound layer includes at least a hole injection layer, a hole transport layer, a light-emitting layer, a hole-blocking layer, an electron transport layer, and an electron injection layer in this order from the anode side.

In the case where a hole-blocking layer is disposed between a light-emitting layer and an electron transport layer, an organic compound layer adjacent to the light-emitting layer on an anode side is a hole transport layer, and an organic compound layer adjacent to the light-emitting layer on a cathode side is a hole blocking layer. Furthermore, a hole injection layer may be disposed between an anode and a hole transport layer, and an electron injection layer may be disposed between a cathode and an electron transport layer. Each of the layers mentioned above may be composed of a plurality of secondary layers.

### <Substrate>

The substrate to be applied in the invention is preferably one which does not scatter or attenuate light emitted from the light-emitting layer. Specific examples of materials for the substrate include inorganic materials such as zirconia-stabilized yttrium (YSZ) and glass; polyesters such as polyethylene terephthalate, polybutylene phthalate, and polyethylene naphthalate; and organic materials such as polystyrene, polycarbonate, polyethersulfone, polyarylate, polyimide, polycycloolefin, norbornene resin, polychlorotrifluoroethylene, and the like.

For instance, when glass is used as the substrate, non-alkali glass is preferably used with respect to the quality of material in order to decrease ions eluted from the glass. In the case of employing soda-lime glass, it is preferred to use glass on which a barrier coat of silica or the like has been applied. In the case of employing an organic material, it is preferred to use a material excellent in heat resistance, dimension stability, solvent resistance, electric insulation performance, and workability.

There is no particular limitation as to the shape, the structure, the size or the like of the substrate, but it may be suitably selected according to the application, purpose and the like of the light-emitting element. In general, a plate-like substrate is preferred as the shape of the substrate. A structure of the substrate may be a monolayer structure or a laminated structure. Furthermore, the substrate may be formed from a single member or two or more members.

Although the substrate may be transparent and colorless, or transparent and colored, it is preferred that the substrate is transparent and colorless from the viewpoint that the substrate does not scatter or attenuate light emitted from the organic light-emitting layer.

A moisture permeation preventive layer (gas barrier layer) may be provided on the front surface or the back surface of the substrate.

For a material of the moisture permeation preventive layer (gas barrier layer), inorganic substances such as silicon nitride and silicon oxide may be preferably applied. The moisture permeation preventive layer (gas barrier layer) may be formed in accordance with, for example, a high-frequency sputtering method or the like.

In the case of applying a thermoplastic substrate, a hard-coat layer or an under-coat layer may be further provided as needed.

### <Anode>

The anode may generally be any material as long as it has a function as an electrode for supplying holes to the organic compound layer, and there is no particular limitation as to the shape, the structure, the size or the like. However, it may be suitably selected from among well-known electrode materials according to the application and purpose of the light-emitting element. As mentioned above, the anode is usually provided as a transparent anode.

Materials for the anode preferably include, for example, metals, alloys, metal oxides, electric conductive compounds, and mixtures thereof. Specific examples of the anode materials include electric conductive metal oxides such as tin oxides doped with antimony, fluorine or the like (ATO and FTO), tin oxide, zinc oxide, indium oxide, indium tin oxide (ITO), and indium zinc oxide (IZO); metals such as gold, silver, chromium, and nickel; mixtures or laminates of these metals and the electric conductive metal oxides; inorganic electric conductive materials such as copper iodide and copper sulfide; organic electric conductive materials such as polyaniline, polythiophene, and polypyrrole; and laminates of these inorganic or organic electric conductive materials with ITO. Among these, the electric conductive metal oxides are preferred, and particularly, ITO is preferable in view of productivity, high electric conductivity, transparency and the like.

The anode may be formed on the substrate in accordance with a method which is appropriately selected from among wet methods such as printing methods, coating methods and the like; physical methods such as vacuum deposition methods, sputtering methods, ion plating methods and the like; and chemical methods such as chemical vapor deposition (CVD) and plasma CVD methods and the like, in consideration of the suitability to a material constituting the anode. For instance, when ITO is selected as a material for the anode, the anode may be formed in accordance with a direct current (DC) or high-frequency sputtering method, a vacuum deposition method, an ion plating method or the like.

In the organic electroluminescence element of the present invention, a position at which the anode is to be formed is not particularly limited, but it may be suitably selected according to the application and purpose of the light-emitting element. The anode is preferably formed on the substrate described above. In this case, the anode may be formed on either the whole surface or a part of the surface on either side of the substrate.

For patterning to form the anode, a chemical etching method such as photolithography, a physical etching method such as etching by laser, a method of vacuum deposition or sputtering through superposing masks, or a lift-off method or a printing method may be applied.

A thickness of the anode may be suitably selected according to the material constituting the anode and is therefore not definitely decided, but it is usually in a range of from 10 nm to 50 μm, and preferably from 50 nm to 20 μm.

A value of electric resistance of the anode is preferably 10³ Ω/□ or less, and more preferably 10² Ω/□. In the case where the anode is transparent, it may be either transparent and colorless, or transparent and colored. For extracting luminescence from the transparent anode side, it is preferred that a light transmittance of the anode is 60% or higher, and more preferably 70% or higher.

Concerning transparent anodes, there is a detailed description in “TOUMEI DENNKYOKU-MAKU NO SHINTENKAI (Novel Developments in Transparent Electrode Films)” edited by Yutaka Sawada, published by C.M.C. in 1999, the contents of which are incorporated by reference herein. In the case where a plastic substrate having a low heat resistance is applied, it is preferred that ITO or IZO is used to obtain a transparent anode prepared by forming a film thereof at a low temperature of 150° C. or lower.

### <Cathode>

The cathode may generally be any material as long as it has a function as an electrode for injecting electrons to the organic compound layer, and there is no particular limitation as to the shape, the structure, the size or the like. However it may be suitably selected from among well-known electrode materials according to the application and purpose of the light-emitting element.

Materials constituting the cathode include, for example, metals, alloys, metal oxides, electric conductive compounds, and mixtures thereof. Specific examples thereof include alkali metals (e.g., Li, Na, K, Cs and the like), alkaline earth metals (e.g., Mg, Ca and the like), gold, silver, lead, aluminum, sodium-potassium alloys, lithium-aluminum alloys, magnesium-silver alloys, rare earth metals such as indium and ytterbium, and the like. They may be used alone, but it is preferred that two or more of them are used in combination from the viewpoint of satisfying both stability and electron injectability.

Among these, as the materials for constituting the cathode, alkaline metals or alkaline earth metals are preferred in view of electron injectability, and materials containing aluminum as a major component are preferred in view of excellent preservation stability.

The term “material containing aluminum as a major component” refers to a material constituted by aluminum alone; alloys comprising aluminum and 0.01% by weight to 10% by weight of an alkaline metal or an alkaline earth metal; or the mixtures thereof (e.g., lithium-aluminum alloys, magnesium-aluminum alloys and the like).

Regarding materials for the cathode, they are described in detail in JP-A Nos. 2-15595 and 5-121172, the contents of which are incorporated by reference herein.

A method for forming the cathode is not particularly limited, but it may be formed in accordance with a well-known method. For instance, the cathode may be formed in accordance with a method which is appropriately selected from among wet methods such as printing methods, coating methods and the like; physical methods such as vacuum deposition methods, sputtering methods, ion plating methods and the like; and chemical methods such as CVD and plasma CVD methods and the like, in consideration of the suitability to a material constituting the cathode. For example, when a metal (or metals) is (are) selected as a material (or materials) for the cathode, one or two or more of them may be applied at the same time or sequentially in accordance with a sputtering method or the like.

For patterning to form the cathode, a chemical etching method such as photolithography, a physical etching method such as etching by laser, a method of vacuum deposition or sputtering through superposing masks, or a lift-off method or a printing method may be applied.

In the present invention, a position at which the cathode is to be formed is not particularly limited, and it may be formed on either the whole or a part of the organic compound layer.

Furthermore, a dielectric material layer made of fluorides, oxides or the like of an alkaline metal or an alkaline earth metal may be inserted between the cathode and the organic compound layer with a thickness of from 0.1 nm to 5 nm. The dielectric layer may be considered to be a kind of electron injection layer. The dielectric material layer may be formed in accordance with, for example, a vacuum deposition method, a sputtering method, an ion plating method or the like.

A thickness of the cathode may be suitably selected according to materials for constituting the cathode and is therefore not definitely decided, but it is usually in a range of from 10 nm to 5 μm, and preferably from 50 nm to 1 μm.

Moreover, the cathode may be transparent or opaque. The transparent cathode may be formed by preparing a material for the cathode with a small thickness of from 1 nm to 10 nm, and further laminating a transparent electric conductive material such as ITO or IZO thereon.

### <Organic Compound Layer>

The organic compound layer according to the present invention is to be described.

The organic electroluminescence element of the present invention has at least one organic compound layer including a light-emitting layer. An organic compound layer apart from the light-emitting layer comprises a hole transport layer, an electron transport layer, a charge blocking layer, a hole injection layer, an electron injection layer and the like.

### —Formation of Organic Compound Layer—

In the organic electroluminescence element of the present invention, each of the layers constituting the organic compound layer can be suitably formed in accordance with any of a dry film-forming method such as a vapor deposition method or a sputtering method; a wet film-forming method; a transfer method; a printing method; an ink-jet method; or the like.

### —Hole Injection Layer and Hole Transport Layer—

The hole injection layer and the hole transport layer are layers functioning to receive holes from an anode or from an anode side and to transport the holes to a cathode side. Materials to be introduced into the hole injection layer or hole transport layer are not particularly limited, but either of a low molecular compound or a high molecular compound may be used.

As a material for the hole injection layer and hole transport layer, it is preferred to contain specifically pyrrole derivatives, carbazole derivatives, imidazole derivatives, polyarylalkane derivatives, pyrazoline derivatives, pyrazolone derivatives, phenylenediamine derivatives, arylamine derivatives, amino-substituted chalcone derivatives, styrylanthracene derivatives, fluorenone derivatives, hydrazone derivatives, stilbene derivatives, silazane derivatives, aromatic tertiary amine compounds, styrylamine compounds, aromatic dimethylidine compounds, phthalocyanine compounds, porphyrin compounds, thiophene derivatives, organosilane derivatives, carbon, metal complexes having a ligand of phenylazole compound or phenylazine, or the like.

An electron-accepting dopant may be introduced into a hole injection layer or a hole transport layer in the organic electroluminescence element of the present invention. As the electron-accepting dopant to be introduced into a hole injection layer or a hole transport layer, either of an inorganic compound or an organic compound may be used as long as the compound has electron accepting property and a function for oxidizing an organic compound.

Specifically, the inorganic compound includes metal halides, such as ferric chloride, aluminum chloride, gallium chloride, indium chloride and antimony pentachloride and the like, and metal oxides, such as vanadium pentaoxide, molybdenum trioxide and the like.

In the case of applying organic compounds, compounds having a substituent such as a nitro group, a halogen, a cyano group, a trifluoromethyl group or the like; quinone compounds; acid anhydride compounds; fullerenes; or the like may be preferably applied.

Specific examples thereof other than those above include compounds described in patent documents such as JP-A Nos. 6-212153, 11-111463, 11-251067, 2000-196140, 2000-286054, 2000-315580, 2001-102175, 2001-160493, 2002-252085, 2002-56985, 2003-157981, 2003-217862, 2003-229278, 2004-342614, 2005-72012, 2005-166637, 2005-209643 and the like.

These electron-accepting dopants may be used alone or in a combination of two or more of them. Although an applied amount of these electron-accepting dopants depends on the type of material, 0.01% by weight to 50% by weight is preferred with respect to a hole injection layer material or a hole transport layer material, 0.05% by weight to 20% by weight is more preferable, and 0.1% by weight to 10% by weight is particularly preferred.

A thickness of the hole injection layer and a thickness of the hole transport layer are each preferably 500 nm or less in view of decrease in driving voltage.

The thickness of the hole transport layer is preferably from 1 nm to 500 nm, more preferably from 5 nm to 300 nm, and even more preferably from 10 nm to 200 nm. The thickness of the hole injection layer is preferably from 0.1 nm to 500 nm, more preferably from 0.5 nm to 300 nm, and even more preferably from 1 nm to 200 nm.

The hole injection layer and the hole transport layer may be composed of a monolayer structure comprising one or two or more of the above-mentioned materials, or a multilayer structure composed of plural layers of a homogeneous composition or a heterogeneous composition.

### —Electron Injection Layer and Electron Transport Layer—

The electron injection layer and electron transport layer are layers having a function of receiving electrons from the cathode or cathode side and transporting the electrons to the anode side. Materials to be introduced into the electron injection layer and electron transport layer according to the invention are not particularly limited, but either of a low molecular compound or a high molecular compound may be used.

Specific examples of the materials applied for the electron injection layer and the electron transport layer include pyridine derivatives, quinoline derivatives, pyrimidine derivatives, pyrazine derivatives, phthalazine derivatives, phenanthroline derivatives, triazine derivatives, triazole derivatives, oxazole derivatives, oxadiazole derivatives, imidazole derivatives, fluorenone derivatives, anthraquinodimethane derivatives, anthrone derivatives, diphenylquinone derivatives, thiopyrandioxide derivatives, carbodiimide derivatives, fluorenylidenemethane derivatives, distyrylpyradine derivatives, aromatic tetracarboxylic anhydrides of naphthalene, perylene or the like, phthalocyanine derivatives; and metal complexes represented by metal complexes of 8-quinolinol derivatives, metal phthalocyanine, metal complexes containing benzoxazole or benzothiazole as the ligand, or organosilane derivatives represented by silol.

The electron injection layer or electron transport layer in the organic EL element of the present invention may include an electron-donating dopant.

As a material applied for the electron-donating dopant which is added into the electron injection layer or the electron transport layer, any material may be used as long as it has an electron-donating property and a property for reducing an organic compound, and alkaline metals such as Li, alkaline earth metals such as Mg, transition metals including rare-earth metals or reducing organic compounds are preferably used. Particularly, metals having a work function of 4.2 V or less are preferably applied, and specific examples thereof include Li, Na, K, Be, Mg, Ca, Sr, Ba, Y, Cs, La, Sm, Gd, and Yb. Specific examples of the reducing organic compound include nitrogen-containing compounds, sulfur-containing compounds, phosphorus-containing compounds, and the like.

In addition, materials described in JP-A Nos. 6-212153, 2000-196140, 2003-68468, 2003-229278 and 2004-342614 may be used.

These electron-donating dopants may be used alone or in a combination of two or more of them. An applied amount of the electron-donating dopants differs dependent on the types of the materials, but it is preferably from 0.1% by weight to 30% by weight with respect to an electron transport layer material, more preferably from 0.1% by weight to 20% by weight, and particularly preferably from 0.1% by weight to 10% by weight.

A thickness of the electron injection layer and a thickness of the electron transport layer are each preferably 500 nm or less in view of decrease in driving voltage.

The thickness of the electron transport layer is preferably from 1 nm to 500 nm, more preferably from 5 nm to 200 nm, and even more preferably from 10 nm to 100 nm. The thickness of the electron injection layer is preferably from 0.1 nm to 200 nm, more preferably from 0.2 nm to 100 nm, and even more preferably from 0.5 nm to 50 nm.

The electron injection layer and the electron transport layer may be composed of a monolayer structure comprising one or two or more of the above-mentioned materials, or a multilayer structure composed of plural layers of a homogeneous composition or a heterogeneous composition.

### —Hole-Blocking Layer—

A hole-blocking layer is a layer having a function to prevent the holes transported from the anode side to the light-emitting layer from passing through to the cathode side. According to the present invention, a hole-blocking layer may be provided as an organic compound layer adjacent to the light-emitting layer on the cathode side.

Examples of the compound constituting the hole-blocking layer include an aluminum complex such as aluminum (III) bis(2-methyl-8-quinolinato)-4-phenylphenolate (BAlq), a triazole derivative, a phenanthroline derivative such as 2,9-dimethyl-4,7-diphenyl-1,10-phenanthroline (BCP), or the like.

A thickness of the hole-blocking layer is preferably from 1 nm to 500 nm, more preferably from 5 nm to 200 nm, and even more preferably from 10 nm to 100 nm.

The hole-blocking layer may have either a monolayer structure comprising one or two or more of the above-mentioned materials, or a multilayer structure composed of plural layers of a homogeneous composition or a heterogeneous composition.

### —Electron-Blocking Layer—

An electron-blocking layer is a layer having a function to prevent the electron transported from the cathode side to the light-emitting layer from passing through to the anode side. According to the present invention, an electron-blocking layer may be provided as an organic compound layer adjacent to the light-emitting layer on the anode side.

Examples of the compound constituting the electron-blocking layer include the compounds explained above as a hole-transporting material.

A thickness of the electron-blocking layer is preferably from 1 nm to 500 nm, more preferably from 5 nm to 200 nm, and even more preferably from 10 nm to 100 nm.

The electron-blocking layer may have either a monolayer structure comprising one or two or more of the above-mentioned materials, or a multilayer structure composed of plural layers of a homogeneous composition or a heterogeneous composition.

### <Protective Layer>

According to the present invention, the whole organic EL element may be protected by a protective layer.

It is sufficient that a material contained in the protective layer is one having a function to prevent penetration of substances such as moisture and oxygen, which accelerate deterioration of the element, into the element.

Specific examples thereof include metals such as In, Sn, Pb, Au, Cu, Ag, Al, Ti, Ni and the like; metal oxides such as MgO, SiO, SiO₂, Al₂O₃, GeO, NiO, CaO, BaO, Fe₂O₃, Y₂O₃, TiO₂ and the like; metal nitrides such as SiNₓ, SiNₓO_{y} and the like; metal fluorides such as MgF₂, LiF, AlF₃, CaF₂ and the like; polyethylene; polypropylene; polymethyl methacrylate; polyimide; polyurea; polytetrafluoroethylene; polychlorotrifluoroethylene; polydichlorodifluoroethylene; a copolymer of chlorotrifluoroethylene and dichlorodifluoroethylene; copolymers obtained by copolymerizing a monomer mixture containing tetrafluoroethylene and at least one comonomer; fluorine-containing copolymers each having a cyclic structure in the copolymerization main chain; water-absorbing materials each having a coefficient of water absorption of 1% or more; moisture permeation preventive substances each having a coefficient of water absorption of 0.1% or less; and the like.

There is no particular limitation as to a method for forming the protective layer. For instance, a vacuum deposition method, a sputtering method, a reactive sputtering method, an MBE (molecular beam epitaxial) method, a cluster ion beam method, an ion plating method, a plasma polymerization method (high-frequency excitation ion plating method), a plasma CVD method, a laser CVD method, a thermal CVD method, a gas source CVD method, a coating method, a printing method, or a transfer method may be applied.

### <Sealing>

The whole organic electroluminescence element of the present invention may be sealed with a sealing cap.

Furthermore, a moisture absorbent or an inert liquid may be used to seal a space defined between the sealing cap and the light-emitting element. Although the moisture absorbent is not particularly limited, specific examples thereof include barium oxide, sodium oxide, potassium oxide, calcium oxide, sodium sulfate, calcium sulfate, magnesium sulfate, phosphorus pentaoxide, calcium chloride, magnesium chloride, copper chloride, cesium fluoride, niobium fluoride, calcium bromide, vanadium bromide, molecular sieve, zeolite, magnesium oxide and the like. Although the inert liquid is not particularly limited, specific examples thereof include paraffins; liquid paraffins; fluorocarbon solvents such as perfluoroalkanes, perfluoroamines, perfluoroethers and the like; chlorine-based solvents; silicone oils; and the like.

### <Driving>

In the organic electroluminescence element of the present invention, when DC (AC components may be contained as needed) voltage (usually 2 volts to 15 volts) or DC is applied across the anode and the cathode, luminescence can be obtained.

For the driving method of the organic electroluminescence element of the present invention, driving methods described in JP-A Nos. 2-148687, 6-301355, 5-29080, 7-134558, 8-234685, and 8-241047; Japanese Patent No. 2784615, U.S. Pat. Nos. 5,828,429 and 6,023,308 are applicable.

In the light-emitting element of the present invention, the light-extraction efficiency can be improved by various known methods. It is possible to elevate the light-extraction efficiency and to improve the external quantum efficiency, for example, by modifying the surface shape of the substrate (for example by forming fine irregularity pattern), by controlling the refractive index of the substrate, the ITO layer and/or the organic layer, or by controlling the thickness of the substrate, the ITO layer and/or the organic layer.

The organic electroluminescence element of the present invention may have a so-called top-emission configuration in which the emitted light is extracted from the opposite side of the substrate from the light-emitting layer.

### (Application of the Present Invention)

The organic electroluminescence element of the present invention can be appropriately used for indicating elements, displays, backlights, electronic photographs, illumination light sources, recording light sources, exposure light sources, reading light sources, signages, advertising displays, interior accessories, optical communications and the like.

All publications, patent applications, and technical standards mentioned in this specification are herein incorporated by reference to the same extent as if each individual publication, patent application, or technical standard was specifically and individually indicated to be incorporated by reference.

### EXAMPLES

In the following, the present invention will be explained by examples thereof, but the present invention is by no means limited by such examples.

### Example 1

### 1. Preparation of Organic EL Element

(Preparation of Comparative Organic EL Element A1)

1) Formation of Anode

As a transparent substrate, the one in which indium tin oxide (which is referred to hereinafter as ITO) was deposited on a glass substrate having a size of 25 mm×25 mm×0.7 mm to form a film having a thickness of 100 nm (manufactured by Tokyo Sanyo Vacuum Co., Ltd.) was used. The transparent substrate was subjected to etching and cleaning.

2) Hole Injection Layer and Hole Transport Layer

On the resulting ITO glass substrate, copper phthalocyanine (which is referred to hereinafter as CuPc) was deposited at a thickness of 10 nm, and then, N,N′-dinaphthyl-N,N′-diphenyl-[1,1′-biphenyl]-4,4′-diamine (which is referred to hereinafter as α-NPD) was deposited at a thickness of 50 nm.

3) Light-Emitting Layer

On the hole injection layer and hole transport layer, compound (AD-1) of formula (1) and platinum complex Pt-1 as an electron-transporting light-emitting material were co-deposited so that the weight ratio would be AD-1:Pt-1=85:15.

The deposition thickness was 30 nm.

4) Electron Transport Layer

Subsequently, aluminum (III) bis(2-methyl-8-quinolinato)-4-phenylphenolate (which is referred to hereinafter as BAlq), which is an electron transporting material, was deposited at a thickness of 40 nm.

5) Electron Injection Layer

Further, lithium fluoride (LiF) was deposited at a thickness of about 1 nm.

6) Formation of Cathode

On the surface of the structure thus constructed, a mask which had been subjected to patterning (a mask that provides a light-emission area of 2 mm×2 mm) was superposed, and aluminum metal (Al) was deposited at a thickness of about 100 nm to prepare an element. The element thus prepared was placed in a dry glove box and was sealed.

The above deposition was performed in a vacuum of from 10⁻³ Pa to 10⁻⁴ Pa under a condition of the substrate temperature of room temperature.

(Preparation of Comparative Organic EL Element A2)

Preparation of comparative organic EL element A2 was conducted in a similar manner to the process in the preparation of the comparative organic EL element A1, except that, in the preparation of the comparative organic EL element A1, the light-emitting layer was changed to the following layer.

Light-emitting layer: N,N′-dicarbazolyl-1,3-benzene (which is referred to as mCP), which is a hole-transporting host material, and the electron-transporting light-emitting material Pt-1 were co-deposited so that the weight ratio would be mCP:Pt-1=85:15. The deposition thickness was 30 nm.

(Preparation of Inventive Organic EL Element Nos. 1 to 4)

Preparation of inventive organic EL element Nos. 1 to 4 was conducted in a similar manner to the process in the preparation of the comparative organic EL element A1, except that, in the preparation of the comparative organic EL element A1, the following layer was used as the light-emitting layer.

Light-emitting layer: ternary element co-deposition was conducted using the hole-transporting host material mCP, compound (AD-1) of formula (1), and the electron-transporting light-emitting material Pt-1, so that the mixing ratio would be the following ratio when the weight ratio of mCP:AD-1:Pt-1 is designated as a:b:c. The deposition thickness was 30 nm.

Organic EL element No. 1: a:b:c=70:15:15

Organic EL element No. 2: a:b:c=60:25:15

Organic EL element No. 3: a:b:c=50:35:15

Organic EL element No. 4: a:b:c=40:45:15

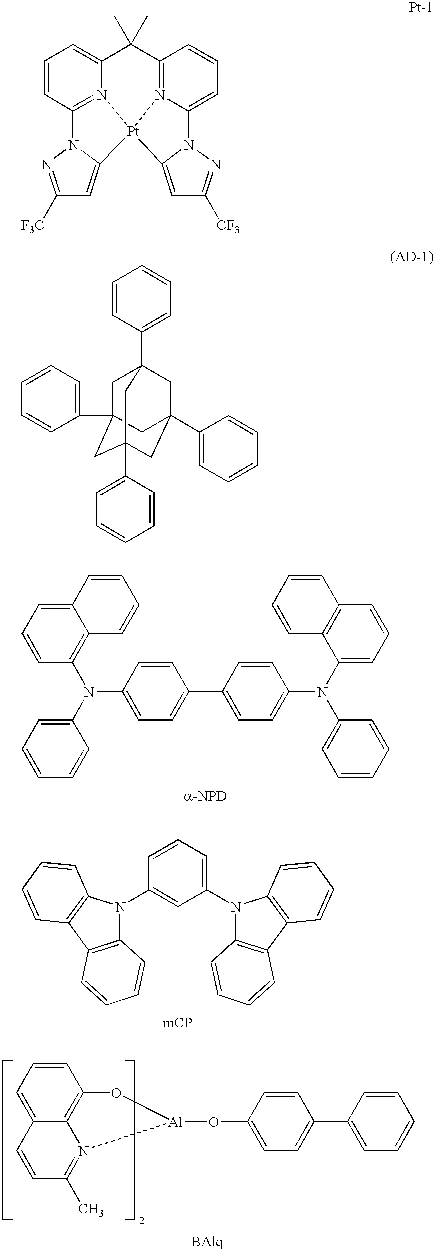

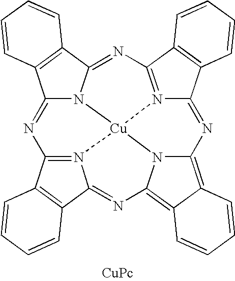

### 2. Performance Evaluation of Organic EL Element

1) External Quantum Efficiency

DC voltage was applied to each element using a source measuring unit, model 2400, manufactured by TOYO Corporation, to emit light. The brightness of the light was measured by using a brightness photometer BM-8, manufactured by Topcon Corporation. The emission spectrum and emission wavelength were measured using a spectral analyzer PMA-11 manufactured by Hamamatsu Photonics K.K. From the obtained values, the external quantum efficiency at a brightness of 1000 cd/m² was calculated by a brightness conversion method.

2) Driving Voltage

DC voltage was applied to each element using a source measuring unit, model 2400, manufactured by TOYO Corporation, to emit light. As the driving voltage, the voltage when an electric current of 10 mA/cm² was applied to the element was measured.

3) Drive Durability: Brightness Half-Value Time

DC voltage was applied to each element to emit light having a brightness of 1000 cd/m². Then, the element was subjected to continuous driving and the time until the brightness was reduced to 500 cd/m² was measured. The brightness half-value time of samples are shown as relative ratios, with the value of the comparative organic EL element A1 designated as 1. Drive durability is expressed in terms of the relative brightness half-value time.

The obtained results are shown in Table 1.

TABLE 1

| | Driving | External | Brightness |
|---|---|---|---|
| | Voltage | Quantum | Half-Value Time |
| Element No. | (V) | Efficiency (%) | (relative ratio) |
| Comparative Element A1 | 19.7 | 1.2 | 1 |
| Comparative Element A2 | 12.5 | 6.1 | 10 |
| Inventive Element No. 1 | 12.7 | 7.0 | 13 |
| Inventive Element No. 2 | 12.9 | 7.2 | 14 |
| Inventive Element No. 3 | 13.0 | 7.5 | 15 |
| Inventive Element No. 4 | 13.1 | 7.1 | 12 |

As is clear from the results shown above, the inventive element Nos. 1, 2, 3, and 4 exhibit light-emission characteristics of unexpectedly high external quantum efficiency, low driving voltage and high drive durability, as compared with the comparative element A1. As compared with the comparative element A2, the inventive element Nos. 1, 2, 3, and 4 exhibit unexpectedly high external quantum efficiency, high drive durability and similar level in driving voltage.

Further, the inventive elements exhibit more excellent performance such that external quantum efficiency increases and drive durability increases together with the increase in a content of the compound of formula (1) when the content of the compound of formula (1) is in a range of from 15% by weight to 35% by weight, but when the content increases to 45% by weight, these effects depreciate.

### Example 2

### 1. Preparation of Sample

(Preparation of Organic EL Element No. 5)

Preparation of inventive organic EL element No. 5 was conducted in a similar manner to the process in the preparation of the organic EL element No. 1 of Example 1, except that, in the preparation of the organic EL element No. 1 of Example 1, the following layer was used as the light-emitting layer.

Ternary element co-deposition was conducted using hole-transporting host material mCP, compound (AD-2) of formula (1), and electron-transporting light-emitting material Pt-1, so that the weight ratio of mCP:AD-2:Pt-1 would be 70:15:15. The deposition thickness was 30 nm.

(Preparation of Organic EL Element No. 6)

Preparation of inventive organic EL element No. 6 was conducted in a similar manner to the process in the preparation of the organic EL element No. 1 of Example 1, except that, in the preparation of the organic EL element No. 1 of Example 1, the following layer was used as the light-emitting layer.

Ternary element co-deposition was conducted using hole-transporting host material mCP, compound (AD-3) of formula (1), and electron-transporting light-emitting material Pt-1, so that the weight ratio of mCP:AD-3:Pt-1 would be 70:15:15. The deposition thickness was 30 nm.

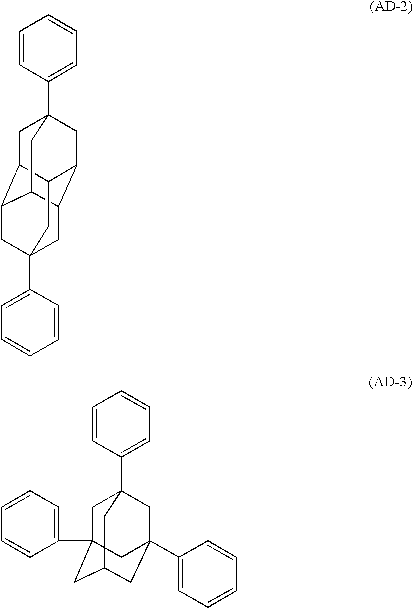

### 2. Performance Evaluation

Concerning the obtained elements, performance was evaluated in a similar manner to that in Example 1. Results are shown in Table 2.

As a result, the inventive element Nos. 5 and 6 exhibit unexpectedly high external quantum efficiency, similar level in driving voltage, and moreover, high drive durability, as compared with the comparative element A2.

TABLE 2

| | | External | |
|---|---|---|---|
| | Driving | Quantum | Brightness |
| | Voltage | Efficiency | Half-Value Time |
| Element No. | (V) | (%) | (relative ratio) |
| Inventive Element No. 5 | 12.9 | 7.0 | 12 |
| Inventive Element No. 6 | 12.8 | 7.1 | 13 |

### Example 3

### 1. Preparation of Organic EL Element Nos. 11 to 16

Preparation of inventive organic EL element Nos. 11 to 16 was conducted in a similar manner to that in the process in the preparation of the organic EL element No. 3 of Example 1, except that, in the preparation of the organic EL element No. 3 of Example 1, the compound(s) shown in Table 3 was (were) used as the compound of formula (1) in the light-emitting layer with the mixing ratio shown in Table 3. In each element, the content of the light emitting material Pt-1 was kept constant to be 15% by weight. In Table 3, when the total amount of the compounds of formula (1) exceeds 35% by weight, the content of the host material mCP is reduced for adjustment.

### 2. Performance Evaluation

Concerning the obtained elements, performance was evaluated in a similar manner to that in Example 1. Results are shown in Table 3.

It is clear from the results shown in Table 3 that the inventive element Nos. 11 to 16 have light-emission characteristics of unexpectedly high external quantum efficiency and low driving voltage. Further, the inventive element Nos. 13 to 16 have light-emission characteristics of further unexpectedly high external quantum efficiency, low driving voltage, and high drive durability. It is revealed that more excellent effects of the invention are obtained by using two of the compounds represented by formula (1) in combination.

TABLE 3

| | First Compound of | | Second Compound of | | | External | |
|---|---|---|---|---|---|---|---|
| | Formula (1) | | Formula (1) | | Driving | Quantum | Brightness |
| | Compound | Content | Compound | Content | Voltage | Efficiency | Half-Value Time |
| Element No. | No. | (% by weight) | No. | (% by weight) | (V) | (%) | (relative ratio) |
| Inventive Element No. 3 | (AD-1) | 35 | — | — | 13.0 | 7.5 | 15 |
| Inventive Element No. 4 | (AD-1) | 45 | — | — | 13.1 | 7.1 | 12 |
| Inventive Element No. 11 | (AD-2) | 35 | — | — | 13.2 | 7.3 | 13 |
| Inventive Element No. 12 | (AD-3) | 35 | — | — | 13.1 | 7.4 | 14 |
| Inventive Element No. 13 | (AD-1) | 25 | (1-2) | 10 | 13.0 | 7.8 | 17 |
| Inventive Element No. 14 | (AD-1) | 35 | (1-2) | 10 | 13.2 | 7.9 | 19 |
| Inventive Element No. 15 | (AD-1) | 25 | (1-3) | 10 | 12.9 | 7.9 | 18 |
| Inventive Element No. 16 | (AD-1) | 35 | (1-3) | 10 | 13.1 | 8.0 | 20 |

### Example 4

### 1. Preparation of Organic EL Element Nos. 22 to 24

Preparation of inventive organic EL element Nos. 22 to 24 and comparative element C1 was conducted in a similar manner to that in the process in the preparation of the organic EL elements of Example 1, except that, in the preparation of the organic EL elements of Example 1, the compound shown in Table 4 was used as the compound of formula (1) in the light-emitting layer. In each element, the content of the light emitting material Pt-1 was kept constant to be 15% by weight. In Table 4, the total content of the compound of formula (1) and the host material mCP is 85% by weight.

TABLE 4

| | | | | | Brightness |
|---|---|---|---|---|---|
| | | | | | Half-Value |
| | | Content | Driving | Quantum | Time |
| Element | Compound | (% by | Voltage | Efficiency | (relative |
| No. | No. | weight) | (V) | (%) | ratio) |
| Comparative Element C1 | Compound A | 15 | 14.9 | 4.3 | 4 |
| Inventive Element No. 22 | (AD-5) | 15 | 13.2 | 7.4 | 12 |
| Inventive Element No. 23 | (AD-6) | 15 | 13.1 | 7.5 | 14 |
| Inventive Element No. 24 | (AD-7) | 15 | 13.0 | 7.5 | 15 |

| | |
|---|---|
| | Compound A |
| 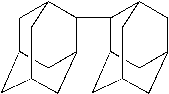 | |

| | |
|---|---|
| | (AD-5) |
| 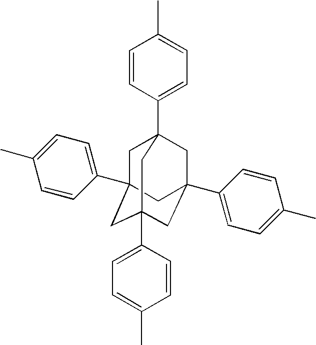 | |
| | (AD-6) |
| 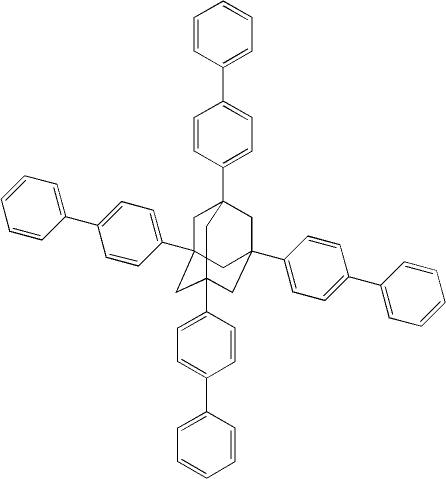 | |
| | (AD-7) |
| 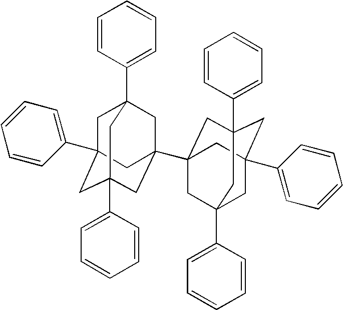 | |

### 2. Performance Evaluation

Concerning the obtained elements, performance was evaluated in a similar manner to that in Example 1. Results are shown in Table 4.

The inventive element Nos. 22 to 24 exhibit light-emission characteristics of unexpectedly high external quantum efficiency, low driving voltage, and high drive durability, as compared with the comparative element C1.

### Example 5

(Preparation of Inventive Organic EL Element Nos. 25 to 27)

Preparation of inventive organic EL element Nos. 25 to 27 was conducted in a similar manner to the process in the preparation of the organic EL elements of Example 1, except that, in the preparation of the organic EL elements of Example 1, Pt-2 was used in place of Pt-1 as the light emitting material in the light-emitting layer, and mCP, H-1 or H-2 was used as the host material, as shown in Table 5. In each element, the content of the light emitting material, the content of compound (AD-1) and the content of the host material are 15% by weight, 15% by weight and 70% by weight, respectively.

(Preparation of Comparative Organic EL Elements D1 to D3)

Preparation of comparative organic EL elements D1 to D3 was conducted in a similar manner to the process in the preparation of the inventive organic EL element Nos. 25 to 27, except that, compound (AD-1) was not added to the light-emitting layer, and the host material was included in an amount of 85% by weight.

TABLE 5

| | | | External Quantum | Brightness |
|---|---|---|---|---|
| | Host | Driving Voltage | Efficiency | Half-Value Time |
| Element No. | Material | (V) | (%) | (relative ratio) |
| Inventive Element No. 25 | mCP | 11.0 | 8.9 | 22 |
| Inventive Element No. 26 | H-1 | 10.8 | 8.7 | 27 |
| Inventive Element No. 27 | H-2 | 10.7 | 8.7 | 38 |
| Comparative Element D1 | mCP | 11.5 | 8.6 | 18 |
| Comparative Element D2 | H-1 | 11.2 | 8.4 | 21 |
| Comparative Element D3 | H-2 | 11.1 | 8.4 | 28 |

(Performance Evaluation)

Concerning the obtained elements, performance was evaluated in a similar manner to that in Example 1. Results are shown in Table 5.

As is clear from the results shown above, the inventive element Nos. 25 to 27 exhibit light-emission characteristics of unexpectedly high external quantum efficiency, low driving voltage, and high drive durability, as compared with the respective comparative elements D1 to D3.

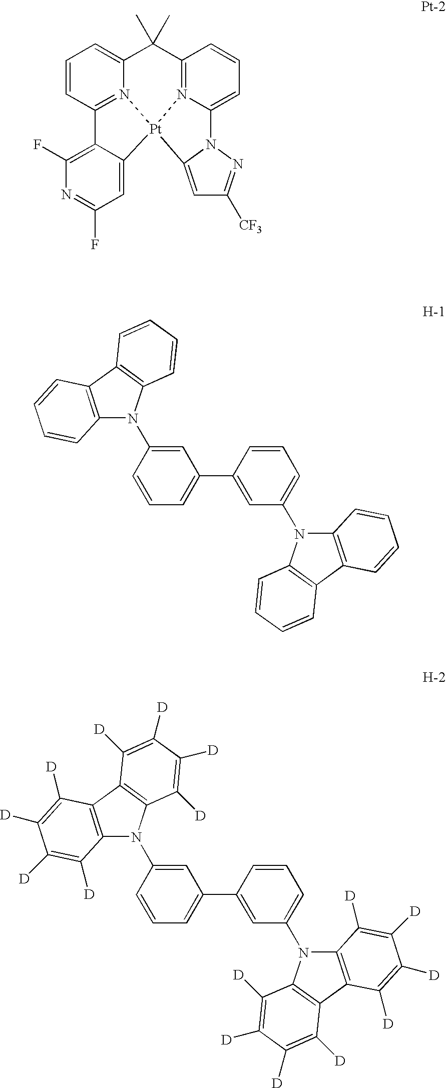

### Example 6

(Preparation of Inventive Organic EL Element Nos. 28 to 30)

Preparation of inventive organic EL element Nos. 28 to 30 was conducted in a similar manner to the process in the preparation of the organic EL elements of Example 1, except that, in the preparation of the organic EL elements of Example 1, compound (AD-8) was used as the compound of formula (1) in the light-emitting layer, and Pt-2 was used in place of Pt-1 as the light emitting material. Furthermore, mCP, H-1 or H-2 was used as the host material, as shown in Table 6. In each element, the content of the light emitting material, the content of compound (AD-8) and the content of the host material are 15% by weight, 15% by weight and 70% by weight, respectively.

(Preparation of Comparative Organic EL Elements E1 to E3)

Preparation of comparative organic EL elements E1 to E3 was conducted in a similar manner to the process in the preparation of the inventive organic EL element Nos. 28 to 30, except that, compound (AD-8) was not added to the light-emitting layer, and the host material was included in an amount of 85% by weight.

TABLE 6

| | | | External Quantum | Brightness |
|---|---|---|---|---|
| | Host | Driving Voltage | Efficiency | Half-Value Time |
| Element No. | Material | (V) | (%) | (relative ratio) |
| Inventive Element No. 28 | mCP | 10.8 | 9.0 | 25 |
| Inventive Element No. 29 | H-1 | 10.7 | 8.8 | 29 |
| Inventive Element No. 30 | H-2 | 10.6 | 8.8 | 42 |
| Comparative Element E1 | mCP | 11.5 | 8.6 | 18 |
| Comparative Element E2 | H-1 | 11.2 | 8.4 | 21 |
| Comparative Element E3 | H-2 | 11.1 | 8.4 | 28 |

(Performance Evaluation)

Concerning the obtained elements, performance was evaluated in a similar manner to that in Example 1. Results are shown in Table 6.

As is clear from the results shown above, the inventive element Nos. 28 to 30 exhibit light-emission characteristics of unexpectedly high external quantum efficiency, low driving voltage, and high drive durability, as compared with the respective comparative elements E1 to E3.

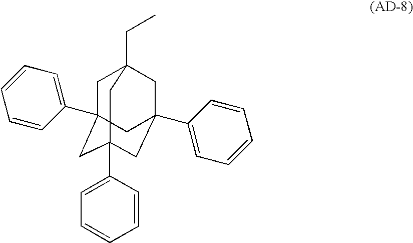

### Example 7

(Preparation of Inventive Organic EL Element Nos. 31 to 34)

Preparation of inventive organic EL element Nos. 31 to 34 was conducted in a similar manner to the process in the preparation of the organic EL elements of Example 1, except that, in the preparation of the organic EL elements of Example 1, Pt-3 was used in place of Pt-1 as the light emitting material in the light-emitting layer, and mCP, N,N′-di-carbazolyl-4,4′-biphenyl (which is referred to hereinafter as CBP), H-1 or H-2 was used as the host material, as shown in Table 7. In each element, the content of the light emitting material, the content of compound (AD-1) and the content of the host material are 15% by weight, 15% by weight and 70% by weight, respectively.

(Preparation of Comparative Organic EL Elements F1 to F4)

Preparation of comparative organic EL elements F1 to F4 was conducted in a similar manner to the process in the preparation of the inventive organic EL element Nos. 31 to 34, except that, the compound of formula (1) was not added to the light-emitting layer, and the host material was included in an amount of 85% by weight.

TABLE 7

| | | | External Quantum | Brightness |
|---|---|---|---|---|
| | Host | Driving Voltage | Efficiency | Half-Value Time |
| Element No. | Material | (V) | (%) | (relative ratio) |
| Inventive Element No. 31 | mCP | 9.5 | 10.0 | 68 |
| Inventive Element No. 32 | CBP | 9.0 | 10.3 | 92 |
| Inventive Element No. 33 | H-1 | 9.2 | 10.3 | 91 |
| Inventive Element No. 34 | H-2 | 9.1 | 10.3 | 105 |
| Comparative Element F1 | mCP | 9.7 | 9.6 | 60 |
| Comparative Element F2 | CBP | 9.3 | 9.8 | 80 |
| Comparative Element F3 | H-1 | 9.4 | 9.7 | 78 |
| Comparative Element F4 | H-2 | 9.3 | 9.7 | 94 |

(Performance Evaluation)

Concerning the obtained elements, performance was evaluated in a similar manner to that in Example 1. Results are shown in Table 7.

As is clear from the results shown above, the inventive element Nos. 31 to 34 exhibit light-emission characteristics of unexpectedly high external quantum efficiency, low driving voltage, and high drive durability, as compared with the respective comparative elements F1 to F4.

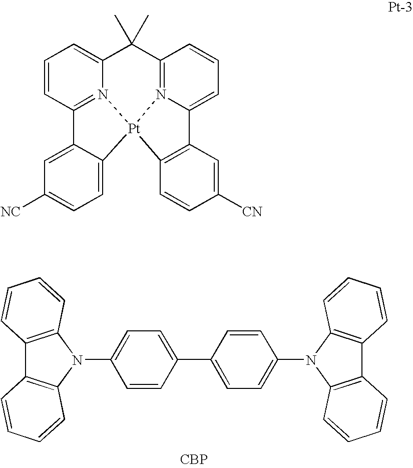

### Example 8

(Preparation of Inventive Organic EL Element Nos. 35 to 38)

Preparation of inventive organic EL element Nos. 35 to 38 was conducted in a similar manner to the process in the preparation of the organic EL elements of Example 1, except that, in the preparation of the organic EL elements of Example 1, compound (AD-8) was used as the compound of formula (1) in the light-emitting layer, and Pt-3 was used in place of Pt-1 as the light emitting material. Furthermore, mCP, CBP, H-1 or H-2 was used as the host material, as shown in Table 8. In each element, the content of the light emitting material, the content of compound (AD-8) and the content of the host material are 15% by weight, 15% by weight and 70% by weight, respectively.

(Preparation of Comparative Organic EL Elements G1 to G4)

Preparation of comparative organic EL elements G1 to G4 was conducted in a similar manner to the process in the preparation of the inventive organic EL element Nos. 35 to 38, except that, compound (AD-8) was not added to the light-emitting layer, and the host material was included in an amount of 85% by weight.

(Performance Evaluation)

Concerning the obtained elements, performance was evaluated in a similar manner to that in Example 1. Results are shown in Table 8.

As is clear from the results shown in Table 8, the inventive element Nos. 35 to 38 exhibit light-emission characteristics of unexpectedly high external quantum efficiency, low driving voltage, and high drive durability, as compared with the respective comparative elements G1 to G4.

TABLE 8

| | | | External Quantum | Brightness |
|---|---|---|---|---|
| | Host | Driving Voltage | Efficiency | Half-Value Time |
| Element No. | Material | (V) | (%) | (relative ratio) |
| Inventive Element No. 35 | mCP | 9.4 | 10.3 | 72 |
| Inventive Element No. 36 | CBP | 8.9 | 10.5 | 100 |
| Inventive Element No. 37 | H-1 | 9.1 | 10.6 | 98 |
| Inventive Element No. 38 | H-2 | 9.0 | 10.5 | 120 |
| Comparative Element G1 | mCP | 9.7 | 9.6 | 60 |
| Comparative Element G2 | CBP | 9.3 | 9.8 | 80 |
| Comparative Element G3 | H-1 | 9.4 | 9.7 | 78 |
| Comparative Element G4 | H-2 | 9.3 | 9.7 | 94 |

### Example 9

(Preparation of Inventive Organic EL Element No. 39)

Preparation of inventive organic EL element No. 39 was conducted in a similar manner to the process in the preparation of the organic EL elements of Example 1, except that, in the preparation of the organic EL elements of Example 1, compound (AD-8) was used as the compound of formula (1) in the light-emitting layer, and Pt-4 was used in place of Pt-1 as the light emitting material. In the element, the content of the light emitting material, the content of compound (AD-8) and the content of the host material (mCP) are 15% by weight, 15% by weight and 70% by weight, respectively.

(Preparation of Comparative Organic EL Element H1)

Preparation of comparative organic EL element H1 was conducted in a similar manner to the process in the preparation of the inventive organic EL element No. 39, except that, compound (AD-8) was not added to the light-emitting layer, and the host material was included in an amount of 85% by weight.

(Performance Evaluation)

Concerning the obtained elements, performance was evaluated in a similar manner to that in Example 1. Results are shown in Table 9.

As is clear from the results shown in Table 9, the inventive element No. 39 exhibits light-emission characteristics of unexpectedly high external quantum efficiency, low driving voltage, and high drive durability, as compared with the comparative element H1.

TABLE 9

| | | | | Brightness |
|---|---|---|---|---|
| | | | External | Half-Value |
| | | Driving | Quantum | Time |
| | Host | Voltage | Efficiency | (relative |
| Element No. | Material | (V) | (%) | ratio) |
| Inventive Element No. 39 | mCP | 9.2 | 10.1 | 56 |
| Comparative Element H1 | mCP | 9.6 | 9.3 | 45 |

| | |
|---|---|
| | Pt-4 |
| 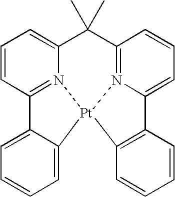 | |

Concerning compounds (AD-1) to (AD-8) used in examples, the energy difference (abbreviated as Eg) between the highest occupied molecular orbital and the lowest unoccupied molecular orbital, the ionization potential (abbreviated as Ip) and the electron affinity (abbreviated as Ea) were measured by the following procedure. Compounds (AD-1) to (AD-8) were each deposited on a quartz substrate having a size of 25 mm×25 mm×0.7 mm to form a film having a thickness of 50 nm in a vacuum of from 10⁻³ Pa to 10⁻⁴ Pa under a condition of the substrate temperature of room temperature.

Eg of the deposited film was determined from the energy at absorption edges of the absorption spectrum.

Ip of the deposited film was measured by using a photoelectron spectrometer (AC-2 manufactured by Riken Keiki Co., Ltd.).

Ea of the deposited film was calculated by subtracting Eg value from Ip value (Ip−Eg).

Furthermore, the lowest excited triplet level (abbreviated as T₁) of compounds (AD-1) to (AD-8) was measured as follows.

The compound was dissolved in an EPA solvent (mixing ratio; diethylether:isopentane:isopropanol=5:5:2 by volume) to make a 0.001% solution. Measurement of phosphorescence spectrum was performed by using a spectrometer (F7000 manufactured by Hitachi, Ltd.) in a state where the prepared solution in a quartz cell was cooled to 77K under an atmosphere of liquid nitrogen. The energy at the short wavelength-edge of the phosphorescence spectrum was regarded as T₁.

The obtained results are shown in Table 10.

Each of the compounds (AD-1) to (AD-8) used in examples has an Eg of 4.0 eV or more, an Ip of 6.0 eV or more and an Ea of 2.1 eV or less. From the above results, it is clear that compounds (AD-1) to (AD-8) are electrically inactive, and they can exhibit an effect of blocking holes and/or electrons (prevention of leak-out) in the light-emitting layer, when at least one of the compounds is added to the light-emitting layer.

Furthermore, it is clear that, as the lowest excited triplet level (abbreviated as T₁) is 2.7 eV or more, excitons are inhibited from diffusing from the light emitting material in the light-emitting layer in the case where at least one of the compounds is included in the light-emitting layer, and thereby the light-emission efficiency is further improved.

TABLE 10

| Compound No. | Eg (eV) | Ip (eV) | Ea (eV) | T₁ (eV) |
|---|---|---|---|---|
| AD-1 | 4.6 | 6.5 | 1.9 | 3.3 |
| AD-2 | 4.6 | 6.5 | 1.9 | 3.3 |
| AD-3 | 4.6 | 6.5 | 1.9 | 3.3 |
| AD-5 | 4.4 | 6.3 | 1.9 | 3.2 |
| AD-6 | 4.1 | 6.1 | 2.0 | 2.8 |
| AD-7 | 4.6 | 6.5 | 1.9 | 3.3 |
| AD-8 | 4.6 | 6.5 | 1.9 | 3.3 |

### Example 10

(Preparation of Inventive Organic EL Element Nos. 40 to 51)

Preparation of inventive organic EL element Nos. 40 to 51 was conducted in a similar manner to the process in the preparation of the organic EL element No. 1 of Example 1, except that, in the preparation of the organic EL element No. 1 of Example 1, compound (AD-8) was used in place of compound (AD-1) as the compound represented by formula (1) in the light-emitting layer, the compound shown in Table 11 was used in place of Pt-1 as the light emitting material, and the compound (mCP, BAlq, CBP, H-1, H-2 or Zn-1) shown in Table 11 was used as the host material. In each element, the content of the light emitting material, the content of compound (AD-8), and the content of the host material are 15% by weight, 15% by weight, and 70% by weight, respectively.

(Preparation of Comparative Organic EL Elements I-1 to I-12)

Preparation of comparative organic EL elements I-1 to I-12 was conducted in a similar manner to the process in the preparation of the inventive organic EL element Nos. 40 to 51, except that, compound (AD-8) was not added to the light-emitting layer, and the host material was included in an amount of 85% by weight.

TABLE 11

| | | | | | Brightness |
|---|---|---|---|---|---|
| | | | | | Half- |
| | | | | External | Value |
| | | Light | Driving | Quantum | Time |
| | Host | Emitting | Voltage | Efficiency | (relative |
| Element No. | Material | Material | (V) | (%) | ratio) |
| Inventive Element | mCP | Pt-5 | 12.1 | 8.2 | 18 |
| No. 40 | | | | | |
| Comparative | mCP | Pt-5 | 12.0 | 7.5 | 15 |
| Element I-1 | | | | | |
| Inventive Element | H-2 | Pt-6 | 10.6 | 9.3 | 22 |
| No. 41 | | | | | |
| Comparative | H-2 | Pt-6 | 10.4 | 9.0 | 18 |
| Element I-2 | | | | | |
| Inventive Element | BAlq | Pt-7 | 10.9 | 7.0 | 40 |
| No. 42 | | | | | |
| Comparative | BAlq | Pt-7 | 10.8 | 6.6 | 30 |
| Element I-3 | | | | | |
| Inventive Element | CBP | Ir-1 | 10.9 | 8.8 | 19 |
| No. 43 | | | | | |
| Comparative | CBP | Ir-1 | 10.7 | 8.5 | 16 |
| Element I-4 | | | | | |
| Inventive Element | H-1 | Ir-2 | 12.7 | 7.5 | 9.4 |
| No. 44 | | | | | |
| Comparative | H-1 | Ir-2 | 12.6 | 7.2 | 7.1 |
| Element I-5 | | | | | |
| Inventive Element | mCP | Ir-3 | 14.5 | 6.5 | 5.3 |
| No. 45 | | | | | |
| Comparative | mCP | Ir-3 | 14.3 | 6.1 | 3.5 |
| Element I-6 | | | | | |
| Inventive Element | Zn-1 | Ir-4 | 8.2 | 8.5 | 34 |
| No. 46 | | | | | |
| Comparative | Zn-1 | Ir-4 | 8.1 | 8.2 | 27 |
| Element I-7 | | | | | |
| Inventive Element | BAlq | Ir-5 | 10.8 | 7.7 | 30 |
| No. 47 | | | | | |
| Comparative | BAlq | Ir-5 | 10.6 | 7.4 | 23 |
| Element I-8 | | | | | |
| Inventive Element | Zn-1 | Ir-6 | 8.3 | 7.3 | 32 |
| No. 48 | | | | | |
| Comparative | Zn-1 | Ir-6 | 8.1 | 7.1 | 27 |
| Element I-9 | | | | | |
| Inventive Element | BAlq | Ir-7 | 10.9 | 7.4 | 27 |
| No. 49 | | | | | |
| Comparative | BAlq | Ir-7 | 10.8 | 7.2 | 23 |
| Element I-10 | | | | | |
| Inventive Element | BAlq | F-1 | 9.6 | 2.4 | 17 |
| No. 50 | | | | | |
| Comparative | BAlq | F-1 | 9.4 | 2.2 | 14 |
| Element I-11 | | | | | |
| Inventive Element | BAlq | F-2 | 8.8 | 3.4 | 21 |
| No. 51 | | | | | |
| Comparative | BAlq | F-2 | 8.7 | 3.2 | 19 |
| Element I-12 | | | | | |

| | |
|---|---|
| | Pt-5 |
| 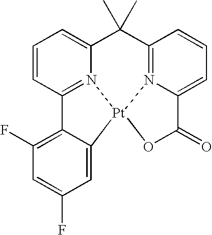 | |
| | Pt-6 |
| 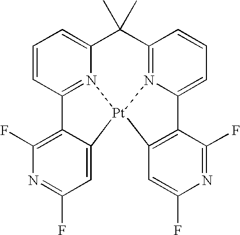 | |
| | Pt-7 |
| 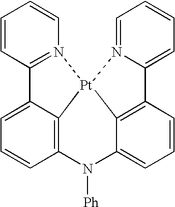 | |
| | Zn-1 |
| 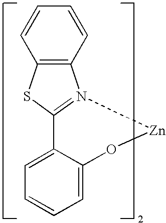 | |
| | Ir-1 |
| 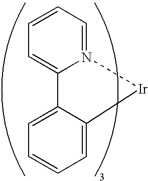 | |
| | Ir-2 |
| 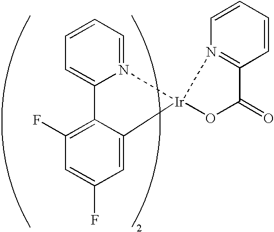 | |
| | Ir-3 |
| 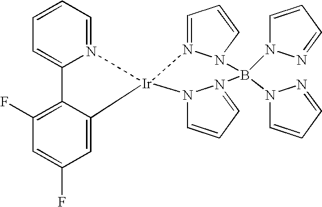 | |
| | Ir-4 |
| 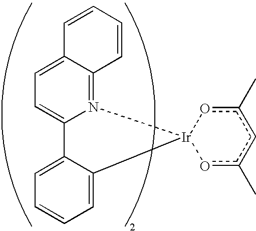 | |
| | Ir-5 |
| 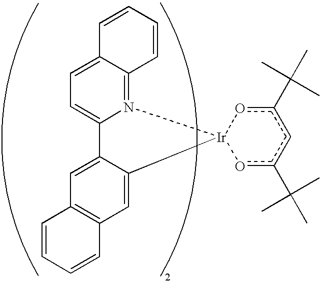 | |
| | Ir-6 |
| 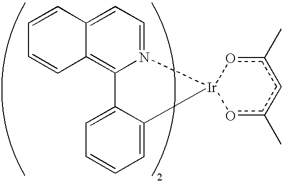 | |
| | Ir-7 |
| 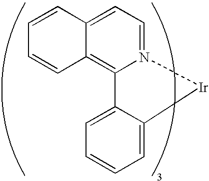 | |

| | |
|---|---|
| | F-1 |
| 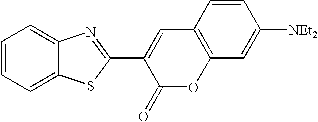 | |
| | F-2 |
| 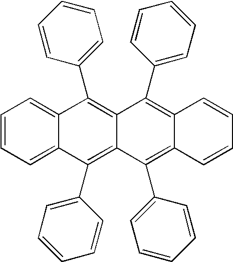 | |

(Performance Evaluation)

Concerning the obtained elements, performance was evaluated in a similar manner to that in Example 1. Results are shown in Table 11.

The inventive element Nos. 40 to 51 exhibit unexpectedly high external quantum efficiency and high drive durability, as compared with the respective comparative elements I-1 to I-12.

### Example 11

(Preparation of Inventive Organic EL Element Nos. 52 to 54)

Preparation of inventive organic EL element Nos. 52 to 54 was conducted in a similar manner to the process in the preparation of the organic EL element No. 1 of Example 1, except that, in the preparation of the organic EL element No. 1 of Example 1, the layer containing α-NPD (referred to as “NPD layer”) and the layer containing BAlq (referred to as “BAlq layer”) were changed as described in the following Table 12.

(Preparation of Comparative Organic EL Elements J1 to J3)

Preparation of comparative organic EL elements J1 to J3 was conducted in a similar manner to the process in the preparation of the inventive organic EL element Nos. 52 to 54, except that compound (AD-1) was not added to the light-emitting layer, and the host material was included in an amount of 85% by weight.

(Performance Evaluation)

Concerning the obtained elements, performance was evaluated in a similar manner to that in Example 1. Results are shown in Table 12.

The inventive element Nos. 52 to 54 exhibit unexpectedly high external quantum efficiency and high drive durability, as compared with the respective comparative elements J1 to J3.

TABLE 12

| | | | | External | |
|---|---|---|---|---|---|
| | Weight Ratio of NPD to | Weight Ratio of BAlq to | Driving | Quantum | Brightness Half- |
| | AD-1 in NPD Layer | AD-1 in BAlq Layer | Voltage | Efficiency | Value Time |
| Element No. | (α-NPD:AD-1) | (BAlq:AD-1) | (V) | (%) | (relative ratio) |
| Inventive | 100:0 | 100:0 | 12.7 | 7.0 | 13 |
| Element No. 1 | | | | | |
| Comparative | 100:0 | 100:0 | 12.5 | 6.1 | 10 |
| Element A2 | | | | | |
| Inventive | 85:15 | 100:0 | 11.9 | 8.0 | 15 |
| Element No. 52 | | | | | |
| Comparative | 85:15 | 100:0 | 11.7 | 7.1 | 12 |
| Element J1 | | | | | |
| Inventive | 100:0 | 85:15 | 11.9 | 7.8 | 15 |
| Element No. 53 | | | | | |
| Comparative | 100:0 | 85:15 | 11.8 | 7.0 | 12 |
| Element J2 | | | | | |
| Inventive | 85:15 | 85:15 | 11.9 | 7.7 | 15 |
| Element No. 54 | | | | | |
| Comparative | 85:15 | 85:15 | 11.8 | 6.9 | 12 |
| Element J3 | | | | | |

What is claimed is:

1. An organic electroluminescence element comprising at least one organic compound layer including a light-emitting layer, which is disposed between a pair of electrodes, wherein the light-emitting layer includes a light emitting material, a compound represented by the following formula (1) and a charge transporting material: 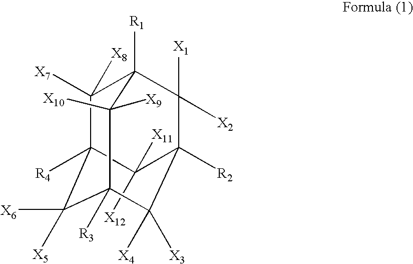
wherein in formula (1), R₁ through R₄ each independently represent a hydrogen atom, an alkyl group having 1 to 6 carbon atoms, an alkenyl group having 2 to 6 carbon atoms, an alkynyl group having 2 to 6 carbon atoms, an aryl group, a heteroaryl group, an alkoxy group having 1 to 6 carbon atoms, an acyl group, an acyloxy group, an amino group, a nitro group, a cyano group, an ester group, an amido group, a halogen atom, a perfluoroalkyl group having 1 to 6 carbon atoms or a silyl group; at least one of R₁ through R₄ is a group having a double bond or a triple bond; and X₁ through X₁₂ each independently represent a hydrogen atom, an alkyl group having 1 to 6 carbon atoms, an alkenyl group having 2 to 6 carbon atoms, an alkynyl group having 2 to 6 carbon atoms, an aryl group, a heteroaryl group, an alkoxy group having 1 to 6 carbon atoms, an acyl group, an acyloxy group, an amino group, a nitro group, a cyano group, an ester group, an amido group, a halogen atom, a perfluoroalkyl group having 1 to 6 carbon atoms or a silyl group.

2. The organic electroluminescence element according to claim 1, wherein at least one of R1 through R4 is a group having a group a double bond, and the group having a double bond is a phenyl group, a biphenylyl group or a terphenylyl group.

3. The organic electroluminescence element according to claim 1, wherein in formula (1), at least one of R₁ through R₄ is a phenyl group.

4. The organic electroluminescence element according to claim 1, wherein an energy difference (Eg) between the highest occupied molecular orbital and the lowest unoccupied molecular orbital of the compound represented by formula (1) is 4.0 eV or more.

5. The organic electroluminescence element according to claim 1, wherein the lowest excited triplet level (T₁) of the compound represented by formula (1) is 2.7 eV or more.

6. The organic electroluminescence element according to claim 1, wherein an ionization potential (Ip) of the compound represented by formula (1) is 6.1 eV or more.

7. The organic electroluminescence element according to claim 1, wherein an electron affinity (Ea) of the compound represented by formula (1) is 2.3 eV or less.

8. The organic electroluminescence element according to claim 1, wherein the compound represented by formula (1) and the charge transporting material are contained in a range of from 1:99 to 50:50 by weight ratio.

9. The organic electroluminescence element according to claim 8, wherein the compound represented by formula (1) and the charge transporting material are contained in a range of from 5:95 to 35:65 by weight ratio.

10. The organic electroluminescence element according to claim 1, wherein plural compounds represented by formula (1) are contained in a mixture.

11. The organic electroluminescence element according to claim 10, wherein the plural compounds represented by formula (1) have different numbers of phenyl groups from each other.

12. The organic electroluminescence element according to claim 1, wherein the charge transporting material comprises a hole transporting material.

13. The organic electroluminescence element according to claim 1, wherein the light emitting material comprises a metal complex represented by the following formula (A): 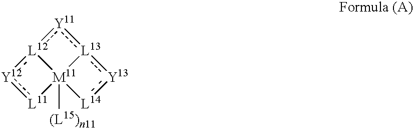
wherein in formula (A), M¹¹ represents a metal ion; L¹¹ through L¹⁵ each independently represent a ligand which coordinates to M¹¹; an atomic group may further exist between L¹¹ and L¹⁴ to form a cyclic ligand; L¹⁵ may bond to both of L¹¹ and L¹⁴ to form a cyclic ligand; Y¹¹, Y¹² and Y¹³ each independently represent a linking group, a single bond or a double bond; when Y¹¹, Y¹² or Y¹³ is a linking group, bonds between L¹¹ and Y¹², Y¹² and L¹², L¹² and Y¹¹, Y¹¹ and L¹³, L¹³ and Y¹³, and Y¹³ and L¹⁴ each independently represent a single bond or a double bond; n11 represents an integer of from 0 to 4; and bonds between M¹¹ and L¹¹ to L¹⁵ are each independently a coordination bond, an ionic bond or a covalent bond.

14. The organic electroluminescence element according to claim 13, wherein in formula (A), M¹¹ is a platinum ion.
